(19) United States
(12) Patent Application Publication
(10) Pub. No.: US 2023/0303896 A1
(43) Pub. Date: Sep. 28, 2023

(54) RESIN REINFORCED WITH NANOCELLULOSE FOR WOOD-BASED PANEL PRODUCTS

(71) Applicant: FIBERLEAN TECHNOLOGIES LIMITED, Par (GB)

(72) Inventors: Yun JIN, St. Austell (GB); David SKUSE, Truro (GB)

(73) Assignee: FIBERLEAN TECHNOLOGIES LIMITED, PAR (GB)

(21) Appl. No.: 18/124,833

(22) Filed: Mar. 22, 2023

Related U.S. Application Data
(63) Continuation of application No. PCT/US2023/015871, filed on Mar. 22, 2023.
(60) Provisional application No. 63/322,854, filed on Mar. 23, 2022.
(60) Provisional application No. 63/450,700, filed on Mar. 8, 2023.

(51) Int. Cl. C09J 11/08; C09J 175/14; C09J 161/06; C09J 161/24; C09J 161/30; C09J 11/04

(52) U.S. Cl. CPC C09J 11/08; C09J 175/14; C09J 161/06; C09J 161/24; C09J 161/30; C09J 11/04; C09J 2203/346; C09J 2301/408; C09J 2301/312; C09J 2301/50

(57) ABSTRACT

Adhesive resin compositions, for the manufacture of wood-based panels, comprising thermosetting resin and nanocellulose, wood-based panels comprising said adhesive resin compositions, methods of using said adhesive resin compositions, and methods of preparing said adhesive resin compositions.

### FIELD OF INVENTION

Adhesive resin compositions, for the manufacture of wood-based panels, comprising thermosetting resin and nanocellulose, wood-based panels comprising said adhesive resin compositions, methods of using said adhesive resin compositions, and methods of preparing said adhesive resin compositions.

### BACKGROUND OF THE INVENTION

Use of nanocellulose (e.g., micro-fibrillated cellulose or cellulose nanofibrils) has become of increased interest in wood-based material research over the past decade. While the addition of nanocellulose is often shown to improve the mechanical properties of wood-based panels, such as internal bond and bending strength (Veigel, S. et al., “Particle Board and Oriented Strand Board Prepared with Nanocellulose-Reinforced Adhesive,” J. Nanomater. 2012, 8 (2012)), a challenge for implementing the technology is the excess water in the nanocellulose suspension. Addition of inorganic filler, such as nanoclay (Lei, H. et al., “Influence of nanoclay on urea-formaldehyde resins for wood adhesives and its model,” J. Appl. Polym. Sci. 109, 2442-2451 (2008)) and calcium carbonate (Ozyhar, T. et al., “Utilization of inorganic mineral filler material as partial replacement for wood fiber in medium density fiberboard (MDF) and its effect on material properties,” Eur. J. Wood Wood Prod. 78, 75-84 (2020)), has demonstrated the possibility of replacing wood fibre in the lab scale study, but there is no commercial application of the technology in the industry. Other bio-based resin technologies (e.g. lignin and protein) and thermoplastic polymers have also been extensively investigated (Solt, P. et al., “Technological performance of formaldehyde-free adhesive alternatives for particleboard industry,” Int. J. Adhes. Adhes. 94, 99-131 (2019)), with the common goal to reduce or replace toxic formaldehyde-based resin. But none of the technologies fully replace urea formaldehyde resin due to cost, process compatibility, productivity, and final product quality.

The high amount of water content of the wood fibre-resin mixture in the hot press section would increase the press factor, leading to lower productivity, and it may also generate excess steam pressure during the production. On the other hand, it is well known that the viscosity of nanocellulose increases exponentially with its solid content (Hubbe, M. A. et al., “Rheology of nanocellulose-rich aqueous suspensions: A review,” BioResources 12, 9556-9661 (2017)) and, therefore, the application of high solid nanocellulose could affect the sprayability of the resin.

Although spraying of nanocellulose slurry has been explored in the past, these were typically conducted with a very high spray pressure of 190 bar, or diluted with excess water to 0.5-2 wt % fibril consistency in order to spray (Beneventi, D. et al., “Highly Porous Paper Loading with Microfibrillated Cellulose by Spray Coating on Wet Substrates,” Ind. Eng. Chem. Res. 53, 10982-10989 (2014); Vartiainen, J. et al., “Health and environmental safety aspects of friction grinding and spray drying of microfibrillated cellulose,” Cellulose 18, 775-786 (2011)).

In U.S. Pat. No. 9,284,474, to Wang et al. and entitled “Wood adhesives containing reinforced additives for structural engineering products,” improved modulus of elasticity (MOE) and modulus of rupture (MOR) is demonstrated for wood composites with the addition of nanocellulose. In U.S. patent application publication number 2018/0169893, to Joutsimo et al. and entitled “Method for Producing MDF Boards with NFC/MFC,” it is described that addition of nanofibrillated cellulose/microfibrillated cellulose in medium-density fiberboard (MDF) or particle board achieves lower urea formaldehyde resin dose in the boards.

U.S. patent application publication no. 2018/0169893 discloses techniques for producing MDF boards, where resin and a mixture of nanofibrillated cellulose/microfibrillated cellulose are added to a board production process. US 2018/0169893 discloses the resin is not previously mixed with the nanofibrillated cellulose/microfibrillated cellulose, but rather is added separately to the board production process.

U.S. patent application publication no. 2010/0285295 discloses wood adhesives containing reinforced additives. US 2010/0285295 discloses a disadvantage of cellulosic fibers for their use in industry is the strong hydrophilic nature of their surface, which inhibits homogeneous dispersion in non-polar polymers. To overcome this, US 2010/0285295 sets forth techniques for chemically modifying cellulose surfaces to become hydrophobized, allowing for dispersion of the cellulose within non-polar resins.

Notwithstanding the foregoing, there remains a need for manufacturing wood-based panel products having decreased toxic resin doses.

### SUMMARY OF THE INVENTION

The foregoing problems are addressed by mixing non-chemically modified nanocellulose, having a low water content, with resin, and applying the resulting nanocellulose/resin mixture in the wood-based panel production process. In some instances, belt-pressed “cakes” (e.g., having about 15 wt % nanocellulose solid content) and high-solid, semi-dry samples (e.g., having >25 wt % nanocellulose solid content) are mixed with the resin. An industrially relevant high-shear make down process in water may be used to re-disperse the cake or high-solid, semi-dry sample in resin with minimal energy. There is currently no such process in the market.

A first aspect of the present disclosure provides an adhesive resin composition for the manufacture of wood-based panels, the adhesive resin composition comprising thermosetting resin and nanocellulose.

In some embodiments of the first aspect of the present disclosure, the thermosetting resin comprises formaldehyde-based resin.

In some embodiments of the first aspect of the present disclosure, the formaldehyde-based resin is selected from the group consisting of urea formaldehyde, melamine urea formaldehyde, phenol formaldehyde, and combinations thereof.

In some embodiments of the first aspect of the present disclosure, the thermosetting resin comprises isocyanate-based resin.

In some embodiments of the first aspect of the present disclosure, the isocyanate-based resin comprises polymeric methylene di-isocyanate.

In some embodiments of the first aspect of the present disclosure, the nanocellulose comprises microfibrillated cellulose.

In some embodiments of the first aspect of the present disclosure, the microfibrillated cellulose has a mean particle size d₅₀ value of about 1 μm to about 500 μm.

In some embodiments of the first aspect of the present disclosure, the microfibrillated cellulose has a fibre steepness of about 20 to about 50.

In some embodiments of the first aspect of the present disclosure, the microfibrillated cellulose has a fibre length (Lc(w) ISO) of less than 0.7 mm as measured by a fiber image analyzer.

In some embodiments of the first aspect of the present disclosure, the microfibrillated cellulose has: a mean particle size d₅₀ value of about 1 μm to about 500 μm; a fibre steepness of about 20 to about 50; and a fibre length (Lc(w) ISO) of less than 0.7 mm as measured by a fiber image analyser.

In some embodiments of the first aspect of the present disclosure, the nanocellulose is present in an amount of at least about 0.01 wt % of the total weight of the adhesive resin composition.

In some embodiments of the first aspect of the present disclosure, the nanocellulose is present in an amount of at least about 0.5 wt % of the total weight of the adhesive resin composition.

In some embodiments of the first aspect of the present disclosure, the nanocellulose is present in an amount of about 0.01 wt % to about 50 wt % of the total weight of the adhesive resin composition.

In some embodiments of the first aspect of the present disclosure, the nanocellulose is present in an amount of about 0.2 wt % to about 50 wt % of the total weight of the adhesive resin composition.

In some embodiments of the first aspect of the present disclosure, the nanocellulose is present in an amount of at least about 40 wt % of the total solid content of the adhesive resin composition.

In some embodiments of the first aspect of the present disclosure, the nanocellulose is present in an amount of at most about 50 wt % of the total solid content of the adhesive resin composition.

In some embodiments of the first aspect of the present disclosure, the adhesive resin composition has a shear viscosity of >100 Pa·s at a shear rate of 0.1 s⁻¹.

In some embodiments of the first aspect of the present disclosure, the adhesive resin composition has a shear viscosity of <1 Pa·s at a shear rate of >1000 s⁻¹.

In some embodiments of the first aspect of the present disclosure, the adhesive resin composition comprises a solvent.

In some embodiments of the first aspect of the present disclosure, the solvent is selected from the group consisting of water, alcohol, toluene, and combinations thereof.

In some embodiments of the first aspect of the present disclosure, the alcohol comprises at least one of ethanol, glycerol, and polyvinyl alcohol.

In some embodiments of the first aspect of the present disclosure, the adhesive resin composition comprises inorganic particulate material.

In some embodiments of the first aspect of the present disclosure, the inorganic particulate material comprises calcium carbonate, clay, aluminum trihydrate, and combinations thereof.

In some embodiments of the first aspect of the present disclosure, the adhesive resin composition comprises at least one additive.

In some embodiments of the first aspect of the present disclosure, the at least one additive comprises a hardener, an emulsion, a fire retardant, and any combination of two or more thereof.

In some embodiments of the first aspect of the present disclosure, the hardener comprises at least one of ammonium chloride and metal chloride.

In some embodiments of the first aspect of the present disclosure, the metal chloride comprises at least one of aluminum chloride, zinc chloride, and magnesium chloride.

In some embodiments of the first aspect of the present disclosure, the emulsion comprises at least one of polyvinyl acetate emulsion and paraffin emulsion.

In some embodiments of the first aspect of the present disclosure, the fire retardant comprises at least one of zinc oxide, aluminum hydroxide, and ammonium polyphosphate.

A second aspect of the present disclosure provides a wood-based panel comprising the adhesive resin composition of the first aspect of the present disclosure.

In some embodiments of the second aspect of the present disclosure, the wood-based panel is selected from the group consisting of plywood, chipboard, low-density fiberboard, medium-density fiberboard, and high-density fiberboard.

A third aspect of the present disclosure provides a method of using the adhesive resin composition of the first aspect of the present disclosure, where the method comprises applying the adhesive resin composition to either the input or the output of a dryer of a wood-based panel assembly process.

In some embodiments of the third aspect of the present disclosure, applying the adhesive resin composition comprises spraying the adhesive resin composition to either the input or the output of the dryer.

In some embodiments of the third aspect of the present disclosure, applying the adhesive resin composition comprises curtain coating the adhesive resin composition to either the input or the output of the dryer.

A fourth aspect of the present disclosure provides a method of preparing the adhesive resin composition of the first aspect of the present disclosure, where the method comprises providing the nanocellulose in the form of a high-solid product, and mixing the high-solid product with the thermosetting resin.

In some embodiments of the fourth aspect of the present disclosure, providing the nanocellulose in the form of the high-solid product comprises producing a slurry comprising nanocellulose present in an amount of up to about 10 wt % of the total weight of the slurry, and mechanically dewatering the slurry to produce the high-solid product having nanocellulose present in an amount of at least about 10 wt % of the total weight of the high-solid product.

In some embodiments of the fourth aspect of the present disclosure, the nanocellulose is present in an amount of about 1 wt % to about 2 wt % of the total weight of the slurry.

In some embodiments of the fourth aspect of the present disclosure, mechanically dewatering the slurry comprises use of a centrifuge.

In some embodiments of the fourth aspect of the present disclosure, mechanically dewatering the slurry comprises use of a belt press.

In some embodiments of the fourth aspect of the present disclosure, nanocellulose is present in an amount of at least about 15 wt % of the total weight of the high-solid product.

In some embodiments of the fourth aspect of the present disclosure, the method comprises mixing the high-solid product with the thermosetting resin to produce the adhesive resin composition to have nanocellulose present in an amount of at least about 40 wt % of the total solid content of the adhesive resin composition.

In some embodiments of the fourth aspect of the present disclosure, the nanocellulose is present in an amount of at most about 50 wt % of the total solid content of the adhesive resin composition.

In some embodiments of the fourth aspect of the present disclosure, mixing the high-solid product with the thermosetting resin comprises use of a Cowles mixer, a rotor/stator mixer, or a homogenizer.

### BRIEF DESCRIPTION OF THE DRAWINGS

FIG. 1 is a flowchart of an example wood-based panel production process, according to embodiments of the present disclosure.

FIG. 2 are shear curves for urea formaldehyde resin (square) and adhesive resin composition including MFC (triangle).

FIG. 3 is a plot of shear viscosity vs. time for urea formaldehyde resin (light colored line made up of triangles) and adhesive resin composition including MFC (dark line made up of rectangles).

FIG. 4A is a chart showing contact angle for urea formaldehyde resin and MFC cake dispersed in urea formaldehyde.

FIG. 4B is a chart showing surface tension for urea formaldehyde resin and MFC cake dispersed in urea formaldehyde.

FIG. 5 is a chart showing Scott Bond of sheets reinforced with urea formaldehyde resin and MFC cake dispersed in urea formaldehyde.

FIG. 6A and FIG. 6B are a schematic of a transportable equipment apparatus and process flow diagram for re-dispersion of nanocellulose and, optionally, one or more inorganic particulate material, and optional additives. The schematic shown in FIG. 6A includes a feed hopper. The schematic shown in FIG. 6B does not include a feed hopper.

FIG. 7A and FIG. 7B are a schematic of a transportable equipment apparatus and process flow diagram for re-dispersion of nanocellulose and, optionally, one or more inorganic particulate material, and optional additive, wherein the process or system further comprises a hydrocyclone apparatus. The schematic shown in FIG. 7A includes a feed hopper. The schematic shown in FIG. 7B does not include a feed hopper.

FIG. 8A is a drawing depicting 6-ring and FIG. 8B depicts 8-ring embodiments of the Atrex® counter rotating rotor-rotor rings.

FIG. 9 is a graph depicting how the chosen Vortex-Finder to Spigot Ratio impacts the D50 on the 1″ hydrocyclone at 4 bar pressure at 1.7% total solids.

FIG. 10 is a graph depicting how the chosen Vortex-Finder to Spigot Ratio impacts the <300 μm fraction on the 1″ hydrocyclone at 4 bar pressure at 1.7% total solids.

FIG. 11 is graph depicting how the chosen Vortex-Finder to Spigot Ratio impacts the Fibrillation % (with constant fines B) as measured by the Valmet Fibre-analyser on the 1″ hydrocyclone at 4 bar pressure and 1.7% total solids.

FIG. 12 is a graph depicting how the chosen Vortex-Finder to Spigot Ratio impacts the total solids on the 1″ hydrocyclone at 4 bar pressure and 1.7% total solids.

FIG. 13 is a graph depicting the rheology of urea formaldehyde (UF)-MFC adhesives (cone-plate test geometry).

FIG. 14 is a graph showing the effect of MFC types on shear strength of MFC-UF bonded wood veneers. coBotMFC-UF refers to UF dosed with MFC made from calcium carbonate and Botnia pulp. coAcaMFC-UF refers to UF dosed with MFC made from calcium carbonate and Acacia pulp.

FIG. 15 is a graph showing the effect of MFC content on shear strength of MFC-UF bonded wood veneers. zirBotMFC-UF refers to UF dosed with MFC made from Botnia pulp. coBotMFC-UF refers to UF dosed with MFC made from calcium carbonate and Botnia pulp.

FIG. 16 is a graph showing the effect of MFC content on melamine urea formaldehyde (MUF) resin.

FIG. 17 is a bar graph showing the effect of MFC content on phenol formaldehyde (PF) resin.

FIG. 18 is a graph showing that a decrease in shear strength is observed when 60 wt % MFC is added in UF.

### DETAILED DESCRIPTION OF THE INVENTION

### Production of Wood-Based Panels

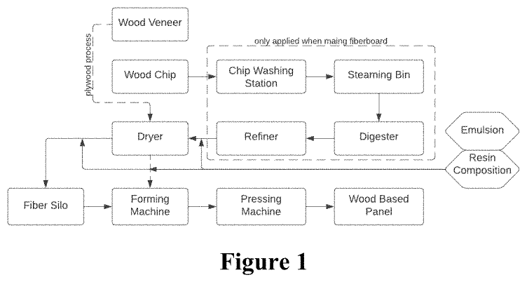

FIG. 1 illustrates an example wood-based panel production process, according to embodiments of the present disclosure. In some embodiments, a wood-based panel of the present disclosure may be plywood. In some embodiments, a wood-based panel of the present disclosure may be chipboard. In some embodiments, a wood-based panel of the present disclosure may be low-density fiberboard. In some embodiments, a wood-based panel of the present disclosure may be medium-density fiberboard (MDF). In some embodiments, a wood-based panel of the present disclosure may be high-density fiberboard (HDF). In some embodiments, a wood-based panel of the present disclosure may be hardboard.

With reference to FIG. 1, wood may be processed (e.g., in a debarker) to produce wood veneers, wood chips, or fibres, depending on the final wood-based product to be manufactured. For example, wood veneers may be produced with the wood-based product is to be plywood, wood chips may be produced when the wood-based product is to be particle board, and fibres may be produced when the wood-based product is to be medium density fiberboard (MDF) or high density fiberboard (HDF).

### Production of Fiberboard or Particle Board

If particle board is to be produced, wood chips may be may be sent to a chip washing station. At the chip washing station, the wood chips may be freed from materials having densities that prohibit the materials from floating. Example materials having such densities include, but are not limited to, sand and metals. The chip washing station may have a drain screw that expels cleaned wood chips from the chip washing station.

After being output from the chip washing station, the cleaned wood chips may be sent to a steaming bin. Within the steaming bin, occluded air in the wood chips may be removed. Such removal of occluded air may render heat transfer in a digester (discussed in detail herein below) more effective. In the steaming bin, the wood chips are heated with saturated vapor (e.g., at a pressure of 3 bar), with the objective of standardizing temperature and humidity, and softening the wood chips, thereby enabling more effective removal of water and natural resins from the wood chips. After being output from the steaming bin, the wood chips may be input to the digester.

The digester may include a vertical tube of varying diameter. Within the tube, the wood chips are heated via saturated vapor (e.g., at a pressure of about 7 bar to about 9 bar). In some embodiments, the vapor may be saturated with sodium hydroxide or sodium sulfide in order to remove lignin from the cellulose fibers of the wood chips. The wood chips may be held within the tube for a period of about 2 minutes to about 7 minutes. In some embodiments, vapor flow, pressure, and temperature may be monitored in an automatic manner.

The digester may have an output screw at the bottom thereof for outputting wood chips from the digester. In some embodiments, the output screw may be a variable-speed supply output screw.

The wood chips, output from the digester, may be input to a refiner. The flow volume, of the wood chips input to the refiner, may be a function of the speed of the output screw of the digester. In embodiments where the output screw is a variable-speed supply output screw, the volume, of the wood chips input to the refiner, may vary.

An emulsion (e.g., a paraffinic or wax emulsion) may be injected to the wood chips within a supply screw of the refiner. By doing this, the emulsion may be properly mixed with fibre during the refinement process. Alternatively, the emulsion may be injected to the wood chips via a blowing line.

Within the refiner, the wood chips may be shredded and refined, resulting in fibres and wood chips being separated. The refiner may include two cut discs, one being stationary while the other is rotary. The wood chips may be input through a center of the stationary disc, and a centrifugal force may operate on the wood chips to displace the wood chips throughout the area between the two discs. Vapor pressure may be used to blow resulting fibre through a blowing value (e.g., adjustable blowing value) and a subsequent blowing line towards a dryer.

In some embodiments, the adhesive resin composition of the present disclosure (the production, properties, and characteristics of which are described in detail herein below) may be applied to the fibre after the fibre has been output from the refiner, but prior to the fibre being input to the dryer. In some embodiments, the adhesive resin composition of the present disclosure may be applied to the fibre at an input of the dryer (i.e., as the fibre is being input to the dryer).

The adhesive resin composition may be applied to the fibre using various techniques. In some embodiments, application of the adhesive resin composition to the fibre may involve spraying the adhesive resin composition onto the fibre. Spraying of the adhesive resin composition onto the fibre may be influenced by factors such as, for example, the number of spray nozzles being used, the size of the openings of the spray nozzles, and the speed at which the fibres are being sent from the refiner to the dryer.

In some embodiments, the dryer may dry fibre (optionally having the adhesive resin composition of the present disclosure applied thereto) using a one- or two-phase process. In some embodiments, the heat source used to perform said drying may include hot gasses or hot air coming from a thermal plant via pipes where it is mixed with fresh air to control temperature.

Dried fibres, output from the dryer, may be sent to a fiber silo. In some embodiments, the dried fibres, output from the dryer, may have at least 90 wt % solid content.

In some embodiments, the adhesive resin composition of the present disclosure (the production, properties, and characteristics of which are described in detail herein below) may be applied to the dried fibres as they are being output from the dryer. In some embodiments, the adhesive resin composition of the present disclosure may be applied to the dried fibres after they have been output from the dryer, but prior to the fibres being input to the fiber silo.

The adhesive resin composition may be applied to the dried fibre using various techniques. In some embodiments, application of the adhesive resin composition to the dried fibre may involve spraying the adhesive resin composition onto the dried fibre. Spraying of the adhesive resin composition onto the dried fibre may be influenced by factors such as, for example, the number of spray nozzles being used, the size of the openings of the spray nozzles, and the speed at which the dried fibres are being sent from the dryer to the fiber silo.

The fiber silo is used to store fibre (having the adhesive resin composition of the present disclosure mixed therewith) for subsequent feeding to a forming machine. The fiber silo may be configured to supply a constant flow of fibre towards the forming machine. In some embodiments, a variable speed conveyor may be used to transport fibres from the fiber silo and to the forming machine.

A pneumatic separator (not illustrated in FIG. 1) may be used to separate and remove high-density particles such as, for example, adhesive clusters, fibre knots, metal, etc., located in a fibre discharge end of the fiber silo. This may minimize the amount of lower-quality material input to the forming machine.

Fibre, output from the fiber silo, is introduced to a formation head of the forming machine. At the formation head, the fibre may be formed into a continuous mat via, for example, blow-molding or mechanical formation. The height of the continuous mat may depend on the desired thickness and density of the fiberboard to be manufactured.

Subsequently, the formed, continuous mat may be input to a pressing machine. Within the pressing machine, pressure and temperature and applied to the continuous mat for a period of time contingent upon density of the continuous mat, thickness of the continuous mat, and optionally other process conditions. In some embodiments, the pressing machine may be multi-plate pressing machine. In some embodiments, the pressing machine may be a continuous pressing machine. The output of the pressing machine is fiberboard in this context.

The fiberboard may undergo processing and inspection. For example, the fiberboard may be subjected to operations such as, but not limited to, measurement, classification, cooling, storage following cooling, sanding, formatting, and packaging.

### Production of Plywood

If plywood is to be produced, wood veneer may be input to the dryer. In some embodiments, the dryer may dry the wood veneers using a one- or two-phase process. In some embodiments, the heat source used to perform said drying may include hot gasses or hot air coming from a thermal plant via pipes where it is mixed with fresh air to control temperature.

Dried wood veneers, output from the dryer, may be sent to the forming machine. In some embodiments, the dried wood veneers, output from the dryer, may have at least 90 wt % solid content.

In some embodiments, the adhesive resin composition of the present disclosure (the production, properties, and characteristics of which are described in detail herein below) may be applied to the wood veneers prior to or as they are being input to the dryer. The adhesive resin composition may be applied to the wood veneers using various techniques.

In some embodiments, application of the adhesive resin composition to the wood veneers may involve spraying the adhesive resin composition onto the wood veneers. Spraying of the adhesive resin composition onto the wood veneers may be influenced by factors such as, for example, the number of spray nozzles being used, the size of the openings of the spray nozzles, and the speed at which the wood veneers are being sent to the dryer.

In some embodiments, application of the adhesive resin composition to the wood veneers may involve curtain coating the adhesive resin composition onto the wood veneers. In this context, curtain coating is a non-contact metering technique in which the adhesive resin composition is applied as a uniform layer atop the wood veneers.

In some embodiments, the adhesive resin composition of the present disclosure (the production, properties, and characteristics of which are described in detail herein below) may be applied to the dried wood veneers as they are being output from the dryer. In some embodiments, the adhesive resin composition of the present disclosure may be applied to the dried wood veneers after they have been output from the dryer, but prior to the veneers being input to the forming machine.

The adhesive resin composition may be applied to the dried wood veneers using various techniques. In some embodiments, application of the adhesive resin composition to the dried wood veneers may involve spraying the adhesive resin composition onto the dried wood veneers. Spraying of the adhesive resin composition onto the dried wood veneers may be influenced by factors such as, for example, the number of spray nozzles being used, the size of the openings of the spray nozzles, and the speed at which the dried wood veneers are being sent from the dryer to the forming machine.

In some embodiments, application of the adhesive resin composition to the dried wood veneers may involve curtain coating the adhesive resin composition onto the dried wood veneers. In this context, curtain coating is a non-contact metering technique in which the adhesive resin composition is applied as a uniform layer atop the dried wood veneers.

Dried wood veneers, output from the dryer, is introduced to a formation head of the forming machine. At the formation head, the wood veneers may be formed into a continuous mat via, for example, mechanical formation. The height of the continuous mat may depend on the desired thickness and density of the plywood to be manufactured.

Subsequently, the formed, continuous mat may be input to the pressing machine. Within the pressing machine, pressure and temperature are applied to the continuous mat for a period of time contingent upon density of the continuous mat, thickness of the continuous mat, and optionally other process conditions. In some embodiments, the pressing machine may be multi-plate pressing machine. In some embodiments, the pressing machine may be a continuous pressing machine. The output of the pressing machine is plywood in this context.

The plywood may undergo processing and inspection. For example, the plywood may be subjected to operations such as, but not limited to, measurement, classification, cooling, storage following cooling, sanding, formatting, and packaging.

### Adhesive Resin Compositions

As described herein above, adhesive resin composition may be used at one or more points in the production process of a wood-based panel. The following is a description of example adhesive resin compositions according to the present disclosure.

An adhesive resin composition of the present disclosure includes one or more thermosetting resins. As used herein, a “resin” refers to a viscous substance of plant or synthetic origin that is capable of being converted into polymers. As used herein, a “thermosetting resin” is a resin that hardens (i.e., cures) upon the application of heat.

In some embodiments, the one or more thermosetting resins may include one or more formaldehyde-based resins. Example formaldehyde-based resins include, but are not limited to, urea formaldehyde, melamine urea formaldehyde, and phenol formaldehyde.

In some embodiments, the one or more thermosetting resins may include one or more isocyanate-based resins. An example isocyanate-based resin is polymeric methylene di-isocyanate.

In some embodiments, the one or more thermosetting resins may include a combination of one or more formaldehyde-based resins and one or more isocyanate-based resins.

In addition to including one or more thermosetting resins, an adhesive resin composition of the present disclosure includes nanocellulose. As used herein, “nanocellulose” refers to cellulose structures with one dimension (e.g., diameter) in the sub-micron region (i.e., <1 μm).

In some embodiments, the nanocellulose may include cellulose nanofiber (CNF). CNF refers to cellulose structures having a diameter of about 5 nm to about 10 nm, and an average length of about 50 nm to about 100 nm. To produce CNF, wood may be crushed into woodchips of about 5 cm in width and 1 cm in thickness. At a paper mill, fibers are extracted from the woodchips and pulped. The pulp is then chemically processed to produce thin pieces, followed by application of high pressure to loosen the wood fibers, producing CNF.

In some embodiments, the nanocellulose may include nanofibrillated cellulose (NFC). NFC refers to cellulose fibers that have been fibrillated (via mechanical disintegration) to achieve agglomerates of cellulose microfibril units. NFC has nanoscale (e.g., <100 nm) diameter, and a typical length of several micrometers. NFC may be produced from various cellulosic sources including, but not limited to, wood, bleached kraft pulp, bleached sulfite pulp, sugar beet pulp, wheat straw and soy hulls, sisal, bagasse, palm trees, ramie, carrots, and luffa cylindrical. NFC may be produced using various mechanical disintegration processes and systems such as, but not limited to, a homogenizer system, a microfluidizer, and a grinder.

In some embodiments, the nanocellulose may include cellulose nanocrystals (CNCs). CNCs are a derivative of cellulose, which can be obtained through acid hydrolysis of cellulose, where the cellulose is exposed to (e.g., sulfuric) acid under controlled temperature for a time period. CNCs can be isolated from various renewable resources such as plants (e.g., cotton and wood), bacteria, and sea animals. Depending on the isolation method utilized and the source of the cellulose, CNCs can range from 5 nm to 30 nm in diameter, and have aspect ratios up to about 100. CNCs can have high specific strength and Young's modulus. Moreover, the active hydroxyl surface groups of CNCs enable chemical functionalization.

In some embodiments, the nanocellulose may include microfibrillated cellulose (MFC). As used herein, “microfibrillated cellulose” and “MFC” both refer to a nanoscale cellulose particle fiber or fibril with at least one dimension less than about 100 nm. MFC comprises partly or totally fibrillated cellulose or lignocellulose fibers. The liberated fibrils have a diameter less than about 100 nm, whereas the actual fibril diameter or particle size distribution and/or aspect ratio (length/width) depends on the source and the manufacturing methods.

The smallest fibril is called elementary fibril and has a diameter of approximately 2 nm to 4 nm (see, e.g., Chinga-Carrasco, G., Cellulose fibres, nanofibrils and microfibrils: The morphological sequence of MFC components from a plant physiology and fibre technology point of view, Nanoscale Research Letters 2011, 6:417), while it is common that the aggregated form of the elementary fibrils, also defined as microfibril (see, e.g., Fengel, D., Ultrastructural behavior of cell wall polysaccharides, Tappi J., March 1970, Vol 53, No. 3.), is the main product that is obtained when making MFC (e.g., by using an extended refining process or pressure-drop disintegration process). Depending on the source and the manufacturing process, the length of the fibrils can vary from around 1 μm to more than 10 μm. A coarse MFC grade might contain a substantial fraction of fibrillated fibers (i.e., protruding fibrils from the tracheid (cellulose fiber)), and with a certain amount of fibrils liberated from the tracheid (cellulose fiber).

MFC can also be characterized by various physico-chemical properties, such as large surface area or its ability to form a gel-like material at low solid contents (e.g., 1 wt % to 5 wt %) when dispersed in water. The cellulose fiber is preferably fibrillated to such an extent that the final specific surface area of the formed MFC is from about 1 m²/g to about 300 m²/g, such as from about 1 m²/g to about 200 m²/g, or more preferably about 50 m²/g to about 200 m²/g, when determined for a freeze-dried material with the Brunauer, Emmett, and Teller (BET) method.

In some embodiments, the MFC may have a Schopper Riegler value (SR.degree.) of more than about 85 SR.degree, more than about 90 SR.degree, or more than about 92 SR. degree. The Schopper-Riegler value can be determined through the standard method defined in EN ISO 5267-1.

MFC may be characterized by its mean particle size. One technique for measuring the mean particle size of MFC involves laser light scattering, using a Malvern Insitec machine as supplied by Malvern Instruments Ltd (or other methods that give essentially the same result). In the laser light scattering technique, the size of particles in powders, suspensions, and emulsions may be measured using the diffraction of a laser beam, based on an application of Mie theory. Such a machine provides measurements and a plot of the cumulative percentage by volume of particles having an “equivalent spherical diameter” (e.s.d.), less than given e.s.d. values. The mean particle size d₅₀ is the value determined in this way of the particle e.s.d. at which there are 50% by volume of the particles which have an equivalent spherical diameter less than that d₅₀ value.

The following is an example procedure for determining particle size distribution of MFC as measured by a Malvern Insitec L light scattering device. To start, it is beneficial to ensure that the MFC slurry is homogeneous by shaking the container contents vigorously. If grinding media is present in the sample, a 850 micron screen may be used to remove the grinding media before running the Malvern analysis. If no grinding medium is present, the slurry may be pipetted from the sample. Turn on the Malvern Insitec unit and start the pump by pressing the pump speed on/off button on top of the Malvern unit and set the speed at 2500 rpm and ensure that the ultrasonic is off. Ensure that the Malvern Insitec is clean by flushing the unit 2-3 times with clean, room temperature water ±5° C. Raise the stirrer to the marked drain position and remove the outlet hose and syphon the solution from the system ensuring that the inlet hose is lifted to drain any trapped solution. Replace water with clean room temperature tap water ±5° C. (800 ml to 900 ml). Fully push down the Malvern stirrer and the pump will start automatically. If the water is very turbulent turn the pump off and on again to help settle the water. Lift the outlet hose to remove any trapped air.

The MFC may have a d₅₀ value ranging from about 1 μm to about 500 μm, as measured by laser light scattering. The MFC may a d₅₀ value equal to or less than about 400 μm, equal to or less than about 300 μm, equal to or less than about 200 μm, equal to or less than about 150 μm, equal to or less than about 125 μm, equal to or less than about 100 μm, equal to or less than about 90 μm, equal to or less than about 80 μm, equal to or less than about 70 μm, equal to or less than about 60 μm, equal to or less than about 50 μm, equal to or less than about 40 μm, equal to or less than about 30 μm, equal to or less than about 20 μm, or equal to or less than about 10 μm.

The MFC may have a modal fibre particle size ranging from about 0.1 μm to about 500 μm, and a modal inorganic particulate material particle size ranging from about 0.25 μm to about 20 μm. The MFC may have a modal fibre particle size of at least about 0.5 μm, at least about 10 μm, at least about 50 μm, at least about 100 μm, at least about 150 μm, at least about 200 μm, at least about 300 μm, or at least about 400 μm.

The MFC may additionally or alternatively be characterized in terms of fibre steepness. Fibre steepness (i.e., the steepness of the particle size distribution of the fibres in the MFC) may be determined by the following formula:

Steepness=100×(d₃₀/d₇₀)

The MFC may have a fibre steepness equal to or less than about 100, equal to or less than about 75, equal to or less than about 50, equal to or less than about 40, or equal to or less than about 30. In some embodiments, the MFC may have a fibre steepness of about 20 to about 50.

MFC may be characterized by fibre length (Lc(w) ISO). The MFC may have a fibre length of less than about 0.7 mm, less than about 0.6 mm, less than about 0.5 mm, less than about 0.4 mm, less than about 0.3 mm, less than about 0.2 mm, or less than about 0.1 mm as measured by a fiber image analyzer. In some embodiments, the MFC may have a fibre length of less than about 0.7 mm.

The nanocellulose may be present in the adhesive resin composition in varying amounts. As used herein, reference to the “total weight of the adhesive resin composition” includes all components of the adhesive resin composition including the weight of all liquids present in the adhesive resin composition unless otherwise stated.

The nanocellulose may be present in an amount of at least about 0.01 wt %, 0.05 wt %, 0.1 wt %, 0.15 wt %, 0.2 wt %, 0.5 wt %, 0.7 wt %, or 1.0 wt %, 5 wt %, 10 wt %, 15 wt %, 20 wt %, 25 wt %, 30 wt %, 35 wt %, 40 wt %, 45 wt %, or 50 wt %, of the total weight of the adhesive resin composition. In some embodiments, the nanocellulose may be present in an amount of at least about 0.2 wt % of the total weight of the adhesive resin composition. In some embodiments, the nanocellulose may be present in an amount of at least about 0.5 wt % of the total weight of the adhesive resin composition.

The nanocellulose may be at most about 50 wt %, at most about 45 wt %, at most about 40 wt %, at most about 35 wt %, at most about 30 wt %, at most about 25 wt %, at most about 20 wt %, at most about 15 wt %, at most about 10 wt %, at most about 5 wt %, or at most about 3 wt % of the total weight of the adhesive resin composition. In some embodiments, the nanocellulose may be present in an amount of at most about 50 wt % of the total weight of the adhesive resin composition.

In some embodiments, the nanocellulose may be about 0.1 wt % to about 50 wt %, about 0.1 wt % to about 45 wt %, about 0.1 wt % to about 40 wt %, about 0.1 wt % to about 35 wt %, about 0.1 wt % to about 30 wt %, about 0.1 wt % to about 25 wt %, about 0.1 wt % to about 20 wt %, about 0.1 wt % to about 15 wt %, about 0.1 wt % to about 10 wt %, or about 0.1 wt % to about 5 wt % of the total weight of the adhesive resin composition. In some embodiments, the nanocellulose may be about 0.1 wt % to about 50 wt % of the total weight of the adhesive resin composition.

In some embodiments, the nanocellulose may be about 0.2 wt % to about 50 wt %, about 0.2 wt % to about 45 wt %, about 0.2 wt % to about 40 wt %, about 0.2 wt % to about 35 wt %, about 0.2 wt % to about 30 wt %, about 0.2 wt % to about 25 wt %, about 0.2 wt % to about 20 wt %, about 0.2 wt % to about 15 wt %, about 0.2 wt % to about 10 wt %, or about 0.2 wt % to about 5 wt % of the total weight of the adhesive resin composition. In some embodiments, the nanocellulose may be about 0.2 wt % to about 50 wt % of the total weight of the adhesive resin composition.

In some embodiments, the nanocellulose may be about 0.5 wt % to about 50 wt %, about 0.5 wt % to about 45 wt %, about 0.5 wt % to about 40 wt %, about 0.5 wt % to about 35 wt %, about 0.5 wt % to about 30 wt %, about 0.5 wt % to about 25 wt %, about 0.5 wt % to about 20 wt %, about 0.5 wt % to about 15 wt %, about 0.5 wt % to about 10 wt %, about 0.5 wt % to about 5 wt %, or about 0.5 wt % to about 3 wt % of the total weight of the adhesive resin composition. In some embodiments, the nanocellulose may be about 0.5 wt % to about 50 wt % of the total weight of the adhesive resin composition.

The nanocellulose may be present in an amount of at least about 0.01 wt %, 0.05 wt %, 0.1 wt %, 0.15 wt %, 0.2 wt %, 0.5 wt %, 0.7 wt %, or 1.0 wt %, 5 wt %, 10 wt %, 15 wt %, 20 wt %, 25 wt %, 30 wt %, 35 wt %, 40 wt %, 45 wt %, or 50 wt %, of the total solid content of the adhesive resin composition. In some embodiments, the nanocellulose may be present in an amount of at least about 40 wt % of the total solid content of the adhesive resin composition. In some embodiments, the nanocellulose may be present in an amount of at most about 50 wt % of the total solid content of the adhesive resin composition.

The nanocellulose may contain some hemicelluloses, of which the amount is dependent on the plant source. Mechanical disintegration of the pre-treated fibers (e.g. hydrolysed, pre-swelled, or oxidized cellulose raw material) is carried out with suitable equipment such as a refiner, grinder, homogenizer, colloider, friction grinder, ultrasound sonicator, fluidizer such as microfluidizer, macrofluidizer or fluidizer-type homogenizer.

Depending on the manufacturing method utilized, the nanocellulose might also contain fines or other chemicals present in wood fibers or in papermaking process. The nanocellulose might also contain various amounts of micron size fiber particles that have not been efficiently fibrillated.

The nanocellulose may be produced from wood cellulose fibers, both from hardwood or softwood fibers. The nanocellulose can also be made from microbial sources, agricultural fibers such as wheat straw pulp, bamboo, bagasse, or other non-wood fiber sources. The nanocellulose may also be made from pulp including pulp from virgin fiber (e.g., mechanical, chemical, and/or thermomechanical pulps). In some embodiments, the nanocellulose may be obtained from a chemical pulp, or a chemithermomechanical pulp, or a mechanical pulp, or thermomechanical pulp, including, for example, Northern Bleached Softwood Kraft pulp (“NBSK”), Bleached Chemi-Thermo Mechanical Pulp (“BCTMP”), a recycled pulp, a paper broke pulp, a paper mill waste stream, or a combination thereof. In some embodiments, the pulp source may be kraft pulp, or bleached long fibre kraft pulp. In some embodiments, the pulp source may be softwood pulp selected from spruce, pine, fir, larch and hemlock or mixed softwood pulp. In some embodiments, the pulp source may be hardwood pulp selected from eucalyptus, aspen and birch, or mixed hardwood pulps. In some embodiments, the pulp source may be eucalyptus pulp, spruce pulp, pine pulp, beech pulp, hemp pulp, acacia cotton pulp, and mixtures thereof.

The nanocellulose may be derived from recycled pulp or a papermill broke and/or industrial waste, or a paper stream rich in mineral fillers and cellulosic materials from a papermill. The recycled cellulose pulp may be beaten (e.g., in a Valley beater) and/or otherwise refined (e.g., processing in a conical or plate refiner) to any predetermined freeness, reported in the art as Canadian standard freeness (CSF) in cm³. CSF means a value for the freeness or drainage rate of pulp measured by the rate that a suspension of pulp may be drained, and this test is carried out according to the T 227 cm-09 TAPPI standard. For example, the cellulose pulp may have a CSF of about 10 cm³ or greater prior to undergoing processing into nanocellulose. The recycled cellulose pulp may have a CSF of about 700 cm³ or less, for example, equal to or less than about 650 cm³, equal to or less than about 600 cm³, equal to or less than about 550 cm³, equal to or less than about 500 cm³, equal to or less than about 450 cm³, equal to or less than about 400 cm³, equal to or less than about 350 cm³, o equal to or less than about 300 cm³, equal to or less than about 250 cm³, equal to or less than about 200 cm³, equal to or less than about 150 cm³, equal to or less than about 100 cm³, or equal to or less than about 50 cm³. The recycled cellulose pulp may have a CSF of about 20 to about 700. The recycled cellulose pulp may then be dewatered by methods well known in the art, for example, the pulp may be filtered through a screen in order to obtain a wet sheet comprising at least about 10% solids, for example at least about 15% solids, at least about 20% solids, at least about 30% solids, or at least about 40% solids.

In some embodiments, an adhesive resin composition of the present disclosure may include one or more organic particulate materials. The inorganic particulate material, when present, may, for example, be an alkaline earth metal carbonate or sulphate, such as calcium carbonate, magnesium carbonate, dolomite, gypsum, a clay such as hydrous kandite clay such as kaolin, halloysite or ball clay, an anhydrous (calcined) kandite clay such as metakaolin or fully calcined kaolin, talc, mica, perlite or diatomaceous earth, or magnesium hydroxide, or aluminum trihydrate, or combination thereof. In some embodiments, the adhesive resin composition may include calcium carbonate, clay, aluminum trihydrate, or a combination of any two or more thereof.

In some instances, the calcium carbonate may be ground calcium carbonate (GCC). GCC is typically obtained by crushing and then grinding a mineral source such as chalk, marble, or limestone, which may be followed by a particle size classification step, in order to obtain a product having the desired degree of fineness. Other techniques such as bleaching, flotation, and magnetic separation may also be used to obtain a product having the desired degree of fineness and/or color. The particulate solid material may be ground autogenously (i.e., by attrition between the particles of the solid material themselves, or, alternatively, in the presence of a particulate grinding medium comprising particles of a different material from the calcium carbonate to be ground). These processes may be carried out with or without the presence of a dispersant and biocides, which may be added at any stage of the process.

In some instances, the calcium carbonate may be precipitated calcium carbonate (PCC). PCC may be used as the source of particulate calcium carbonate in the nanocellulose disclosed herein, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present disclosure. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process, the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral, and scalenohedral, all of which are suitable for use in the herein disclosed nanocellulose, including mixtures thereof.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

As noted above, in some embodiments the nanocellulose may include kaolin clay. The kaolin clay may be a processed material derived from a natural source, namely raw natural kaolin clay mineral. The processed kaolin clay may typically contain at least about 50% by weight kaolinite. For example, most commercially processed kaolin clays contain greater than about 75% by weight kaolinite and may contain greater than about 90%, in some cases greater than about 95% by weight of kaolinite.

The kaolin may be prepared from the raw natural kaolin clay mineral by one or more other processes which are well known to those skilled in the art, for example by known refining or beneficiation steps. For example, the clay mineral may be bleached with a reductive bleaching agent, such as sodium hydrosulfite. If sodium hydrosulfite is used, the bleached clay mineral may optionally be dewatered, and optionally washed and again optionally dewatered, after the sodium hydrosulfite bleaching step.

The clay mineral may be treated to remove impurities, for example, by flocculation, flotation, or magnetic separation techniques well known in the art. Alternatively, the clay mineral may be untreated in the form of a solid or as an aqueous suspension.

The process for preparing the particulate kaolin clay may also include one or more comminution steps (e.g., grinding or milling). The comminution may be carried out by use of beads or granules of a plastic (e.g. nylon), sand or ceramic grinding or milling aid. The coarse kaolin may be refined to remove impurities and improve physical properties using well known procedures. The kaolin clay may be treated by a known particle size classification procedure (e.g., screening and centrifuging (or both)), to obtain particles having a desired d₅₀ value or particle size distribution.

When the inorganic particulate material is obtained from naturally occurring sources, it may be that some mineral impurities will contaminate the ground material. For example, naturally occurring calcium carbonate can be present in association with other minerals. Thus, in some embodiments, the inorganic particulate material includes some extent of impurities. In general, however, the inorganic particulate material may contain less than about 5% by weight, preferably less than about 1% by weight, of other mineral impurities.

In some circumstances, one or more other minerals may be included in the nanocellulose of the present disclosure. Such one or more other minerals include, for example, kaolin, calcined kaolin, wollastonite, bauxite, talc, and mica.

The inorganic particulate material may have a particle size distribution in which at least about 10% by weight of the particles have an equivalent spherical diameter (e.s.d.) of less than 2 μm, for example, at least about 20% by weight, at least about 30% by weight, at least about 40% by weight, at least about 50% by weight, at least about 60% by weight, at least about 70% by weight, at least about 80% by weight, at least about 90% by weight, at least about 95% by weight, or about 100% of the particles have an e.s.d. of less than 2 μm.

Particle size properties, referred to herein for the inorganic particulate materials, may be measured in a well-known manner. For example, the particle size properties of the inorganic particular materials may be measured by sedimentation of the particulate material in a fully dispersed condition in an aqueous medium using a Sedigraph 5100 machine as supplied by Micromeritics Instruments Corporation, Norcross, Ga., USA. Such a machine provides measurements and a plot of the cumulative percentage by weight of particles having a size, referred to in the art as the “equivalent spherical diameter” (e.s.d), less than given e.s.d. values. The mean particle size d₅₀ is the value determined in this way of the particle e.s.d. at which there are 50% by weight of the particles which have an equivalent spherical diameter less than that d₅₀ value.

As another example, the particle size properties for the inorganic particulate materials may be measured by the well-known conventional method employed in the art of laser light scattering, using a Malvern Insitec machine as supplied by Malvern Instruments Ltd (or by other methods which give essentially the same result). In the laser light scattering technique, the size of particles in powders, suspensions, and emulsions may be measured using the diffraction of a laser beam, based on an application of Mie theory. Such a machine provides measurements and a plot of the cumulative percentage by volume of particles having an e.s.d. less than given e.s.d. values. The mean particle size d₅₀ is the value determined in this way of the particle e.s.d. at which there are 50% by volume of the particles which have an equivalent spherical diameter less than that d₅₀ value.

In some embodiments, an adhesive resin composition of the present disclosure may include one or more additives. For example, the adhesive resin composition may include a hardener, an emulsion, a fire retardant, and any combination of two or more thereof.

Unless stated otherwise, reference to a “hardener” herein means a material that increases the curing rate of the adhesive resin composition. A hardener may sometimes be referred to as a catalyst. Example hardeners include, but are not limited to, ammonium chloride and metal chloride. Example metal chlorides include, but are not limited to, aluminum chloride, zinc chloride, and magnesium chloride. In some embodiments, an adhesive resin composition of the present disclosure may include ammonium chloride and/or metal chloride.

Unless stated otherwise, reference to an “emulsion” herein means a compound or composition configured to reduce water absorption of a wood-based panel of which the emulsion is a component. An emulsion may sometimes be referred to as a wax. Example emulsions include, but are not limited to, polyvinyl acetate emulsion and paraffin emulsion. In some embodiments, an adhesive resin composition of the present disclosure may include polyvinyl acetate emulsion and/or paraffin emulsion.

Unless stated otherwise, reference to a “fire retardant” herein means a compound or composition configured to provide fire retardant properties to a wood-based panel of which the fire retardant is a component. Example fire retardants include, but are not limited to, zinc oxide, aluminum hydroxide, and ammonium polyphosphate. In some embodiments, an adhesive resin composition of the present disclosure may include zinc oxide, aluminum hydroxide, and/or ammonium polyphosphate.

In some embodiments, an adhesive resin composition of the present disclosure may include a solvent. In some embodiments, the solvent may be water, alcohol, toluene, or a combination thereof. In some embodiments, the alcohol may comprise one or more of ethanol, glycerol, and polyvinyl alcohol.

Adhesive resin compositions of the present disclosure may have a distinctive rheology profile from that of the liquid resin included therein. In some embodiments, an adhesive resin composition of the present disclosure may have a shear viscosity of >100 pascal-second (Pa·s) at a shear rate of 0.1 s⁻¹. In some embodiments, an adhesive resin composition of the present disclosure may have a shear viscosity of <1 Pa·s at a shear rate of 1000 s⁻¹. In some embodiments, an adhesive resin composition of the present disclosure may have a shear viscosity of >100 pascal-second (Pa·s) at a shear rate of 0.1 s⁻¹, and <1 Pa·s at a shear rate of 1000 s⁻¹. Shear viscosity curves may be recorded on a Kinexus pro+ rheometer (Netzsch Instruments) at 25° C., using a cone (CP4/40 SR1877) and plate (PL61 ST S1555) measurement geometry. The shear rate for the sample measurement may be ramped up from 0.01 s⁻¹ to 1000 s⁻¹, with 10 samples per decade.

### Fibrous Substrate Comprising Cellulose

A fibrous substrate comprising cellulose (variously referred to herein as “fibrous substrate comprising cellulose,” “cellulose fibres,” “fibrous cellulose feedstock,” “cellulose feedstock” and “cellulose-containing fibres (or fibrous,” etc.) may be derived from virgin or recycled pulp.

The fibrous substrate comprising cellulose may be derived from any suitable source, such as wood, grasses (e.g., sugarcane, bamboo) or rags (e.g., textile waste, cotton, hemp or flax). The fibrous substrate comprising cellulose may be in the form of a pulp (i.e., a suspension of cellulose fibres in water), which may be prepared by any suitable chemical or mechanical treatment, or combination thereof. For example, the pulp may be a chemical pulp, or a chemithermomechanical pulp, or a mechanical pulp, or a recycled pulp, or a papermill broke, or a papermill waste stream, or waste from a papermill, or a combination thereof. The cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilized in an unrefined state, that is to say, without being beaten or dewatered, or otherwise refined.

The cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained, and this test is carried out according to the T 227 cm-09 TAPPI standard. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The cellulose pulp may have a CSF of about 20 to about 700. The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilized in an unrefined state, that is to say, without being beaten or dewatered, or otherwise refined.

Microfibrillated cellulose may be produced by any method of reducing the particle size of polysaccharides as would be known to a person of ordinary skill in the art. However, methods for reducing particle size while preserving a high aspect ratio in the polysaccharide are preferred. In particular, the at least one microfibrillated cellulose may be produced by a method selected from the group consisting of grinding; sonication; homogenization; impingement mixer; heat; steam explosion; pressurization-depressurization cycle; freeze-thaw cycle; impact; grinding (such as a disc grinder); pumping; mixing; ultrasound; microwave explosion; and/or milling. Various combinations of these may also be used, such as milling followed by homogenization. In one embodiment, the at least one microfibrillated cellulose is formed by subjecting one or more cellulose-containing raw materials to a sufficient amount of shear in an aqueous suspension such that a portion of the crystalline regions of the cellulose fibers in the one or more cellulose-containing raw materials are fibrillated.

Microfibrillation of the fibrous substrate comprising cellulose may be obtained under wet conditions in the presence of the inorganic particulate material by a method in which the mixture of cellulose pulp and inorganic particulate material is pressurized (for example, to a pressure of about 500 bar) and then passed to a zone of lower pressure. The rate at which the mixture is passed to the low pressure zone is sufficiently high and the pressure of the low pressure zone is sufficiently low as to cause microfibrillation of the cellulose fibres. For example, the pressure drop may be obtained by forcing the mixture through an annular opening that has a narrow entrance orifice with a much larger exit orifice. The drastic decrease in pressure as the mixture accelerates into a larger volume (i.e., a lower pressure zone) induces cavitation which causes microfibrillation. In an embodiment, microfibrillation of the fibrous substrate comprising cellulose may be obtained in a homogenizer under wet conditions in the presence of the inorganic particulate material. In the homogenizer, the cellulose pulp-inorganic particulate material mixture is pressurized (for example, to a pressure of about 500 bar), and forced through a small nozzle or orifice. The mixture may be pressurized to a pressure of from about 100 to about 1000 bar, for example to a pressure of equal to or greater than 300 bar, or equal to or greater than about 500, or equal to or greater than about 200 bar, or equal to or greater than about 700 bar. The homogenization subjects the fibres to high shear forces such that as the pressurized cellulose pulp exits the nozzle or orifice, cavitation causes microfibrillation of the cellulose fibres in the pulp. Additional water may be added to improve flowability of the suspension through the homogenizer. The resulting aqueous suspension comprising microfibrillated cellulose and inorganic particulate material may be fed back into the inlet of the homogenizer for multiple passes through the homogenizer. In a preferred embodiment, the inorganic particulate material is a naturally platy mineral, such as kaolin. As such, homogenization not only facilitates microfibrillation of the cellulose pulp, but also facilitates delamination of the platy particulate material.

The microfibrillated cellulose may be in the form of at least one of a dispersion (e.g., in a gel or gelatinous form), a diluted dispersion, and/or in a suspension.

### Production of MFC

By “microfibrillating” is meant a process in which microfibrils of cellulose are liberated or partially liberated as individual species or as small aggregates as compared to the fibres of the pre-microfibrillated pulp. Typical cellulose fibres (i.e., pre-microfibrillated pulp) suitable for use in papermaking include larger aggregates of hundreds or thousands of individual cellulose fibrils.

Microfibrillating of cellulose involves stripping away the outer layers of cellulose fibers that may have been exposed through mechanical shearing, with or without prior enzymatic or chemical treatment. There are numerous methods of preparing microfibrillated cellulose that are known in the art.

The particle size distribution and/or aspect ratio (length/width) of the cellulose microfibrils attached to the fibrillated cellulose fiber or as a liberated microfibril depends on the source and the manufacturing methods employed in the microfibrillation process.

In a non-limiting example, the aspect ratio of microfibrils is typically high and the length of individual microfibrils may be more than one micrometer and the diameter may be within a range of about 5 to 60 nm with a number-average diameter typically less than 20 nm. The diameter of microfibril bundles may be larger than 1 micron, however, it is usually less than one.

Depending on the source of the cellulose fibers and the manufacturing process employed to microfibrillate the cellulose fibres, the length of the fibrils can vary, frequently from about 1 to greater than 10 micrometers.

A coarse MFC grade might contain a substantial fraction of fibrillated fibers, i.e., protruding fibrils from the tracheid (cellulose fiber), and with a certain amount of fibrils liberated from the tracheid (cellulose fiber).

The microfibrillated cellulose may, for example, be treated prior to dewatering and/or drying. For example, one or more additives as specified below (e.g. salt, sugar, glycol, urea, glycol, carboxymethyl cellulose, guar gum, or a combination thereof as specified below) may be added to the microfibrillated cellulose. For example, one or more oligomers (e.g. with or without the additives specified above) may be added to the microfibrillated cellulose. For example, one or more inorganic particulate materials may be added to the microfibrillated cellulose to improve dispersibility (e.g. talc or minerals having a hydrophobic surface-treatment such as a stearic acid surface-treatment (e.g. stearic acid treated calcium carbonate). The additives may, for example, be suspended in low dielectric solvents. The microfibrillated cellulose may, for example, be in an emulsion, for example an oil/water emulsion, prior to dewatering and/or drying. The microfibrillated cellulose may, for example, be in a masterbatch composition, for example a polymer masterbatch composition and/or a high solids masterbatch composition, prior to dewatering and/or drying. The microfibrillated cellulose may, for example, be a high solids composition (e.g. solids content equal to or greater than about 60 wt % or equal to or greater than about 70 wt % or equal to or greater than about 80 wt % or equal to or greater than about 90 wt % or equal to or greater than about 95 wt % or equal to or greater than about 98 wt % or equal to or greater than about 99 wt %) prior to dewatering and/or drying. Any combination of one or more of the treatments may additionally or alternatively be applicable to the microfibrillated cellulose after dewatering and drying but prior to or during re-dispersion.

The fibrous substrate comprising cellulose may be added to a grinding vessel in a dry state. For example, a dry paper broke may be added directly to the grinder vessel. The aqueous environment in the grinder vessel will then facilitate the formation of a pulp.

Methods of manufacturing MFC include mechanical disintegration by refining, milling, beating and homogenizing, and refining, for example, by an extruder. These mechanical measures may be enhanced by chemical or chemo-enzymatic treatments as a preliminary step. Various known methods of microfibrillation of cellulosic fibres are summarized in U.S. Pat. No. 6,602,994 B1 as including, for example, homogenization, steam explosion, pressurization-depressurization, impact, grinding, ultrasound, microwave explosion, milling and combinations of these. WO 2007/001229 discloses enzyme treatment and, as a method of choice, oxidation in the presence of a transition metal for turning cellulosic fibres to MFC. After the oxidation step, the material is disintegrated by mechanical means. A combination of mechanical and chemical treatment can also be used. Examples of chemicals that can be used are those that either modify the cellulose fibers through a chemical reaction or those that modify the cellulose fibers via, for example, grafting or sorption of chemicals onto/into the fibers.

Various methods of producing MFC are known in the art. Certain methods and compositions comprising MFC produced by grinding procedures are described in WO 2010/131016. Husband, J. C., Svending, P., Skuse, D. R., Motsi, T., Likitalo, M., Coles, A., FiberLean Technologies Ltd., 2015, “Paper filler composition,” PCT International Application No. WO-A-2010/131016. Paper products comprising such MFC have been shown to exhibit excellent paper properties, such as paper burst and tensile strength. The methods described in WO-A-2010/131016 also enable the production of MFC economically.

WO 2007/091942 A1 describes a process in which chemical pulp is first refined, then treated with one or more wood degrading enzymes, and finally homogenized to produce MFC as the final product. The consistency of the pulp is described to be preferably from about 0.4% to about 10%. The advantage is said to be avoidance of clogging in the high-pressure fluidizer or homogenizer.

WO2010/131016 describes a grinding procedure for the production of MFC with or without inorganic particulate material. Such a grinding procedure is described below. In an embodiment of the process set forth in WO-A-2010/131016, the contents of which is hereby incorporated by reference in its entirety, the process utilizes mechanical disintegration of cellulose fibres to produce MFC cost-effectively and at large scale, without requiring cellulose pre-treatment. An embodiment of the method uses stirred media detritor grinding technology, which disintegrates fibres into MFC by agitating grinding media beads. In this process, a mineral such as calcium carbonate or kaolin is added as a grinding aid, greatly reducing the energy required. Husband, J. C., Svending, P., Skuse, D. R., Motsi, T., Likitalo, M., Coles, A., FiberLean Technologies Ltd., 2015, “Paper filler composition,” U.S. Pat. No. 9,127,405 B2.

A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

### Homogenization Preparation of MFC

In some embodiments, microfibrillation of a fibrous substrate comprising cellulose may be effected under wet conditions in the presence of the inorganic particulate material by a method in which the mixture of cellulose pulp and inorganic particulate material is pressurized (for example, to a pressure of about 500 bar) and then passed to a zone of lower pressure. The rate at which the mixture is passed to the low-pressure zone is sufficiently high and the pressure of the low pressure zone is sufficiently low to cause microfibrillation of the cellulose fibres. For example, the pressure drop may be affected by forcing the mixture through an annular opening that has a narrow entrance orifice with a much larger exit orifice. The drastic decrease in pressure as the mixture accelerates into a larger volume (i.e., a lower pressure zone) induces cavitation which causes microfibrillation. In an embodiment, microfibrillation of the fibrous substrate comprising cellulose may be affected in a homogenizer under wet conditions in the presence of the inorganic particulate material. In the homogenizer, the cellulose pulp-inorganic particulate material mixture is pressurized (for example, to a pressure of about 500 bar), and forced through a small nozzle or orifice. The mixture may be pressurized to a pressure of from about 100 to about 1000 bar, for example to a pressure equal to or greater than 200 bar, equal to or greater than about 300 bar, equal to or greater than about 500, or equal to or greater than about 700 bar. The homogenization subjects the fibres to high shear forces such that as the pressurized cellulose pulp exits the nozzle or orifice, cavitation causes microfibrillation of the cellulose fibres in the pulp.

Water may be added to improve flowability of the suspension through the homogenizer. The resulting aqueous suspension comprising MFC and inorganic particulate material may be fed back into the inlet of the homogenizer for multiple passes through the homogenizer. In some embodiments, the inorganic particulate material is a naturally platy mineral, such as kaolin. As such, homogenization not only facilitates microfibrillation of the cellulose pulp, but also facilitates delamination of the platy inorganic particulate material.

A platy inorganic particulate material, such as kaolin, is understood to have a shape factor of at least about 10, at least about 15, at least about 20, at least about 30, at least about 40, at least about 50, at least about 60, at least about 70, at least about 80, at least about 90, or at least about 100. Shape factor, as used herein, is a measure of the ratio of particle diameter to particle thickness for a population of particles of varying size and shape as measured using the electrical conductivity methods, apparatuses, and equations described in U.S. Pat. No. 5,576,617, which is incorporated herein by reference.

### Preparing an Aqueous Suspension of Microfibrillated Cellulose and Inorganic Particulate Material.

In certain embodiments, a fibrous substrate comprising cellulose may be microfibrillated in the presence of a grinding medium. The process is advantageously conducted in an aqueous environment.

The particulate grinding medium, when present, may be of a natural or a synthetic material. The grinding medium may, for example, comprise balls, beads or pellets of any hard mineral, ceramic or metallic material. Such materials may include, for example, alumina, zirconia, zirconium silicate, aluminum silicate or the mullite-rich material which is produced by calcining kaolinitic clay at a temperature in the range of from about 1300° C. to about 1800° C. For example, in some embodiments a Carbolite® grinding media is preferred. Alternatively, particles of natural sand of a suitable particle size may be used.

The grinding may be carried out in one or more stages. For example, a coarse inorganic particulate material may be ground in the grinder vessel to a predetermined particle size distribution, after which the fibrous material comprising cellulose is added and the grinding continued until the desired level of microfibrillation has been obtained. The coarse inorganic particulate material used in accordance with the first aspect of this disclosure initially may have a particle size distribution in which less than about 20% by weight of the particles have an equivalent spherical diameter (e.s.d.) of less than 2 μm for example, less than about 15% by weight, or less than about 10% by weight of the particles have an e.s.d. of less than 2 μm. In another embodiment, the coarse inorganic particulate material used in accordance with the first aspect of this disclosure initially may have a particle size distribution, as measured using a Malvern Insitec or equivalent apparatus, in which less than about 20% by volume of the particles have an e.s.d of less than 2 μm for example, less than about 15% by volume, or less than about 10% by volume of the particles have an e.s.d. of less than 2 μm. In another embodiment, the fibrous material containing cellulose may be ground in the presence of a grinding medium and in the absence of inorganic particulate matter, as described below.

The coarse inorganic particulate material may be wet or dry ground in the absence or presence of a grinding medium. In the case of a wet grinding stage, the coarse inorganic particulate material is preferably ground in an aqueous suspension in the presence of a grinding medium. In such a suspension, the coarse inorganic particulate material may preferably be present in an amount of from about 5% to about 85% by weight of the suspension; more preferably in an amount of from about 20% to about 80% by weight of the suspension. Most preferably, the coarse inorganic particulate material may be present in an amount of about 30% to about 75% by weight of the suspension. As described above, the coarse inorganic particulate material may be ground to a particle size distribution such that at least about 10% by weight of the particles have an e.s.d of less than 2 μm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% by weight of the particles, have an e.s.d of less than 2 μm after which the cellulose pulp is added and the two components are co-ground to microfibrillate the fibres of the cellulose pulp. In another embodiment, the coarse inorganic particulate material is ground to a particle size distribution, as measured using a Malvern Insitec apparatus (or equivalent) such that at least about 10% by volume of the particles have an e.s.d of less than 2 μm, for example, at least about 20% by volume, or at least about 30% by volume or at least about 40% by volume, or at least about 50% by volume, or at least about 60% by volume, or at least about 70% by volume, or at least about 80% by volume, or at least about 90% by volume, or at least about 95% by volume, or about 100% by volume of the particles, have an e.s.d of less than 2 μm after which the cellulose pulp is added and the two components are co-ground to microfibrillate the fibres of the cellulose pulp.

Generally, the type of and particle size of grinding medium to be selected for use in the disclosure may be dependent on the properties, e.g., the particle size of, and the chemical composition of, the feed suspension of material to be ground. Preferably, the particulate grinding medium comprises particles having an average diameter in the range of from about 0.1 mm to about 6.0 mm and, more preferably, in the range of from about 0.2 mm to about 4.0 mm. The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

Unless otherwise stated, particle size properties of the microfibrillated cellulose materials are as measured by the well-known conventional method employed in the art of laser light scattering, using a Malvern Insitec apparatus (or equivalent), as supplied by Malvern Instruments Ltd (or by other methods which give essentially the same result.

The fibrous substrate comprising cellulose may be in the form of a pulp (i.e., a suspension of cellulose fibres in water), which may be prepared by any suitable chemical or mechanical treatment, or combination thereof.

Details of the procedure used to characterise the particle size distributions of mixtures of inorganic particle material and microfibrillated cellulose using a Malvern Insitec apparatus (or equivalent) are provided below.

The fibrous substrate comprising cellulose may be microfibrillated in the presence of an inorganic particulate material to obtain microfibrillated cellulose having a d₅₀ ranging from about 5 μm to about 500 μm, as measured by laser light scattering. The fibrous substrate comprising cellulose may be microfibrillated in the presence of an inorganic particulate material to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated in the presence of an inorganic particulate material to obtain microfibrillated cellulose having a modal fibre particle size ranging from about 0.1-500 μm and a modal inorganic particulate material particle size ranging from 0.25-20 μm. The fibrous substrate comprising cellulose may be microfibrillated in the presence of an inorganic particulate material to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated in the presence of an inorganic particulate material to obtain microfibrillated cellulose having a fibre steepness equal to or greater than about 10, as measured by Malvern. Fibre steepness (i.e., the steepness of the particle size distribution of the fibres) is determined by the following formula:

Steepness=100×(d₃₀/d₇₀).

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

The finer mineral peak can be fitted to the measured data points and subtracted mathematically from the distribution to leave the fibre peak, which can be converted to a cumulative distribution. Similarly, the fibre peak can be subtracted mathematically from the original distribution to leave the mineral peak, which can also be converted to a cumulative distribution. Both these cumulative curves may then be used to calculate the mean particle size (d₅₀) and the steepness of the distribution (d₃₀/d₇₀×100). The differential curve may then be used to find the modal particle size for both the mineral and fibre fractions.

### Microfibrillated Cellulose Prepared Without Addition of Inorganic Particulate Material

In a preferred embodiment, the microfibrillated cellulose is prepared in accordance with a method comprising a step of microfibrillating a fibrous substrate comprising cellulose in an aqueous environment by grinding in the presence of a grinding medium which is to be removed after the completion of grinding, wherein the grinding is performed in a tower mill or a screened grinder, and wherein the grinding is carried out in the absence of grindable inorganic particulate material.

A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

A grindable inorganic particulate material is a material which would be ground in the presence of the grinding medium.

The particulate grinding medium may be of a natural or a synthetic material. The grinding medium may, for example, comprise balls, beads or pellets of any hard mineral, ceramic or metallic material. Such materials may include, for example, alumina, zirconia, zirconium silicate, aluminum silicate or the mullite-rich material which is produced by calcining kaolinitic clay at a temperature in the range of from about 1300° C. to about 1800° C. For example, in some embodiments a Carbolite® grinding media is preferred. Alternatively, particles of natural sand of a suitable particle size may be used.

Generally, the type of and particle size of grinding medium to be selected for use in the disclosure may be dependent on the properties, e.g., the particle size of, and the chemical composition of the feed suspension of material to be ground. Preferably, the particulate grinding medium comprises particles having an average diameter in the range of from about 0.5 mm to about 6 mm. In one embodiment, the particles have an average diameter of at least about 3 mm.

The grinding medium may comprise particles having a specific gravity of at least about 2.5. The grinding medium may comprise particles have a specific gravity of at least about 3, or least about 4, or least about 5, or at least about 6.

The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

The fibrous substrate comprising cellulose may be microfibrillated to obtain microfibrillated cellulose having a d∞ ranging from about 5 μm to about 500 μm, as measured by laser light scattering.

The fibrous substrate comprising cellulose may be microfibrillated to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated to obtain microfibrillated cellulose having a modal fibre particle size ranging from about 0.1-500 μm. The fibrous substrate comprising cellulose may be microfibrillated in the presence to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated to obtain microfibrillated cellulose having a fibre steepness equal to or greater than about 10, as measured by Malvern. Fibre steepness i.e., the steepness of the particle size distribution of the fibres) is determined by the following formula:

Steepness=100×(d₃₀/d₇₀)

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40. In an embodiment, a preferred steepness range is about 20 to about 50.

In one embodiment, the grinding vessel is a tower mill. The tower mill may comprise a quiescent zone above one or more grinding zones. A quiescent zone is a region located towards the top of the interior of a tower mill in which minimal or no grinding takes place and comprises microfibrillated cellulose and inorganic particulate material. The quiescent zone is a region in which particles of the grinding medium sediment down into the one or more grinding zones of the tower mill.

The tower mill may comprise a classifier above one or more grinding zones. In an embodiment, the classifier is top mounted and located adjacent to a quiescent zone. The classifier may be a hydrocyclone.

The tower mill may comprise a screen above one or more grind zones. In an embodiment, a screen is located adjacent to a quiescent zone and/or a classifier. The screen may be sized to separate grinding media from the product aqueous suspension comprising microfibrillated cellulose and to enhance grinding media sedimentation.

In another embodiment, the microfibrillated cellulose may be prepared in a stirred media detritor. A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

In an embodiment, the grinding is performed under plug flow conditions. Under plug flow conditions the flow through the tower is such that there is limited mixing of the grinding materials through the tower. This means that at different points along the length of the tower mill the viscosity of the aqueous environment will vary as the fineness of the microfibrillated cellulose increases. Thus, in effect, the grinding region in the tower mill can be considered to comprise one or more grinding zones which have a characteristic viscosity. A skilled person in the art will understand that there is no sharp boundary between adjacent grinding zones with respect to viscosity.

In an embodiment, water is added at the top of the mill proximate to the quiescent zone or the classifier or the screen above one or more grinding zones to reduce the viscosity of the aqueous suspension comprising microfibrillated cellulose at those zones in the mill. By diluting the product microfibrillated cellulose at this point in the mill it has been found that the prevention of grinding media carry over to the quiescent zone and/or the classifier and/or the screen is improved. Further, the limited mixing through the tower allows for processing at higher solids lower down the tower and dilute at the top with limited backflow of the dilution water back down the tower into the one or more grinding zones. Any suitable amount of water which is effective to dilute the viscosity of the product aqueous suspension comprising microfibrillated cellulose may be added. The water may be added continuously during the grinding process, or at regular intervals, or at irregular intervals.

In another embodiment, water may be added to one or more grinding zones via one or more water injection points positioned along the length of the tower mill, the or each water injection point being located at a position which corresponds to the one or more grinding zones. Advantageously, the ability to add water at various points along the tower allows for further adjustment of the grinding conditions at any or all positions along the mill.

The tower mill may comprise a vertical impeller shaft equipped with a series of impeller rotor disks throughout its length. The action of the impeller rotor disks creates a series of discrete grinding zones throughout the mitt.

In another embodiment, the grinding is performed in a screened grinder, preferably a stirred media detritor. The screened grinder may comprise one or more screen(s) having a nominal aperture size of at least about 250 μm, for example, the one or more screens may have a nominal aperture size of at least about 300 μm, or at least about 350 μm, or at least about 400 μm, or at least about 450 μm, or at least about 500 μm, or at least about 550 μm, or at least about 600 tin), or at least about 650 μm, or at least about 700 μm, or at least about 750 pin, or at least about 800 μm, or at least about 850 μm, or at or least about 900 μm, or at least about 1000 μm.

The screen sizes noted immediately above are applicable to the tower mill embodiments described above.

As noted above, the grinding is performed in the presence of a grinding medium. In an embodiment, the grinding medium is a coarse media comprising particles having an average diameter in the range of from about 1 mm to about 6 mm, for example about 2 mm, or about 3 mm, or about 4 mm, or about 5 mm.

In another embodiment, the grinding media has a specific gravity of at least about 2,5, for example, at least about 3, or at least about 3.5, or at least about 4.0, or at least about 4.5, or least about 5.0, or at least about 5.5, or at least about 6.0.

As described above, the grinding medium (or media) may be in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

In one embodiment, the grinding medium is present in amount of about 50% by volume of the charge.

By ‘charge’ is meant the composition which is the feed fed to the grinder vessel. The charge includes water, grinding media, the fibrous substrate comprising cellulose and any other optional additives (other than as described herein).

The use of a relatively coarse and/or dense media has the advantage of improved (i.e., faster) sediment rates and reduced media carry over through the quiescent zone and/or classifier and/or screen(s).

A further advantage in using relatively coarse screens is that a relatively coarse or dense grinding media can be used in the microfibrillating step. In addition, the use of relatively coarse screens having a nominal aperture of least about 250 μm) allows a relatively high solids product to be processed and removed from the grinder, which allows a relatively high solids feed (comprising fibrous substrate comprising cellulose and inorganic particulate material) to be processed in an economically viable process. As discussed below, it has been found that a teed having a high initial solids content is desirable in terms of energy sufficiency. Further, it has also been found that product produced (at a given energy) at lower solids has a coarser particle size distribution.

In accordance with one embodiment, the fibrous substrate comprising cellulose is present in the aqueous environment at an initial solids content of at least about 1 wt %. The fibrous substrate comprising cellulose may be present in the aqueous environment at an initial solids content of at least about 2 wt %, for example at least about 3 wt %, or at least about at least 4 wt %. Typically the initial solids content will be no more than about 10 wt %.

In another embodiment, the grinding is performed in a cascade of grinding vessels, one or more of which may comprise one or more grinding zones. For example, the fibrous substrate comprising cellulose may be ground in a cascade of two or more grinding vessels, for example, a cascade of three or more grinding vessels, or a cascade of four or more grinding vessels, or a cascade of five or more grinding vessels, or a cascade of six or more grinding vessels, or a cascade of seven or more grinding vessels, or a cascade of eight or more grinding vessels, or a cascade of nine or more grinding vessels in series, or a cascade comprising up to ten grinding vessels. The cascade of grinding vessels may be operatively inked in series or parallel or a combination of series and parallel. The output from and/or the input to one or more of the grinding vessels in the cascade may be subjected to one or more screening steps and/or one or more classification steps.

The total energy expended in a microfibrillation process may be apportioned equally across each of the grinding vessels in the cascade. Alternatively, the energy input may vary between some or all of the grinding vessels in the cascade.

A person skilled in the art will understand that the energy expended per vessel may vary between vessels in the cascade depending on the amount of fibrous substrate being microfibrillated in each vessel, and optionally the speed of grind in each vessel, the duration of grind in each vessel and the type of grinding media in each vessel. The grinding conditions may be varied in each vessel in the cascade in order to control the particle size distribution of the microfibrillated cellulose.

In an embodiment the grinding is performed in a closed circuit. In another embodiment, the grinding is performed in an open circuit.

As the suspension of material to be ground may be of a relatively high viscosity, a suitable dispersing agent may preferably be added to the suspension prior to grinding. The dispersing agent may be, for example, a water soluble condensed phosphate, polysilicic acid or a salt thereof, or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry inorganic particulate solid material. The suspension may suitably be ground at a temperature in the range of from 4° C. to 100° C.

Other additives which may be included during the microfibrillation step include: carboxymethyl cellulose, amphoteric carboxymethyl cellulose, oxidising agents, 2,2,6,6-Tetramethylpiperidine-1-oxyl (TEMPO), TEMPO derivatives, and wood degrading enzymes.

The pH of the suspension of material to be ground may be about 7 or greater than about 7 (i.e., basic), for example, the pH of the suspension may be about 8, or about 9, or about 10, or about 11. The pH of the suspension of material to be ground may be less than about 7 (i.e., acidic), for example, the pH of the suspension may be about 6, or about 5, or about 4, or about 3. The pH of the suspension of material to be ground may be adjusted by addition of an appropriate amount of acid or base. Suitable bases included alkali metal hydroxides, such as, for example NaOH. Other suitable bases are sodium carbonate and ammonia. Suitable acids included inorganic acids, such as hydrochloric and sulphuric acid, or organic acids. An exemplary acid is orthophosphoric acid.

The total energy input in a typical grinding process to obtain the desired aqueous suspension composition may typically be between about 100 and 1500 kWht⁻¹ based on the total dry weight of the inorganic particulate filler. The total energy input may be less than about 1000 kWht⁻¹, for example, less than about 800 kWht⁻¹, less than about 600 kWht⁻¹, less than about 500 kWht⁻¹, less than about 400 kWht⁻¹, less than about 300 kWht⁻¹, or less than about 200 kWht⁻¹. As such, the present inventors have surprisingly found that a cellulose pulp can be microfibrillated at relatively low energy input when it is co-ground in the presence of an inorganic particulate material. As will be apparent, the total energy input per tonne of dry fibre in the fibrous substrate comprising cellulose will be less than about 10,000 kWht⁻¹, for example, less than about 9000 kWht⁻¹, or less than about 8000 kWht⁻¹ or less than about 7000 kWht⁻¹, or less than about 6000 kWht⁻¹, or less than about 5000 kWht⁻¹ for example less than about 4000 kWht⁻¹, less than about 3000 kWht⁻¹, less than about 2000 kWht⁻¹, less than about 1500 kWht⁻¹ less than about 1200 kWht⁻¹, less than about 1000 kWht⁻¹, or less than about 800 kWht⁻¹. The total energy input varies depending on the amount of dry fibre in the fibrous substrate being microfibrillated, and optionally the speed of grind and the duration of mind.

### Production of NFC

Methods of manufacturing NFC are known in the art/industry. One or more art-/industry-known techniques may be used to produce NFC of the present disclosure. Example NFC production techniques are disclosed in U.S. Patent Application Publication No. 2021/0261781 A1, entitled “Process for the Production of Nano-Fibrillar Cellulose Gels,” to Gane et al.; U.S. Pat. No. 10,975,242, “Process for the Production of Nano-Fibrillar Cellulose Gels,” to Gane et al.; U.S. Pat. No. 10,294,371, “Process for the Production of Nano-Fibrillar Cellulose Gels,” to Gane et al.; U.S. Pat. No. 8,871,056, “Process for the Production of Nano-Fibrillar Cellulose Gels,” to Gane et al.; U.S. Patent Application Publication No. 2021/0262164 A1, entitled “Process for the Production of Nano-Fibrillar Cellulose Suspensions,” to Gane et al.; U.S. Pat. No. 10,982,387, “Process for the Production of Nano-Fibrillar Cellulose Suspensions,” to Gane et al.; U.S. Pat. No. 10,301,774, “Process for the Production of Nano-Fibrillar Cellulose Suspensions,” to Gane et al.; U.S. Pat. No. 8,871,057, “Process for the Production of Nano-Fibrillar Cellulose Suspensions,” to Gane et al.; all of which are incorporated herein by reference in their entireties.

### Methods of Making Adhesive Resin Compositions

In some embodiments, a method of preparing an adhesive resin composition of the present disclosure may include (i) providing nanocellulose in the form of a high-solid product, and (ii) mixing the high-solid product with thermosetting resin. Mixing of the high-solid product with the thermosetting resin may result in the nanocellulose being dispersed throughout the thermosetting resin.

In some embodiments, mixing of the high-solid product with the thermosetting resin may involve use of a high-speed mixing unit. Example high-speed mixing units include, but are not limited to, a radial flow impeller (e.g., a Cowles mixer), a rotor/stator mixer, a rotor-rotor apparatus, a hydrocyclone, and a homogenizer.

A radial flow impeller is capable of generating moderate-to-high shear mixing of suspended solids in a solvent, e.g., the thermosetting resin. Such a radial flow impeller is exemplified by a Cowles-blade, where tip speeds less than 20 m/s are utilized with an impeller (D) to tank (T) diameter less than 0.5, i.e., D/T<0.5.

A rotor-stator imparts higher shear rates than a radial flow impeller in the mixing of suspended solids in a solvent, e.g., the thermosetting resin. A rotor-stator apparatus is exemplified, for example, by a Trigonal® mixer (available from Wilhelm Siefer GmbH & Co. KG, Bahnhofstr. 114, DE-42551 Velbert). The rotor-stator mixer typically has tip speeds >20 m/s and an in-situ adjustable rotor-stator gap width of 0.1, 0.2, 0.3 mm and so on, depending on required shear-levels & physical limits of the design.

With respect to a Trigonal® machine, the source material undergoes a size reduction by a system of up to four coaxially arranged, rigid and movable rings. The rotor-stator system, of the Trigonal® mixer, is capable of reaching speeds up to 4,500 revolutions per minute. In material that is reduced in size in the Trigonal® mixer may also be mixed with another components using grooves, blades, and/or drills. The number of rings, their shapes, and their dimensions are customizable for different tasks, and the Trigonal® mixer can be fitted with a cooling or heating jacket to increase the temperature range during processing.

A hydrocyclone is an apparatus for separating or sorting particles in a liquid suspension based on the ratio of their centripetal force to fluid resistance. Generally a hydrocyclone comprises a base end and an apex end and a separation chamber having an elongated shape between the base end and the apex end. At least one inlet for feeding a cellulose-containing suspension to be cleaned is arranged at the base end, at least one underflow outlet is arranged at the apex end and at least one overflow outlet is arranged at the base end. An inlet flow, primarily fed tangentially into the separation chamber, is separated into an accept fraction and a reject fraction. The accept fraction is sent forward in the system for downstream processing. The reject fraction from the hydrocyclone underflow stage is returned to a rotor-stator mixer for further processing. A suspension is injected into the hydrocyclone in a manner that creates a vortex. Depending upon the relative densities of the phases, centrifugal acceleration causes the dispersed phase to move away from or towards the central core of the vortex. Hydrocyclone or cyclone devices are known for separating particles from liquid mixture by exploiting the centripetal force. By injecting the liquid mixture into a vessel and spinning therein, heavy or large particles move outward towards the wall of the vessel due to the centripetal force, and spirally move down to the bottom of the vessel. Light components move towards the center of the vessel and may be discharged via an outlet. This ratio is high for separation of coarse particles and low for separation of fine particles.

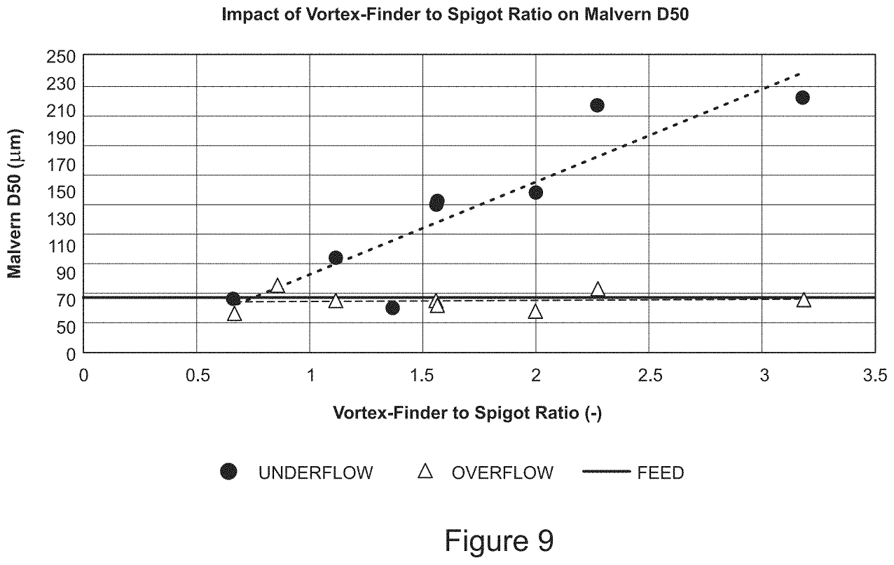

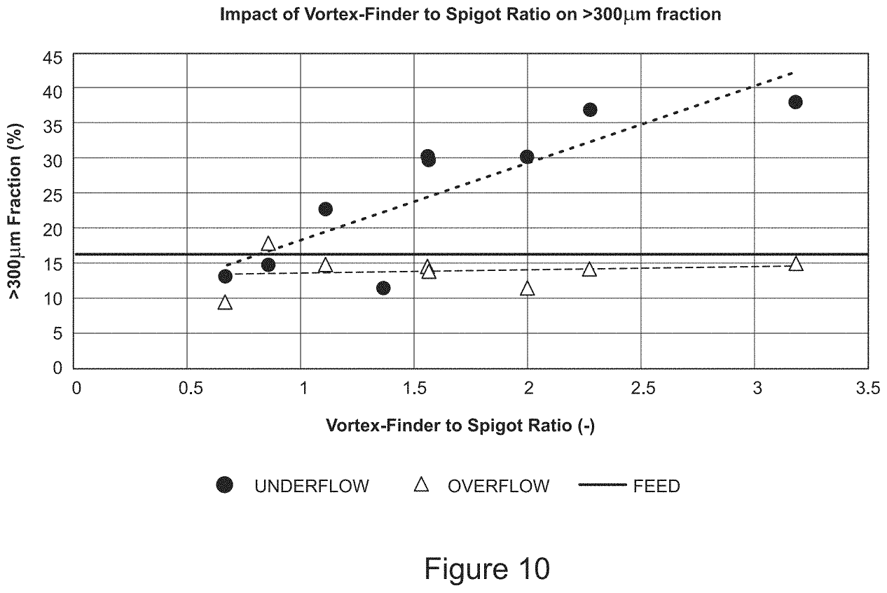

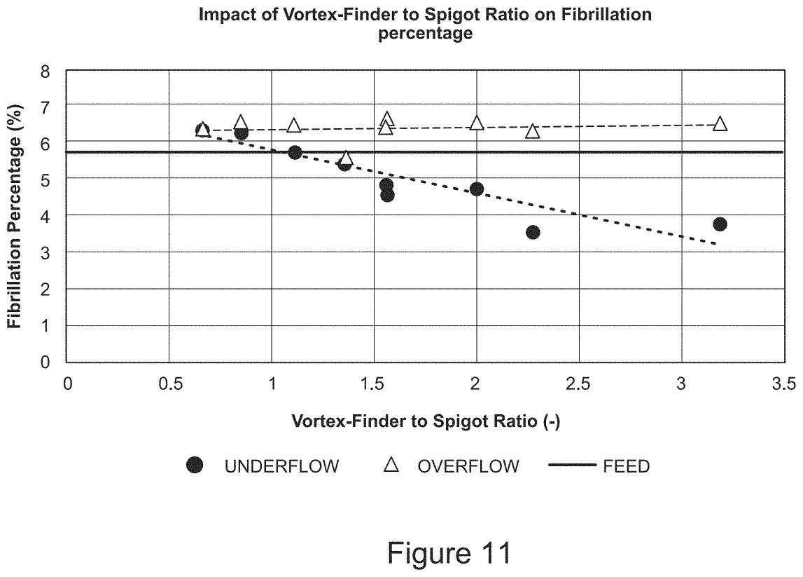

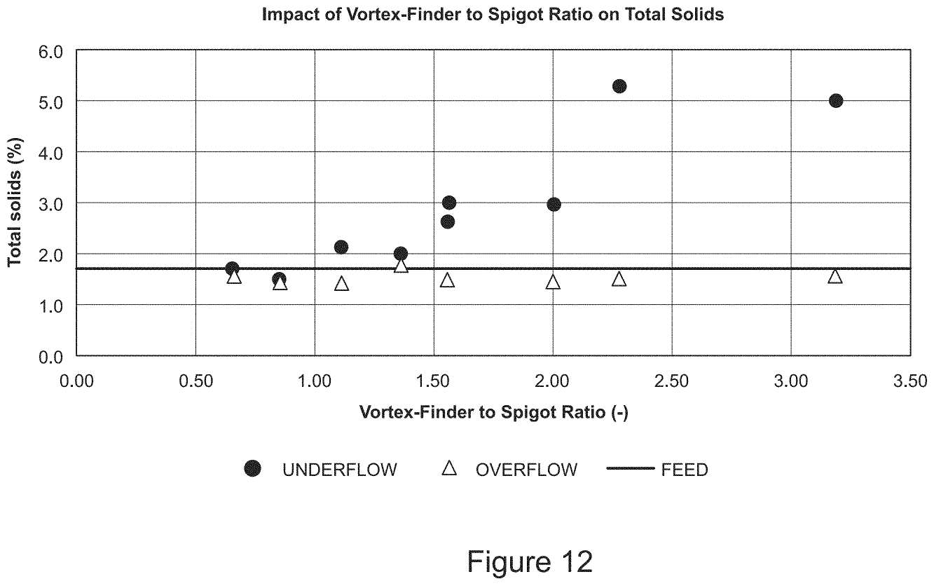

The impact of the vortex-finder to spigot ratio on Malvern D₅₀, the >300 μm fraction, the fibrillation percentage and total solids is presented in FIGS. 9, 10, 11, and 12, respectively. The fine stream and feed streams very closely resemble each other in terms of particle size distributions.

In this context, a “high-solid” product refers to a dewatered slurry resultant having nanocellulose present in an amount of at least about 15 wt % of the total weight of the resultant/high-solid product. In some embodiments, the nanocellulose may be present in an amount of at least about 15 wt %, at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 99 wt % of the total weight of the high-solid product.

In some embodiments, providing the nanocellulose in the form of the high-solid product includes (i) producing a slurry including nanocellulose present in an amount of up to about 10 wt % of the total weight of the slurry, and (ii) mechanically dewatering the slurry to produce the high-solid product having nanocellulose present in an amount of at least about 10 wt % of the total weight of the high-solid product.

In some embodiments, the nanocellulose may be present in an amount of at most about 10 wt %, at most about 9 wt %, at most about 8 wt %, at most about 7 wt %, at most about 6 wt %, at most about 5 wt %, at most about 4 wt %, at most about 3 wt %, at most about 2 wt %, or at most about 1 wt % of the total weight of the slurry. In some embodiments, the nanocellulose may be present in an amount of about 1 wt % to about 2 wt % of the total weight of the slurry.

In some embodiments, mechanically dewatering the slurry includes use of a centrifuge (i.e., a machine with a rapidly rotating container that applies centrifugal force to slurry contained therein). In some embodiments, mechanically dewatering the slurry includes use of a belt press. Any art-/industry-known belt press may be used.

A belt press includes three zones: a gravity zone; a wedge zone; and a high pressure/shear zone.

In the gravity zone, sludge or slurry is introduced to a filter. This often happens after a chemical flocculent or polymer has been introduced and mixed into the slurry to release water and form larger particles. The slurry is spread across the usable area of the filter and is contained from running off the filter sides. Often, plows or chicanes are located on the upper surface of the filter belt to move the sludge solids and promote drainage. On the lower side, the filter belt may be supported by a grid (e.g., of replaceable plastic material).

Some belt presses having inclined gravity zones, where the sludge feed box is lower than the discharge end of the gravity zone. This promotes dewatering by keeping the water laden sludge near the feed box and carrying the solids up to the discharge only after a majority of water has drained through the filter.

At the wedge zone, the upper and lower filter belts meet and envelope the slurry on two sides. The wedge zone applies pressure on solids in the slurry.

At the high pressure/shear zone, the filter belts are wrapped around (e.g., steel) rollers that progress from large diameter to smaller diameter and, as the diameter of the roll decreases, the pressure on the sludge increases.

Example belt presses and their components are described in U.S. Pat. No. 6,543,623 B2, issued Apr. 8, 2003 and titled “Belt Filter Press With Winged Primary Roller,” and U.S. Pat. No. 6,561,361 B2, issued May 13, 2003 and titled “Belt Filter Press With Improved Wedge Section,” the contents of which are hereby incorporated by reference in their entireties.

In some embodiments, the method of preparing an adhesive resin composition of the present disclosure includes mixing the high-solid product with the thermosetting resin to product an adhesive resin composition having nanocellulose present in an amount of at least about 40 wt % of the total solid content of the adhesive resin composition. In some embodiments, the method of preparing an adhesive resin composition of the present disclosure includes mixing the high-solid product with the thermosetting resin to produce an adhesive resin composition having nanocellulose present in an amount of at most about 50 wt % of the total solid content of the adhesive resin composition. For example, nanocellulose may be present in an amount of about 0.01 wt % to about 5 wt %, 0.01 wt % to about 10 wt %, 0.01 wt % to about 15 wt %, 0.01 wt % to about 20 wt %, 0.01 wt % to about 25 wt %, 0.01 wt % to about 30 wt %, 0.01 wt % to about 35 wt %, 0.01 wt % to about 40 wt %, about 0.01 wt % to about 45 wt %, or about 0.01 wt % to about 50 wt % of the total solid content of the adhesive resin composition.

An adhesive resin composition of the present disclosure may have an enhanced shear strength compared to the resin without nanocellulose mixed therewith. For example, the shear strength of the resin may be increased by about 1%, about 2%, about 3%, about 4%, about 5%, about 6%, about 7%, about 8%, about 9%, or about 10% when nanocellulose is mixed therewith.

In certain embodiments, the essentially completely-dried or partially-dried nanocellulose is prepared in accordance with the procedures of U.S. Pat. No. 11,001,644, issued May 11, 2021 and titled “Re-Dispersed Microfibrillated Cellulose,” which is incorporated by reference herein in its entirety.

Table 1 below illustrates example adhesive resin compositions of the present disclosure. In Table 1, “resin solid” refers to the initial solid content of the resin liquid, “nanocellulose solid” refers to the nanocellulose consistency in the slurry mentioned above, “nanocellulose dose in resin” refers to the addition rate of nanocellulose in the resin, and “total resin solid” refers to the final solid content of the adhesive resin composition.

TABLE 1
Example adhesive resin compositions.

| | Nanocellulose | Nanocellulose | |
|---|---|---|---|
| Resin Solid | Solid | Dose in Resin | Total Resin Solid |
| 50% | 0% | 2% | 50.0% |
| 50% | 1% | 2% | 25.3% |
| 50% | 4% | 2% | 40.7% |
| 50% | 10% | 2% | 46.3% |
| 50% | 20% | 2% | 48.5% |

### Preparation of Nanocellulose Belt Press Cake.

A belt-press cake, an example of a high-solid product, may comprise nanocellulose and inorganic particulate material at 50% percentage of pulp (POP), prepared by grinding a substrate comprising cellulose with an inorganic particulate material at 2.5% total solids. The grinder product is passed through two pressure screens in series with 250 μm then 120 μm slot sizes.

The grinder product may optionally be passed through a BVG high shear mixer at 80 kWh/t energy input.

2000 ppm Percol 3035 flocculant is added and mixed with MFC/mineral slurry with a static inline mixer.

The product is fed onto a belt filter press at ambient temperature running at 2 m/min with a pressing pressure of 35 bar.

Ploughs are fitted to the gravity dewatering section of the belt filter press to assist gravity dewatering before the pressure section.

Press cake comes off the belt filter press at 40% total solids and falls into a screw feeder which transports the material into a Winkworth, plough share type mixer. In these trials the Winkworth mixer has a Weir inside which is at 3% (0% is highest) which helps to increase residence time in the mixer The mixer breaks the large pieces of press cake up into small granules. The mixer is run at 40% speed.

Inside the Winkworth mixer, biocide may optionally be added at two addition points. At the first addition point about 250 ppm DBNPA (based on total weight of cake) is added to the product and distributed within the cake by the action of the Winkworth mixer. At the second addition point inside the Winkworth mixer, about 200 ppm of CMIT/MIT (3:1 ratio) is added and mixed into the cake carrier water is added to the CMIT/MIT biocide before it is added to the product to help distribute the biocide evenly in the cake product. Product exits the Winkworth mixer and is screw fed into a bagging unit where FIBC bags are filled with 1000 kg of cake product. A vibrating table is used to help with packing.

### Re-Dispersion of Partially-Dried Nanocellulose

The disclosure provides a system and process that enables re-dispersion of partially-dried, filtration cake compositions through energy efficient and economical process steps and equipment. The present disclosure provides for dewatering a liquid composition (preferably, an aqueous composition) and eliminating a drying step, wherein the partially-dried filtration cake composition (for example, a belt press cake or a plate and frame press cake, or a tube press caked composition) in partially-dried form is re-dispersed in a thermosetting resin(s) in a minimum number of process steps and utilizing a minimum number of apparatus, to yield a liquid composition of nanocellulose, and optionally one or more inorganic particulate material, and, optionally, one or more additive. Such compositions include liquid (e.g., thermosetting resin(s)) compositions of nanocellulose (i.e., essentially mineral-free nanocellulose) and nanocellulose, and one or more inorganic particulate material (i.e., mineral-containing nanocellulose).

Accordingly, the present disclosure seeks to address the problem of re-dispersing a dewatered, partially-dried filtration cake composition comprising nanocellulose and, optionally, comprising one or more inorganic particulate matter, and, optionally one or more additive composition, in a thermosetting resin(s), optionally in the presence of an additive other than inorganic particulate material (for example, one or more biocide or flocculant) and/or in the presence of a combination of inorganic particulate materials, while avoiding the well-known problems of agglomeration and/or hornification. The additive and/or combination of inorganic particulate materials may, for example, enhance a mechanical and/or physical property of the re-dispersed nanocellulose. The additive may also provide biocidal properties to the caked composition or filtration cake materials, while in transit and storage. The present disclosure further relates to MFC-containing adhesive compositions and their manufacture and use to produce construction products such as particle boards, fibreboards, plywood, and low-, medium-, and high density fibreboards.

The present disclosure also provides an economical method and corresponding portable manufacturing system for re-dispersing a nanocellulose and, optionally, one or more inorganic particulate material, and, optionally one or more additive, in a thermosetting resin(s), as described more completely herein. Such portable systems allow construction of a system for re-dispersing a partially-dried, filtration cake composition comprising nanocellulose and, optionally, one or more inorganic particulate material, and, optionally one or more additive at a location proximate to an end-use manufacturing site, for example, a particle boards, fibreboards, plywood, and low-, medium-, and high density fibreboards production site.

The present disclosure provides a transportable system for re-dispersing previously partially-dried and, optionally, comminuted or pulverized, compositions comprising nanocellulose, and optionally one or more inorganic particulate material, and optionally one or more additive, and associated methods for the re-dispersion of a previously partially-dried, filtration cake composition comprising nanocellulose and, optionally, one or more inorganic particulate material, and optionally, one or more additive, as described in detail in the present specification.

Transportable re-dispersion systems of the type described comprise either single or twin moderate-to-high-shear mixing apparatus comprising a shear-head impeller, for example a dispergator, disperser, overhead stirrer for high-speed, high-shear mixing or a Cowles-type mixer, or other generally vertically-oriented, shear-head impeller apparatus, although horizontally oriented embodiments are contemplated, as well. The single or twin moderate-to-high-shear mixing apparatus comprising a shear-head impeller may be used either singly in a single mixing tank, or two or more in succession when the transportable system incorporates a second mixing tank (or more), to partially de-agglomerate and form a flowable liquid slurry or suspension of nanocellulose and, optionally, one or more inorganic particulate material, and, optionally one or more additive, before performing a high-shear mixing operation to further process the flowable slurry or suspension into a substantially homogeneous suspension. The flowable suspension or slurry comprising nanocellulose and, optionally, one or more inorganic particulate material, and, optionally, one or more additive, is sequentially subjected to high-shear mixing by one or more rotor-stator and/or rotor-rotor mixing apparatus, to form a substantially homogenous suspension. The high-shear mixing apparatus is preferably selected from a rotor-rotor apparatus, a rotor-stator apparatus, a colloid mill, an ultrafine grinding apparatus, or a refiner, wherein the rotor-rotor apparatus comprises counter-rotating rings, for subjecting the substantially homogenous suspension to additional high-shear processing.

As used herein, a “rotor-rotor mixer” produces high and focused shear with high viscosity slurries compared to conventional mixers. Rotor-rotor mixers have two counter-rotating mixing elements (rotors) which are capable of imparting high shear forces. Due to the geometry of the mixer, the liquid slurry is forced through a zone of high shear forces formed by the rotors. An exemplary commercially available rotor-rotor mixer is an Atrex® mixer supplied by Megatrex Oy, Lempäälä, Finland. Alternative apparatus include an ultra-fine friction grinder (Supermasscolloider® available from Masuko Sangyo Co. Ltd., Japan. An example of an Atrex® mixer is a rotor-rotor dispergator, model G30, diameter 500 mm, 6 rotor peripheries, rotation speed applied 1500 rpm (counter-rotating rotors). The preferred gap width is less than 10 mm and preferably less than 5 mm. So-called rotor-rotor dispergators operate in a manner where a series of frequently repeated impacts to the dispersion, i.e., substantially homogeneous suspension, are caused by blades of several rotors that rotate in opposite directions. An Atrex® dispergator is an example of such a dispergator. The adjacent rotors rotated in opposite directions at 1500 rpm. The present disclosure contemplates use of comparable rotor-rotor mixing apparatus to those named herein.

As used herein, a rotor-stator apparatus imparts higher shear rates than a radial flow impeller in the mixing of suspended solids in a solvent, e.g., thermosetting resin. A commercially available rotor-stator apparatus is exemplified, for example, by a Trigonal® mixer, and other comparable high-shear mixers, for instance a BVG ShearMaster rotor-stator mixing apparatus. The rotor-stator mixer typically has tip speeds >20 m/s and an in-situ adjustable rotor-stator gap width of 0.1, 0.2, 0.3 mm and so on, depending on required shear-levels and the physical limits of their design. Feed flows typically within the range 7 to 16 m³/hr but can handle flows of up to 35 m³/h if required, High Shear mixer is controlled off a variable speed drive (VSD) drive to vary the amount of energy input. The present disclosure contemplates use of comparable rotor-stator mixing apparatus to those named herein.

In some preferred embodiments, the transportable system is used in conjunction with a feed hopper, conveyor and screw feeder to load partially-dried, filtration cake compositions of nanocellulose, and optionally one or more inorganic particulate material, and optionally one or more additive, into a mixing tank having a dispergator, disperser, overhead stirrer for high-speed, high-shear mixing or Cowles type mixer or comparable mixing apparatus.

In some embodiments, the feed hopper may have a motor driven scraper for loosening particulate that may adhere to the interior wall of the feed hopper.

In some embodiments, there is a second mixing tank having a second dispergator, disperser, overhead stirrer for high-speed, high-shear mixing or Cowles type mixer or comparable apparatus for further de-agglomerating and mixing the flowable liquid slurry or suspension of nanocellulose, and optionally one or more inorganic particulate material, and optionally one or more additive.

In some embodiments, the first mixing tank and second mixing tank are connected with an overflow pipe. Once the level of flowable slurry inside the first mixing tank reaches overflow level, the flowable slurry is constantly transferred to second mixing tank during a continuous re-dispersing process. In some embodiments, the overflow pipe optionally may have one or more openings to allow inspection and cleaning of the overflow pipe.

In some embodiments, the first mixing tank and second mixing tank may have one or more openings to permit inspection and cleaning of the mixing tank.

The transportable system has a second stage, high-shear mixing apparatus connected to the first mixing tank if the system utilizes a single moderate-to-high-shear mixing apparatus comprising a shear-head impeller (for example a dispergator, disperser, overhead stirrer for high-speed, high-shear mixing or Cowles type mixer). Where the system has two mixing tanks each with a moderate-to-high-shear mixing apparatus comprising a shear-head impeller (for example a dispergator, disperser, overhead stirrer for high-speed, high-shear mixing or Cowles type mixer), the second mixing tank is connected to the second stage high-shear mixing apparatus, such as a rotor-stator and/or rotor-rotor mixing apparatus, that is used to apply high-shear to the flowable liquid slurry or suspension of nanocellulose and, optionally, one or more inorganic particulate material, and, optionally, one or more additive.

In some embodiments, the transportable make down system may utilize two or more second state rotor-stator and/or rotor-rotor high-shear mixing apparatus.

In some embodiments, when the transportable MDU is located adjacent to a particle board, fibreboard, plywood, low-, medium-, and/or high density fibreboard, or other construction product manufacturing facility, the MDU can utilize a pulper or similar mixing tank at the manufacturing facility in lieu of the first mixing tank and moderate-to-high-shear mixing apparatus comprising a shear-head impeller (for example a dispergator, disperser, overhead stirrer for high-speed, high-shear mixing or Cowles type mixer) and then circulate the flowable slurry from the pulper to one or more high-shear rotor-stator and/or rotor-rotor mixing apparatus.

In some embodiments where a first and second mixing tank each comprising a single moderate-to-high-shear mixing apparatus comprising a shear-head impeller (for example a dispergator, disperser, overhead stirrer for high-speed, high-shear mixing or Cowles type mixer), followed by a second stage, high-shear mixing apparatus, the substantially homogeneous composition of nanocellulose, and optionally one or more inorganic particulate material, and optionally one or more additive discharged therefrom is recirculated to a second inlet of the first mixing tank to enable a recirculation loop for further processing. The substantially homogenous suspension product may optionally be piped from the final delivery outlet, back to the first mixing tank so it recirculates through the entire transportable re-dispersion system for a calculated time period to achieve a specific or maximum quality level, as determined by viscosity properties.

In some embodiments, a third or fourth high-shear mixing apparatus may be added in series or parallel (for example, a BVG ShearMaster rotor-stator mixing apparatus may be followed by (or in parallel to) a second rotor-stator mixing apparatus (for example a BVG ShearMaster or a Trigonal® high-shear mixing apparatus or a deflaker or refiner) or be followed by a rotor-rotor mixing apparatus (for example, an Atrex® rotor-rotor mixing apparatus. Various combinations of rotor-rotor and/or rotor-stator mixing apparatus may be configured which would be understood by the skilled person based on the disclosures set forth in this specification.

In some embodiments the high-shear processed substantially homogenous suspension is collected in a suitable holding vessel for further end-use applications.

In some embodiments the high-shear processed substantially homogenous suspension is redirected to the first mixing tank in unitary systems or twin mixing tank systems to permit further high-shear processing.

In some embodiments, the second stage, third high shear mixing apparatus is selected from a rotor-rotor apparatus, a high-shear rotor-stator apparatus, a colloid mill, an ultrafine grinding apparatus, or a refiner, wherein the rotor-rotor apparatus comprises counter-rotating rings, for subjecting the flowable slurry to high-shear processing to produce a substantially homogenous suspension of nanocellulose and, optionally, one or more inorganic particulate material, and, optionally, one or more additive.

In some embodiments, the third high-shear mixing apparatus is connected to one or more filters, for example a first static filter and a second static filter which may be operated interchangeably to permit cleaning and removing deposited material, wherein the substantially homogenous suspension may then be transferred to a suitable holding vessel for further end-use applications or a second inlet of a first mixing tank or may be used directly in an end-use application.

In some embodiments, filters may be utilized after the first mixing apparatus or second (or third mixing apparatus if utilized) and the high-shear rotor-stator or rotor-rotor mixing apparatus, but could also be optionally utilized after the rotor-stator or rotor-rotor high-shear mixing apparatus, to increase throughput. The placement of filters in the system would be readily understood by the skilled person based on the disclosures in this specification and upon common general knowledge of the skilled person.

In some embodiments, a third or fourth high-shear mixing apparatus may be added in series (for example, a BVG ShearMaster rotor-stator mixing apparatus may be followed by a second rotor-stator mixing apparatus (for example a BVG ShearMaster or a Trigonal® high-shear mixing apparatus) or be followed by a rotor-rotor mixing apparatus (for example, an Atrex® rotor-rotor mixing apparatus. Various combinations of rotor-rotor and/or rotor-stator mixing apparatus may be configured, which would be understood by the skilled person.

In some embodiments, the substantially homogenous suspension of nanocellulose and, optionally, one or more inorganic particulate material, and, optionally, one or more additive can be pumped to an end-use manufacturing process.

### Further Definitions

The titles, headings and subheadings provided herein should not be interpreted as limiting the various aspects of the disclosure. Accordingly, the terms defined below are more fully defined by reference to the specification in its entirety. All references cited herein are incorporated by reference in their entirety.

Unless otherwise defined, scientific and technical terms used herein shall have the meanings that are commonly understood by those of ordinary skill in the art. Further, unless otherwise required by context, singular terms shall include pluralities and plural terms shall include the singular.

In this application, the use of “or” means “and/or” unless stated otherwise. In the context of a multiple dependent claim, the use of “or” refers back to more than one preceding independent or dependent claim in the alternative only.

It is further noted that, as used in this specification and the appended claims, the singular forms “a,” “an,” and “the,” and any singular use of any word, include plural referents unless expressly and unequivocally limited to one referent.

The instant invention is most clearly understood with reference to the following definitions.

The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%.

As used herein, the terms “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, unrecited elements or method steps. Additionally, a term that is used in conjunction with the term “comprising” is also understood to be able to be used in conjunction with the term “consisting of” or “consisting essentially of.”

The term “dry” weight is intended to mean the weight of the composition free of liquid, in particular free of water.

As used herein, the term “include” and its grammatical variants are intended to be non-limiting, such that recitation of items in a list is not to the exclusion of other like items that can be substituted or added to the listed items.

As used herein, the phrase “integer from X to Y” means any integer that includes the endpoints. For example, the phrase “integer from 1 to 5” means 1, 2, 3, 4, or 5.

The term “recycled cellulose-containing materials” means recycled pulp or a papermill broke and/or industrial waste, or paper streams rich in mineral fillers and cellulosic materials from a papermill.

By “deagglomerate,” “de-agglomerate,” ‘de-agglomeration, and the like, is meant a process of breaking up agglomerates.

By “essentially-dried” or “dry” is meant that the water content of an aqueous composition comprising nanocellulose, and, optionally, one or more inorganic particulate material is reduced by at least about 95% by weight water.

By “partially-dried” or “partially-dry” is meant that the water content of the aqueous composition comprising nanocellulose is reduced by an amount less than 95% by weight. In certain embodiments, “partially-dried” or “partially-dry” means that the water content of the aqueous composition comprising nanocellulose is reduced by at least 50% by weight, for example, by at least 75% by weight, or by at least 90% by weight. In an embodiment, the aqueous suspension is treated to remove at least a portion or substantially all of the water to form a partially-dried or essentially-dried product. For example, at least about 10% by volume of water in the aqueous suspension may be removed from the aqueous suspension, for example, at least about 20% by volume, or at least about 30% by volume, or least about 40% by volume, or at least about 50% by volume, or at least about 60% by volume, or at least about 70% by volume or at least about 80% by volume or at least about 90% by volume, or at least 95% by volume, or at least about 100% by volume of water in the aqueous suspension may be removed. Any suitable technique can be used to remove water from the aqueous suspension including, for example, by gravity or vacuum-assisted drainage, with or without pressing, or by evaporation, or by filtration, or by a combination of these techniques. The partially-dried or essentially-dried composition will comprise nanocellulose and, optionally one or more inorganic particulate material and any other optional additives that may have been added to the aqueous suspension prior to drying. The partially-dried or essentially-dried product may be stored or packaged for sale. The partially-dried or essentially-dried product may be optionally re-hydrated and incorporated in papermaking compositions and other paper products, as described herein.

In certain embodiments, the total solids range of the filtration cake is about 8% to about 60% total solids.

In some embodiments, the fibre content of the thermosetting resin and filtration cake comprising nanocellulose and, optionally, one or more inorganic particulate material, and, optionally, one or more additive is about 0.5 wt. % to about 20 wt. %, preferably, about 0.5 wt. % to about 4 wt. % or more preferably about 1 wt. % to 2 wt. %.

In an embodiment, the aqueous suspension is treated to remove at least a portion or substantially all of the water to form a partially-dried. For example, at least about 10% by volume of water in the aqueous suspension may be removed from the aqueous suspension, for example, at least about 20% by volume, or at least about 30% by volume, or least about 40% by volume, or at least about 50% by volume, or at least about 60% by volume, or at least about 70% by volume or at least about 80% by volume or at least about 90% by volume, or at least 95% by volume water from the aqueous suspension including, for example, by gravity or vacuum-assisted drainage, with or without pressing, or by evaporation, or by filtration, or by a combination of these techniques. The partially-dried or essentially-dried composition will comprise nanocellulose and, optionally one or more inorganic particulate material and one or more optional additive that may have been added to the aqueous suspension prior to drying. The partially-dried product may be stored or packaged for sale. The partially-dried or essentially-dried product may be optionally re-hydrated and incorporated in particle board, fibreboard, plywood, low-, medium-, and/or high density fibreboard, or other construction products, as described herein.

Various methods are known to the skilled person for preparing partially-dried or essentially-dried compositions comprising nanocellulose and, optionally, one or more inorganic particulate material. For example, methods disclosed in the prior art and which are incorporated herein by reference in their entirety are disclosed in U.S. Pat. Nos. 10,435,482 and 11,001,644.

The process of U.S. Pat. No. 10,435,482, is described as a method of improving the physical and/or mechanical properties of re-dispersed dried or partially-dried microfibrillated cellulose, the method comprising: (a) providing an aqueous composition of microfibrillated cellulose; (b) dewatering the aqueous composition by one or more of: i. dewatering by belt press, ii. a high pressure automated belt press, iii. centrifuge, iv. tube press, v. screw press, and vi. rotary press; to produce a dewatered microfibrillated cellulose composition; (c) drying the dewatered microfibrillated cellulose composition by one or more of: i. a fluidized bed dryer, ii. microwave and/or radio frequency dryer, iii. a hot air swept mill or dryer, a cell mill or a multirotor cell mill, and iv. freeze drying; to produce a dried or partially-dried microfibrillated cellulose composition; and (d) re-dispersing the dried or at least partially dried microfibrillated cellulose in a liquid medium; wherein the microfibrillated cellulose has a viscosity which is at least 50% of the viscosity of the aqueous composition of microfibrillated cellulose prior to drying at a comparable concentration and a fibre steepness of from 20 to 50.

The process of U.S. Pat. No. 11,001,644 is described as a method of improving the physical and/or mechanical properties of redispersed dried or partially dried microfibrillated cellulose, the method comprising: (a) providing an aqueous composition of microfibrillated cellulose, wherein the microfibrillated cellulose is obtained from a recycled pulp, or a papermill broke, or a papermill waste stream, or waste from a papermill; (b) dewatering the aqueous composition by one or more of: dewatering by belt press, a high pressure automated belt press, iii. centrifuge, tube press, screw press, and rotary press to produce a dewatered microfibrillated cellulose composition; (c) drying the dewatered microfibrillated cellulose composition by one or more of: i. a fluidized bed dryer, ii. microwave and/or radio frequency dryer, a hot air swept mill or dryer, a cell mill or a multirotor cell mill, and freeze drying to produce a dried or partially dried microfibrillated cellulose composition; and (d) re-dispersing the dried or at least partially dried microfibrillated cellulose in a liquid medium; wherein the microfibrillated cellulose has a viscosity which is at least 50% of the viscosity of the aqueous composition of microfibrillated cellulose prior to drying at a comparable concentration and a fibre steepness of from 20 to 50. Alternative processes for re-dispersing partially-dried or essentially-dried microfibrillated cellulose are disclosed in U.S. Patent Publication No. 20200263358A1, which method is incorporated herein by reference in its entirety.

In U.S. Patent Publication No. 20200263358 there is provided a method for re-dispersing dewatered, partially dried or essentially dried microfibrillated cellulose, the method comprising the steps of: (a) adding a quantity of a suitable dispersing liquid to a tank having at least a first and a second inlet and an outlet, wherein the tank further comprises a mixer and a pump attached to the outlet; (b) adding a quantity of dewatered, partially dried or essentially dried microfibrillated cellulose to the tank through the first inlet in sufficient quantity to yield a liquid composition of microfibrillated cellulose at a desired solids concentration of 0.5 to 5% fibre solids; (c) mixing the dispersing liquid and the dewatered, partially dried or essentially dried microfibrillated cellulose in the tank with the mixer to partially de-agglomerate and re-disperse the microfibrillated cellulose to form a flowable slurry; (d) pumping the flowable slurry with the pump to an inlet of a flow cell, wherein the flow cell comprises a recirculation loop and one or more sonication probe in series and at least a first and a second outlet, wherein the second outlet of the flow cell is connected to the second inlet of the tank, thereby providing for a continuous recirculation loop providing for the continuous application of ultrasonic energy to the slurry for a desired time period and/or total energy, wherein the flow cell comprises an adjustable valve at the second outlet to create back pressure of the recirculated slurry, further wherein the liquid composition comprising microfibrillated cellulose of step (c) is continuously recirculated through the recirculation loop at an operating pressure of 0 to 4 bar and at a temperature of 20° C. to 50° C.; (e) applying an ultrasonic energy input to the slurry of 200 to 10,000 kWh/t continuously by the sonication probe at a frequency range of 19 to 100 kHz and at an amplitude of up to 60%, up to 100% or up to 200% to the physical limitations of the sonicator used for 1 to 120 minutes; (0 collecting the re-dispersed suspension comprising microfibrillated cellulose with enhanced viscosity properties from the first outlet of the flow cell in a suitable holding vessel.

The terms “re-dispersion,” “re-dispersing,” and “re-dispersed” refer to the suspension of dried and, optionally, pulverized, nanocellulose and, optionally, one or more inorganic particulate material in thermosetting resin(s).

As used herein, the term “pulverize,” “pulverized,” and “pulverization” mean the mechanical disintegration of nanocellulose press-cake into a powder.

As used herein, a mixer with a shear head impeller imparts “moderate shear” to the essentially-dried or partially-dried, and optionally, pulverized, composition comprising nanocellulose, and optionally one or more inorganic particulate material composition. An example of a moderate shear mixer useful in the present invention is a Cowles-blade (radial-flow impeller) inside a holding vessel, where, for example, tip speeds less than 20 m/s are encountered with an impeller (D) to tank (T) diameter less than 0.5, i.e., D/T<0.5. Other exemplary mixers include various propeller mixers, dual shaft and triple shaft mixers, (e.g., Ross mixers), dispersers having blade mixers, Silverson® mixers, Myers mixers, PVC mixers, and other similar generic mixers as known by the skilled person.

As used herein a rotor-stator mixer, for example, a Trigonal® mixer (Siefer-Trigonal machine), or more generally a colloid mill, or a refiner, which impart relatively higher shear-rates, depending on required shear-levels and physical limits of the design compared to a shear head mixer imparting moderate shear. Another apparatus includes a Cavitron® rotor-stator mixer supplied by Hagen & Funke GmbH. Sprockhövel, Germany. Feed flows typically within the range 7 to 16 m³/hr but can handle flows of up to 35 m³/h if required, High Shear mixer is controlled off a VSD drive to vary the amount of energy input.

As used herein, a “rotor-rotor mixer” produces high and focused shear with high viscosity slurries compared to conventional mixers. Rotor-rotor mixers have two counter-rotating mixing elements (rotors) which are capable of imparting high shear forces. Due to the geometry of the mixer, the liquid slurry is forced through a zone of high shear forces formed by the rotors. An exemplary rotor-rotor mixer is an Atrex® mixer supplied by Megatrex Oy, Lempäälä, Finland. Alternative apparatus include an ultra-fine friction grinder (Supermasscolloider® available from Masuko Sangyo Co. Ltd., Japan. An example of an Atrex® mixer is a rotor-rotor dispergator, model G30, diameter 500 mm, 6 rotor peripheries, rotation speed applied 1500 rpm (counter-rotating rotors). The preferred gap width is less than 10 mm and preferably less than 5 mm. So-called rotor-rotor dispergators, where a series of frequently repeated impacts to the dispersion are caused by blades of several rotors that rotate in opposite directions. Atrex® dispergator is an example of such a dispergator. The adjacent rotors rotated in opposite directions at 1500 rpm.

As used herein, an “under-sheared coarse particle stream” comprises particle sizes at least 20% greater than the overflow/fine stream d₅₀(μm).

A fibrous substrate comprising cellulose (variously referred to herein as “fibrous substrate comprising cellulose,” “cellulose fibres,” “fibrous cellulose feedstock,” “cellulose feedstock” and “cellulose-containing fibres,” etc.) may be derived from virgin or recycled pulp.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. In the context of “substantially homogenous suspension” the suspension is understood to have minimal aggregates.

As used herein, “viscosity” is measured in accordance with the procedures of Example 5.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the “equivalent spherical diameter” (e.s.d), less than given e.s.d values. The mean particle size d₅₀ is the value determined in this way of the particle e.s.d at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Mastersizer S machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the “equivalent spherical diameter” (e.s.d), less than given e.s.d values. The mean particle size d₅₀ is the value determined in this way of the particle e.s.d at which there are 50% by volume of the particles which have an equivalent spherical diameter less than that d₅₀ value.

As used herein, “percentage of pulp” and “POP” refer to the pulp consistency as a weight percentage of dry substances in a composition.

As used herein, the phrase “integer from X to Y” means any integer that includes the endpoints. For example, the phrase “integer from 1 to 5” means 1, 2, 3, 4, or 5.

For the avoidance of doubt, insofar as is practicable any embodiment of a given aspect of the present invention may occur in combination with any other embodiment of the same aspect of the present invention. In addition, insofar as is practicable it is to be understood that any preferred or optional embodiment of any aspect of the present invention should also be considered as a preferred or optional embodiment of any other aspect of the present invention.

The foregoing embodiments and advantages are merely exemplary and are not to be construed as limiting the present invention. Also, the description of the embodiments of the present invention is intended to be illustrative and not to limit the scope of the claims. Many alternatives, modifications, and variations will be apparent to those skilled in the art.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The various embodiments described in this specification can be combined to provide further embodiments. Aspects of the embodiments can be modified, if necessary to employ concepts of the various patents, applications and publications to provide yet further embodiments.

The disclosures of each and every patent, patent application, publication, and accession number cited herein are hereby incorporated herein by reference in their entirety.

While the present disclosure has been disclosed with reference to various embodiments, it is apparent that other embodiments and variations of these may be devised by others skilled in the art without departing from the true spirit and scope of the disclosure. The appended claims are intended to be construed to include all such embodiments and equivalent variations. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The foregoing written specification is considered to be sufficient to enable one skilled in the art to practice the embodiments. The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

### Examples

### Example 1. Affect of Mixing High-Solid Product in Resin Instead of MFC Slurry

Table 2 below shows that, by dispersing high-solid product (as defined herein above) in urea formaldehyde resin instead of mixing MFC slurry with resin, the total resin solid content can be significantly increased from 39 wt % to 60 wt % of the total weight of the adhesive resin composition.

TABLE 2
Adhesive resin compositions based on
varying input type of nanocellulose.

| | | | | MFC Solid |
|---|---|---|---|---|
| | | | | Content Before |
| | | | | Mixed with |
| | MFC Dose | IC60 Dose | Total Resin | Urea |
| Sample | in Resin | in Resin | Solid | Formaldehyde |
| Description | wt % | wt % | wt % | wt % |
| Urea | 0 | 0 | 62 | — |
| formaldehyde | | | | |
| resin | | | | |
| MFC slurry | 1 | 1 | 39 | 1 |
| mixed with | | | | |
| urea | | | | |
| formaldehyde | | | | |
| MFC cake | 1 | 1 | 60 | 15.5 |
| dispersed in | | | | |
| urea | | | | |
| formaldehyde | | | | |

### Example 2. Rheology Features of Urea Formaldehyde Resin and Adhesive Resin Composition Including MFC

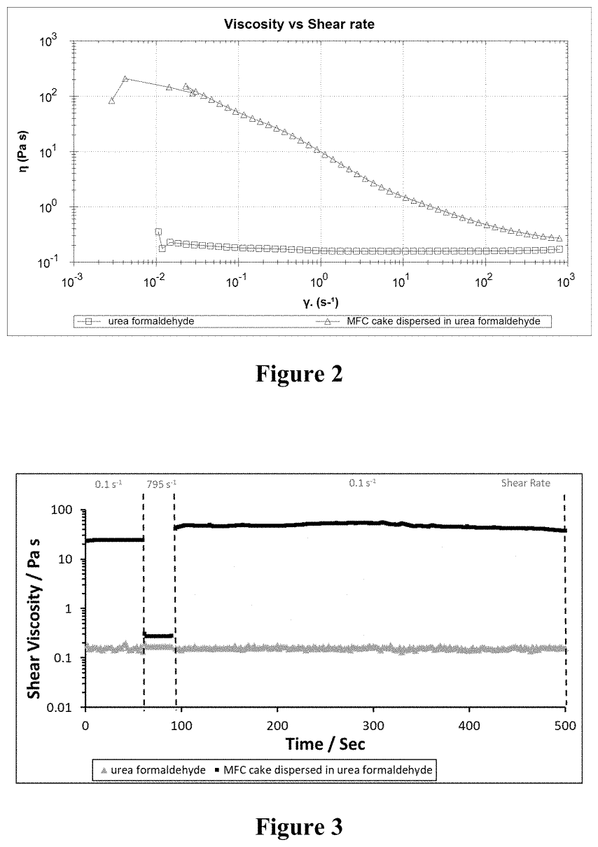

The rheology property of the resin in critical in the application of resin during a spraying process in a wood-based panel production process. A shear viscosity profile was conducted for resin mixtures to understand the fluid behaviour from low (0.01 s⁻¹) to high (1000 s⁻¹) shear rate. Observations of this testing are shown in Table 3 below and FIG. 2.

TABLE 3
rheology features of urea formadehyde resin and an adhesive resin
composition including MFC.

| | | | | MFC Solid | | |
|---|---|---|---|---|---|---|
| | MFC | IC60 | | Content | Shear | Shear |
| | Dose | Dose | Total | Before Mixed | Viscosity | Viscosity |
| | in | in | Resin | with Urea | at | at |
| Sample | Resin | Resin | Solid | Formaldehyde | 0.01 s⁻¹ | 790 s⁻¹ |
| Description | wt % | wt % | wt % | wt % | Pa · s | Pa · s |
| Urea | 0 | 0 | 62 | — | 0.191 | 0.145 |
| formaldehyde | | | | | | |
| resin | | | | | | |
| MFC cake | 1 | 1 | 60 | 15.5 | 145.2 | 0.270 |
| dispersed in | | | | | | |
| urea | | | | | | |
| formaldehyde | | | | | | |

The urea formaldehyde resin showed a Newtonian fluid behaviour, where the viscosity is independent of shear rate and viscosity increased linearly with the solid content. The MFC-urea formaldehyde adhesive resin composition demonstrated a characteristic shear-thinning profile. The higher viscosity of the MFC-urea formaldehyde adhesive resin composition than the urea formaldehyde resin at low shear rate may indicate better storage stability. The much-lowered viscosity of the MFC-urea formaldehyde adhesive resin composition at high shear rate, approaching the viscosity of the urea formaldehyde resin, suggests good sprayability of the MFC-urea formaldehyde adhesive resin composition, as the typical shear rate for spray application ranges from about 10⁶ to about 10⁸ s⁻¹.

Resin viscosity recovery behaviour was further investigated to understand how fast the samples recovered the viscosity following spraying (see FIG. 3). It was noted that the tested shear rate was much lower than the actual shear rate experienced in the spraying, due to the limitation of the cone and plate geometry. Notwithstanding, for the urea formaldehyde resin, the viscosity remained unchanged before and after the spraying; and the adhesive resin composition, including MFC and urea formaldehyde resin, responded to the change in shear rate almost instantaneously, typically less than 1 second. This suggests that the viscous adhesive resin composition, including MFC and urea formaldehyde resin, could be sprayed easily upon the application of shear force and recover its viscosity quickly once forming droplets.

### Example 3. Interfacial Adhesion Between Resin and Cellulose Substrate

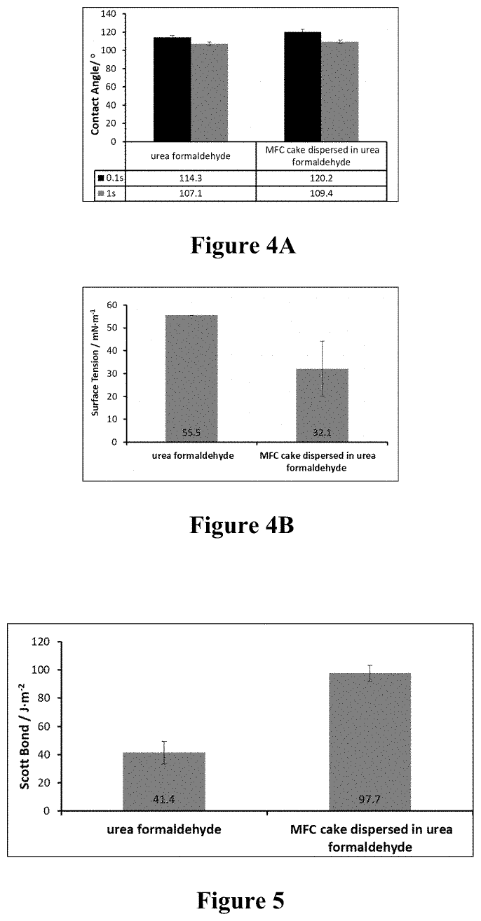

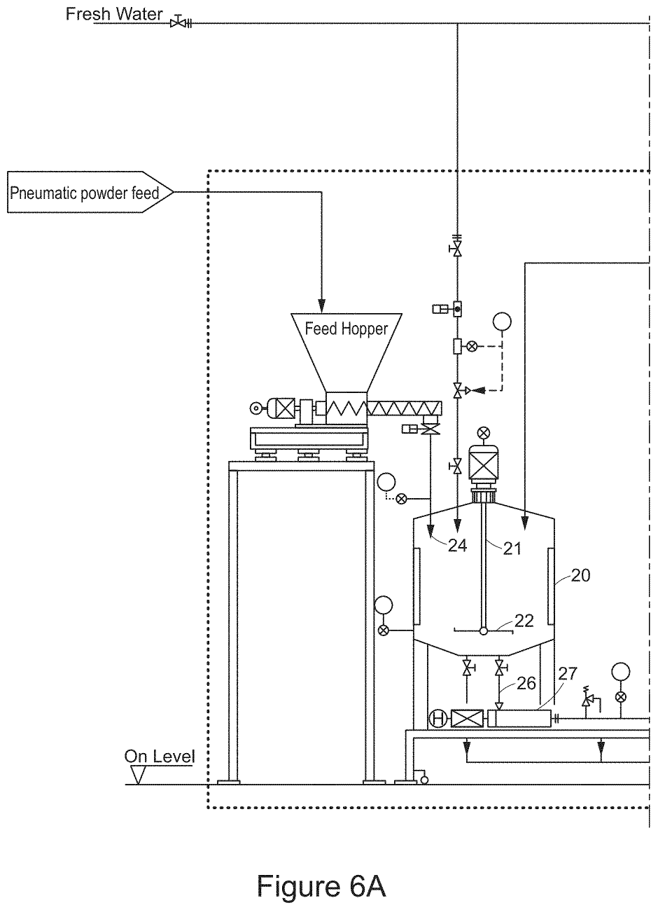

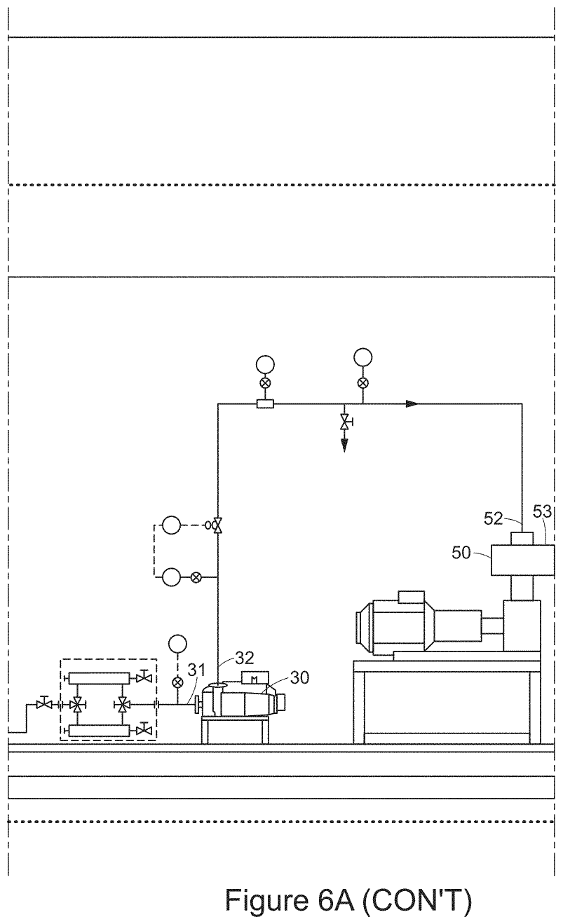

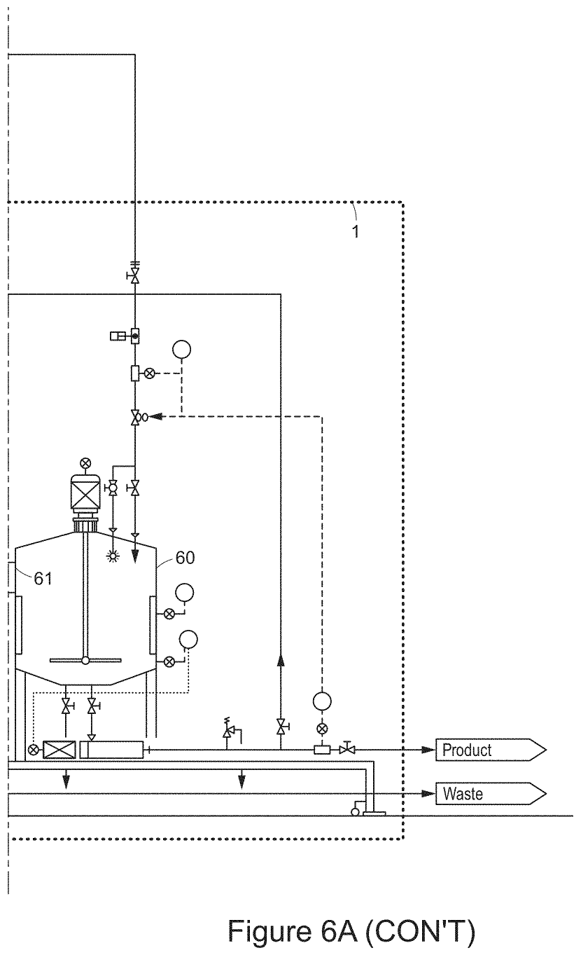

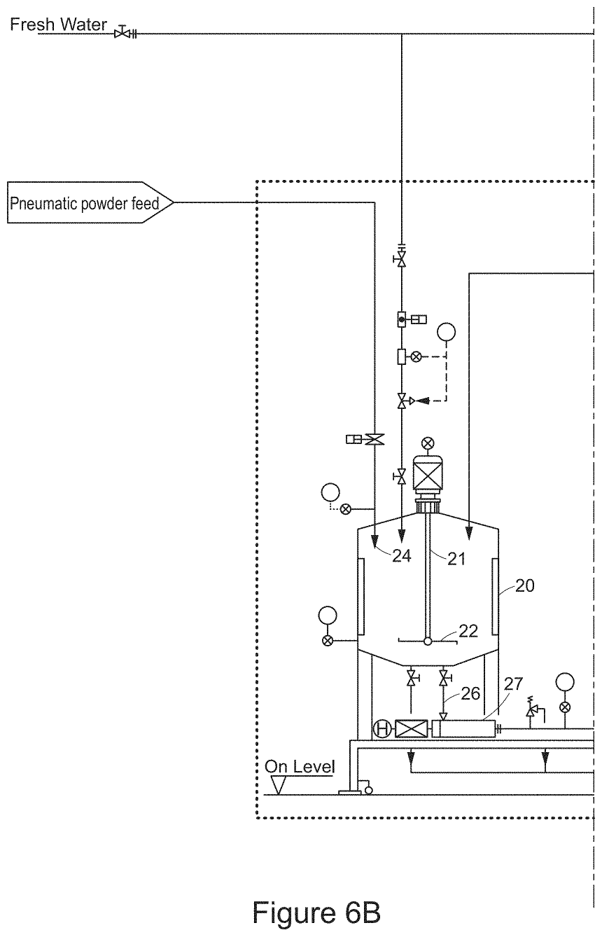

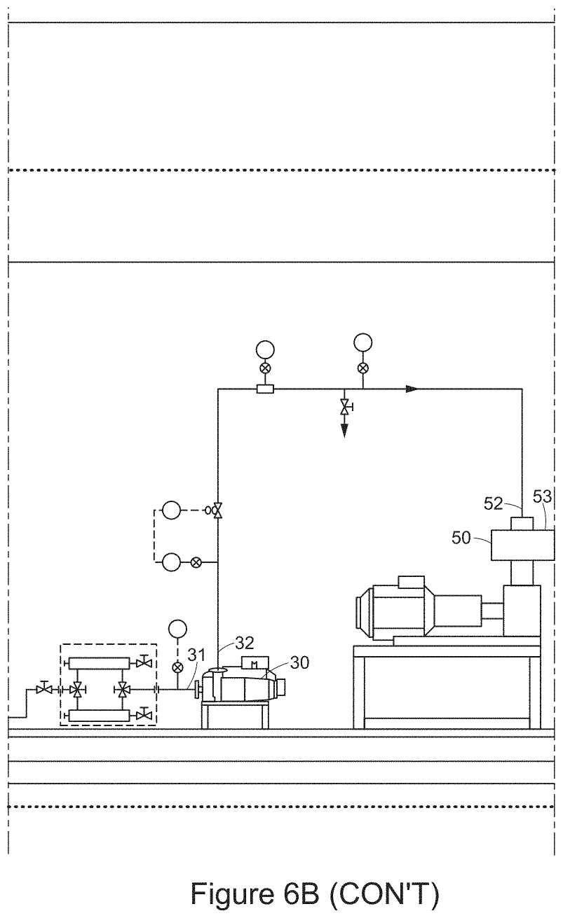

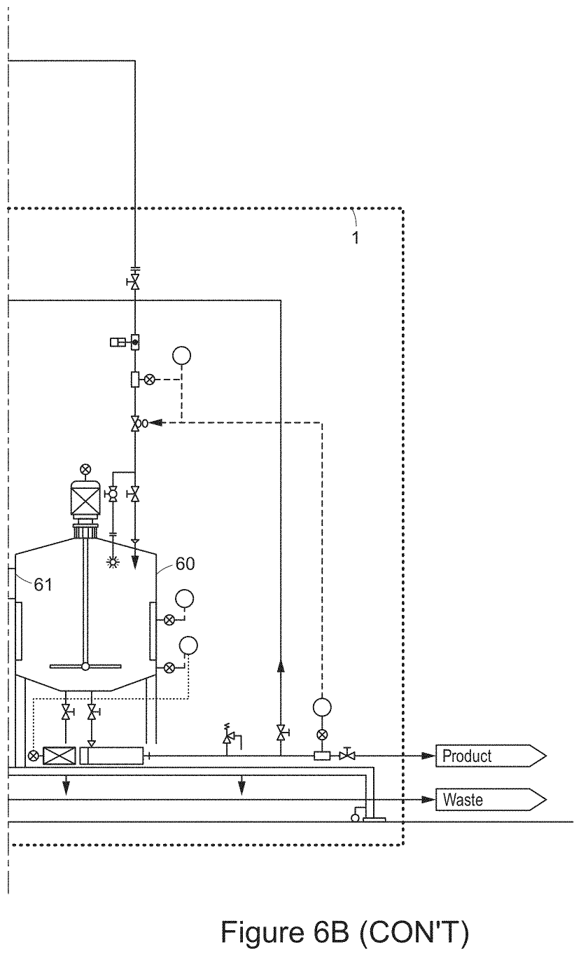

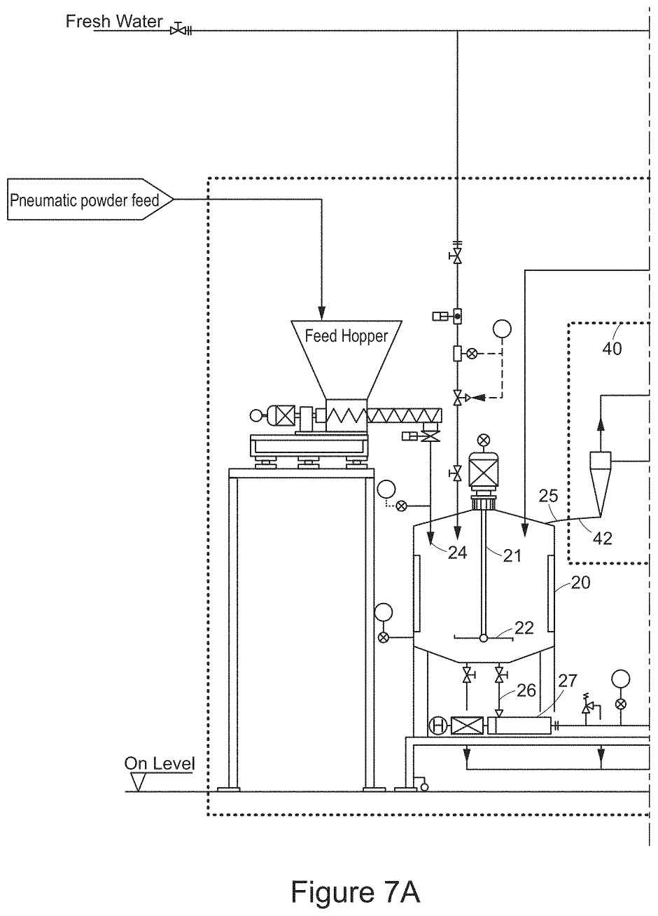

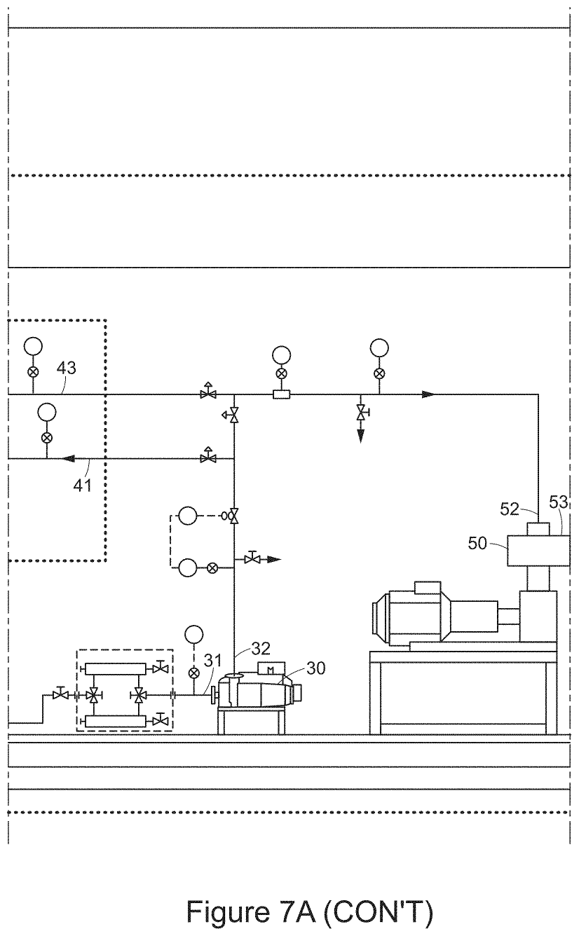

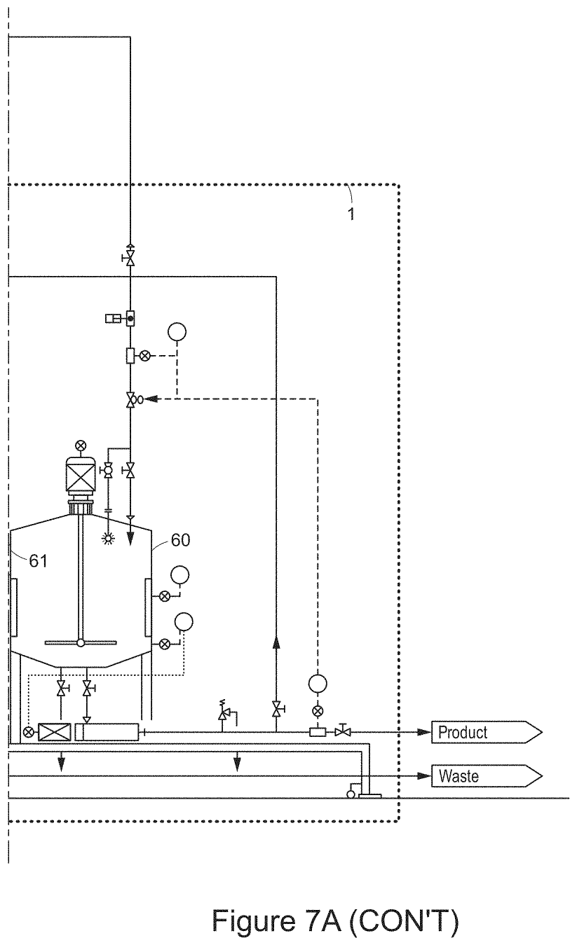

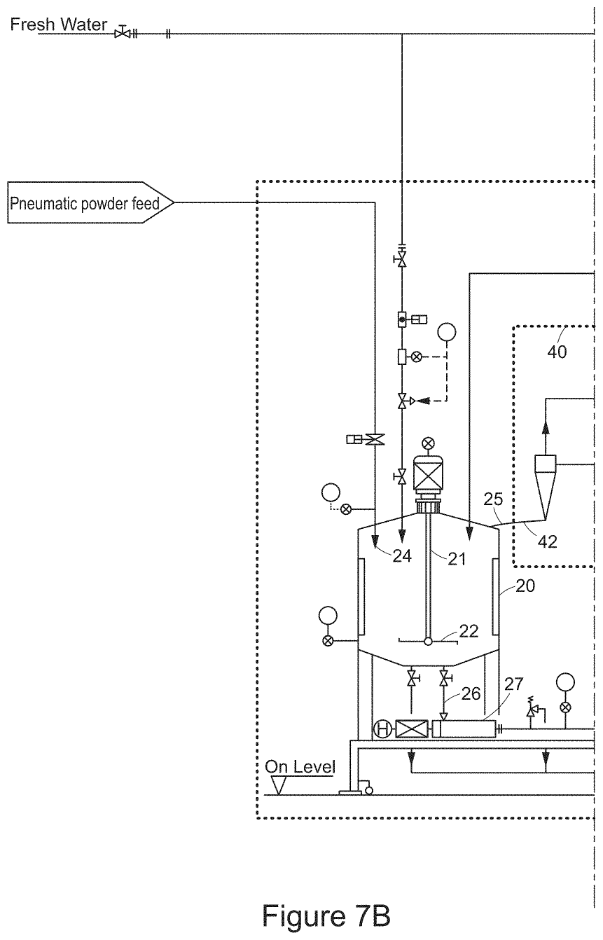

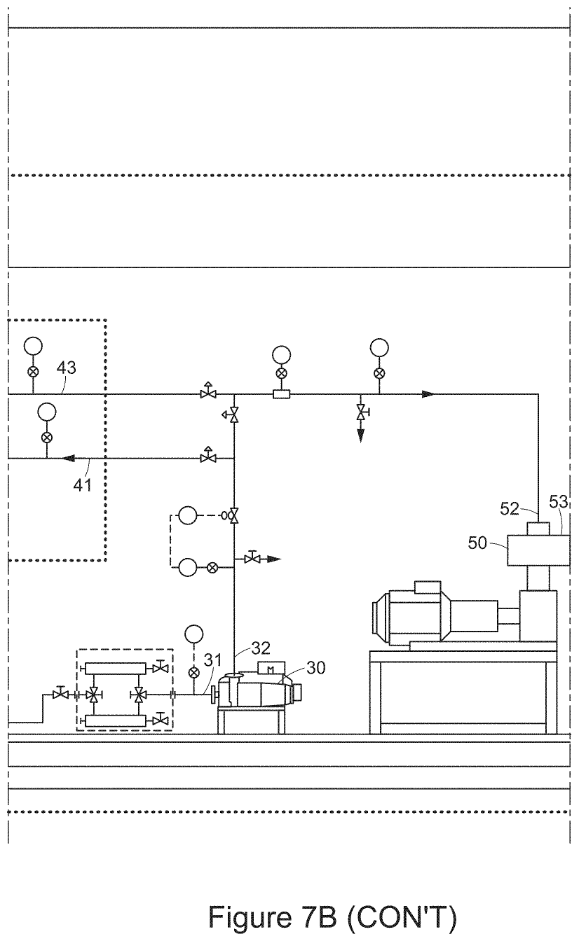

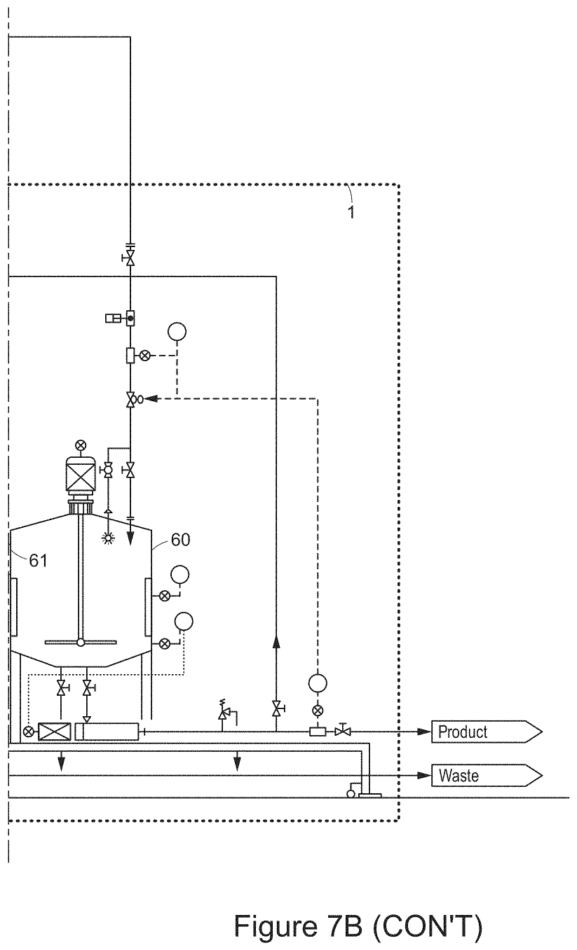

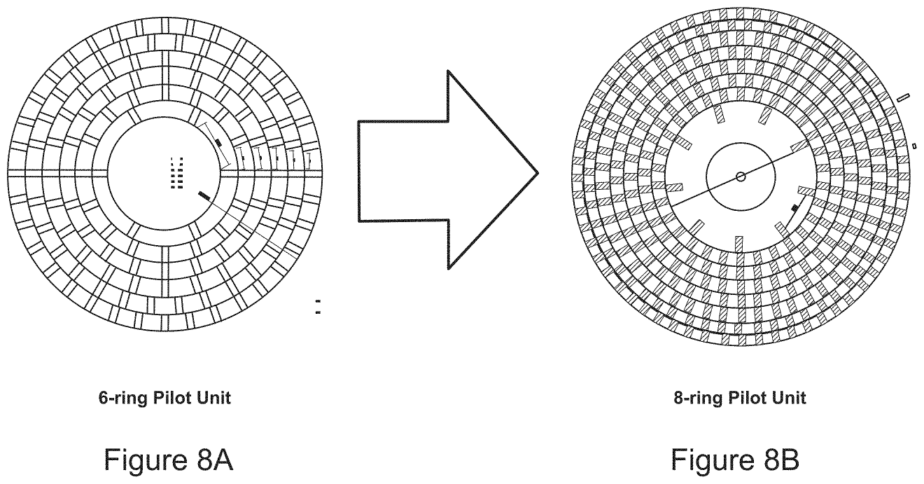

Testing was performed to measure interfacial adhesion between resin and cellulose substrate. FIG. 4a is a chart showing contact angle for urea formaldehyde resin and adhesive resin composition including MFC. FIG. 4b is a chart showing surface tension for urea formaldehyde resin and adhesive resin composition including MFC.

The contact angle at 1 s was similar for all the samples, while MFC seemed to increase the initial contact angle at 0.1 s. The lower liquid-air surface tension for the adhesive resin composition including MFC and urea formaldehyde resin, together with the similar contact angle, indicates that there is a strong interaction at the fibre-resin interface when MFC is added, according to the Young's equation:

γ_{sg}=γₛₗ+γ_{lg} cos θ, Equation 1

where γ_{sg} is solid-gas interfacial energy, γₛₗ is solid-liquid interfacial energy, θ is the contact angle in FIG. 4a, and γ_{lg} is liquid-gas interfacial energy (i.e., surface tension in FIG. 4b). In this study, γ_{sg} was constant and θ can be considered as identical for all samples at 1 second. Therefore, reduction in γ_{lg} suggested the γₛₗ increased in the presence of MFC.

### Example 4. Scott Bond of Sheets Reinforced with Urea Formaldehyde Resin and Adhesive Resin Composition Including MFC

Testing was performed to measure the Scott Bond of sheets reinforced with urea formaldehyde resin and adhesive resin composition including MFC. The results of this testing are shown in FIG. 5. The results showed that the addition of MFC in urea formaldehyde resin significantly increases the internal bond in composites.

### Example 5. Viscosity Measurements

A Brookfield viscosity test for nanocellulose and inorganic particulate material composite samples at 2.0% fibre solids can be performed using a Vane Spindle. Kaolin and calcium carbonate based nanocellulose and inorganic particulate material composite samples may be measured in the following manner.

Viscometer: Brookfield YR-1 or R.V. or similar instrument including Vane Spindles.

Ensure that the slurry is homogenous by shaking the container and contents vigorously. Use a palette knife to scoop and transfer at least 100 ml to a polystyrene pot. Stir well with spatula (or spindle). Set the speed of the viscometer to the required speed (10 rpm) and switch on. Allow the spindle to rotate for 30 seconds. Note and record the viscometer reading, speed, and Vane number.

### Example 6. Rheology of Resin-MFC Adhesives

A mineral/MFC composite filter cake was prepared at ˜15% fibre solids. The filter case was redispersed in urea formaldehyde (UF) (2 wt % MFC dose in dry resin, ˜60% total solids). 2 litres of UF were collected for analysis. Two trials were run:
Trial 1: 50 POP NBSK/GCC MFC in UF; 2% MFC dose in dry UF (˜4% FiberLean on dry basis); a total of 4 recirculation were run in the MDU; one litre of the mixture was collected after each recirculation.
Trial 2: 100 POP Euca MFC in UF; 2% MFC dose in dry UF; a total of 4 recirculation were run in the MDU; one litre of the mixture was collected after each recirculation.

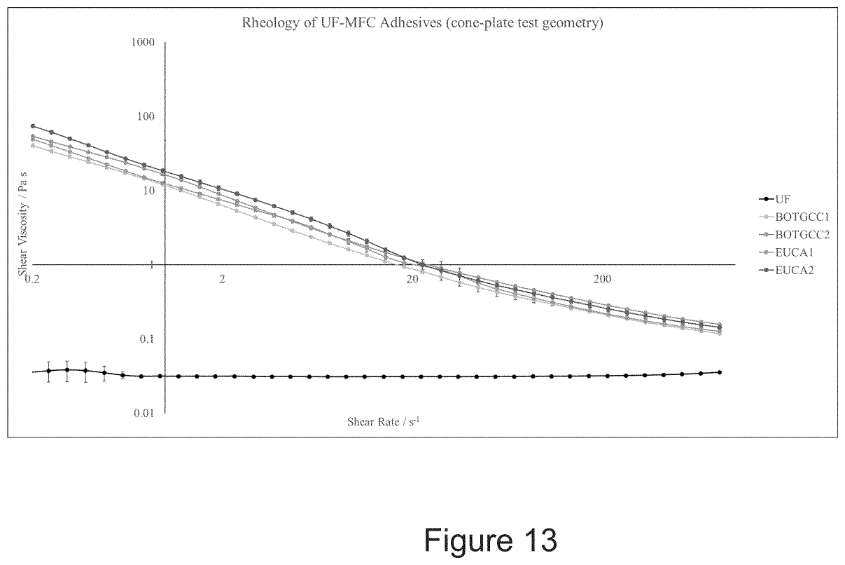

FIG. 13 and Tables 4-5 show the results of the trials.

FIG. 13 is a graph depicting the rheology of urea formaldehyde UF-MFC adhesives (cone-plate test geometry). As can be seen in FIG. 13, the mixtures of the two trials exhibited similar rheologies. It is also noted that the UF without the MFC exhibited significantly different rheology than the MFC-containing samples.

As shown in Tables 4, the viscosities of the MFC-containing samples were much higher than UF on its own, and the viscosity was higher in both cases after the second pass. It is also noted, with respect to Table 5, that there was an increase in shear strength for the Euca samples compared to UF. The Botnia samples contained GCC, which reduces the strength; but they almost matched the strength of the UF on its own despite this. The apparent drop in strength between BotGCC1 (first pass) and BotGCC2 (second pass) appears to be noise.

TABLE 4
Brookfield viscosity, solids, and temperature of mixtures from
Trials 1 and 2. The temperatures are the temperature of the
resin-MFC mixture before and after being re-dispersed.

| | Brookfield Viscosity @ 10 rpm | | |
|---|---|---|---|
| Sample | (s04) | Solids | Temperature |
| ID | cP | % | ° C. |
| UF | 20 | 52.54 | 8.3-12.6 |
| Euca1 | 3060 | 48.13 | 12.6-15.2 |
| Euca2 | 4840 | 48.40 | 14.6-16.2 |
| BotGCC1 | 3700 | 45.48 | 8.3-13.6 |
| BotGCC2 | 5400 | 48.67 | 11.6-15.5 |

TABLE 5
Shear strength and standard deviation
of mixtures from Trials 1 and 2.

| | | |
|---|---|---|
| Sample | Shear Strength | STDEV |

| | |
|---|---|
| ID | Mpa |

| | | |
|---|---|---|
| UF | 1.48 | 0.39 |
| Euca1 | 1.89 | 0.27 |
| Euca2 | 1.61 | 0.30 |
| BotGCC1 | 1.36 | 0.20 |
| BotGCC2 | 1.30 | 0.30 |

### Example 7. Resin Reinforced With Nanocellulose For Wood-Based Panel Products

Experimental Materials: Oak Constructional Wood Veneer with 1.5 mm thickness was obtained from The Wood Veneer Hub (UK). The urea formaldehyde (UF, product code: CMD1153) was supplied by Hexion (UK). The melamine urea formaldehyde (MUF) was supplied by Marinochem (Ireland). The phenol formaldehyde (PF) was supplied by Allnex (Netherlands). The FiberLean samples investigated in this study are listed in Table 6.

TABLE 6
Summary of FiberLean products.

| | | | FLT Index | |
|---|---|---|---|---|
| Sample ID | Solid (%) | POP (%) | (Nm/g) | Note |
| 50POP NBSK-GCC | 31.4 | 50.4 | 9.5 | MFC made |
| | | | | from Pine pulp |
| 50POP Acacia-GCC | 28.2 | 51.2 | 7.3 | MFC made |
| | | | | from Acacia |
| | | | | pulp |
| 100POP NBSK | 20 | 97.4 | 8.7 | MFC made |
| | | | | from Pine pulp |

Experimental Design: The UF resin was supplied at 62 wt % solid content. The belt-pressed FiberLean cakes were made down directly in the 62 wt % UF via 1 min Silverson make down procedure, followed by addition of distilled water to the target total solid content. The details of all the resin mixtures are listed in Table 7. The prepared resin samples were stored in the fridge at 4° C. before further analysis.

TABLE 7
Composition of resin solutions and FiberLean dose levels.

| | | Composition | | |
|---|---|---|---|---|
| | | MFC | GCC | UF |
| Resin Samples ID | FiberLean | wt % | wt % | wt % |
| UF | | 0 | 0 | 100 |
| 3% coBotMFC -UF | 50POP NBSK-GCC | 3 | 3 | 94 |
| 2% coBotMFC -UF | | 2 | 2 | 96 |
| 1% coBotMFC -UF | | 1 | 1 | 98 |
| 2% coAcaMFC -UF | 50POP Acacia-GCC | 2 | 2 | 96 |
| 1% coAcaMFC -UF | | 1 | 1 | 98 |
| 3% zirBotMFC-UF | 100POP NBSK | 3 | 0 | 97 |
| 2% zirBotMFC-UF | | 2 | 0 | 98 |
| 1% zirBotMFC-UF | | 1 | 0 | 99 |

Resin Laminated Wood Veneer Making Process: Wood veneers were cut into 100×20 mm strips. The prepared resin solution was coated onto one side of the wood veneer surface using a draw-down coating bar (No. 4 K Bar, 40 μm wet film thickness), targeting at 65 gsm dry mass theoretical coating weight. After preparing the resin coated wood veneers, two of the corresponding veneers were assembled into a 2-ply panel with 20×20 mm overlap of the resin coated sides. After 1 minute of the assembly, the panels were dried between Teflon papers for 5 minutes with a L&W Rapid Drier set to 180° C. A set of four repeats of the laminated wood was prepared for each resin composition. The prepared panels were conditioned at 25° C. 50% RH for 1 day before being tested for the shear strength.

Testing: Shear viscosity curves were recorded on Kinexus pro+rheometer (NETZSCH) at 25° C., using a cone (CP4/40 SR1877) and plate (PL61 ST S1555) measurement geometry. The shear rate for the sample measurement ramped up from 0.01 to 1000 s⁻¹, with 10 samples per decade. Shear tensile strength measurements were conducted on a Tinius Olsen H10KS Benchtop Tester, in compliance with ASTM D2339. The span was 100 mm and the test speed was 10 mm/min. The dried 2-ply panels were conditioned at 50% RH, 23° C. for 1 day before testing, unless specified. The testing results were averaged over the quadruplicate measurement. The experiment was conducted at 50% RH, 25° C. The maximum load at failure (Force) was recorded in Newton, and the shear tensile strength in MPa was calculated as dividing load at failure by the overlap area (20×20 mm) using Equation 2.

$$STS = \frac{Force}{overlap area} \% \qquad Equation 2$$

Results—Storage Stability of Resin in the Presence of MFC: The polymerisation of the UF resin was rapidly developed under pressure and elevated temperature to form bonds in the wood panels, which is indicated by the sudden increase in viscosity. At room temperature, the UF polymerisation can take place gradually, which is known as the aging process. The viscosity changes for UF and MFC-UF mixture in Table 8 suggest that both resins had very similar shelf life, about 20 days, at ambient conditions. The shelf life could be significantly increased if stored at low temperature.

TABLE 8
Summary of shear viscosity data of UF resin mixture over time.

| | Day 0 | Day 16 | Day 22 | Day 30 | Day 89 |
|---|---|---|---|---|---|
| Shear Rate | 795 s⁻¹ | 795 s⁻¹ | 795 s⁻¹ | 795 s⁻¹ | 795 s⁻¹ |
| Viscosity | Pas | Pas | Pas | Pas | Pas |
| Urea Formaldehyde (UF) | 0.170 | 0.223 | 0.253 | 0.384 | gelled |
| 1% coBotMFC -UF | 0.270 | 0.283 | 0.360 | 0.377 | gelled |
| UF stored at 4° C. | — | — | — | 0.198 | 0.224 |

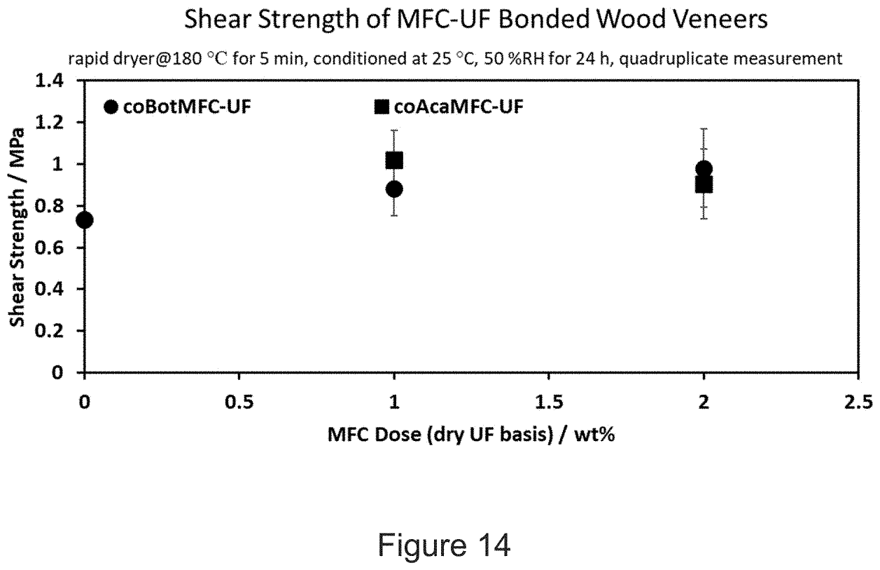

Results—Effect of MFC Types on Shear Strength of MFC-UF Bonded Wood Veneers: FIG. 14 is a graph showing the effect of MFC types on shear strength of MFC-UF bonded wood veneers. As can be seen in FIG. 14, the addition of MFC in UF resin improved the bonding strength in the wood veneers. The pulp source of MFC had little impact on shear strength (coBotMFC-UF vs. coAcaMFC-UF).

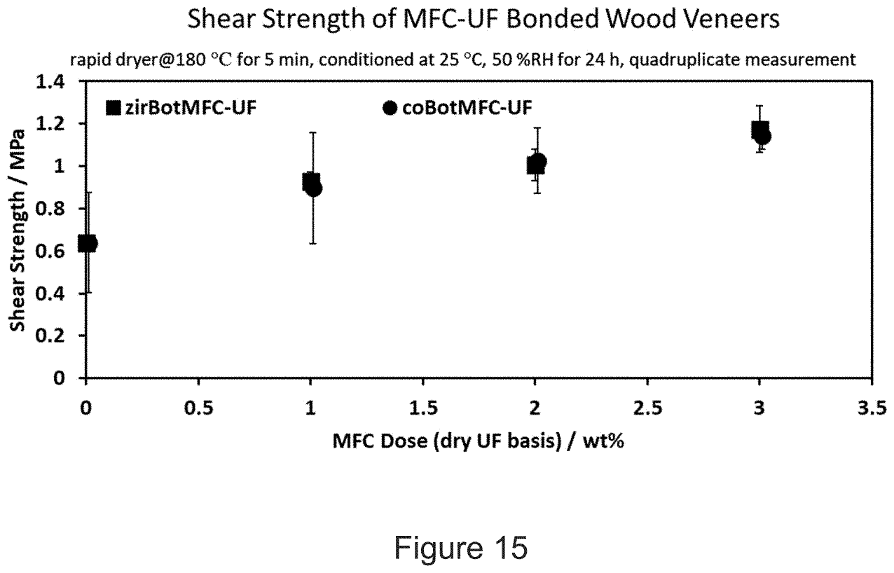

Results—Effect of MFC Content on Shear Strength: FIG. 15 is a graph showing the effect of MFC content on shear strength of MFC-UF bonded wood veneers. As can be seen in FIG. 15, for both mineral-free and 50 POP MFC, increasing the MFC percentage leads to an increase in shear strength with an increase in strength of up to 84% being achieved with mineral free 3% MFC.

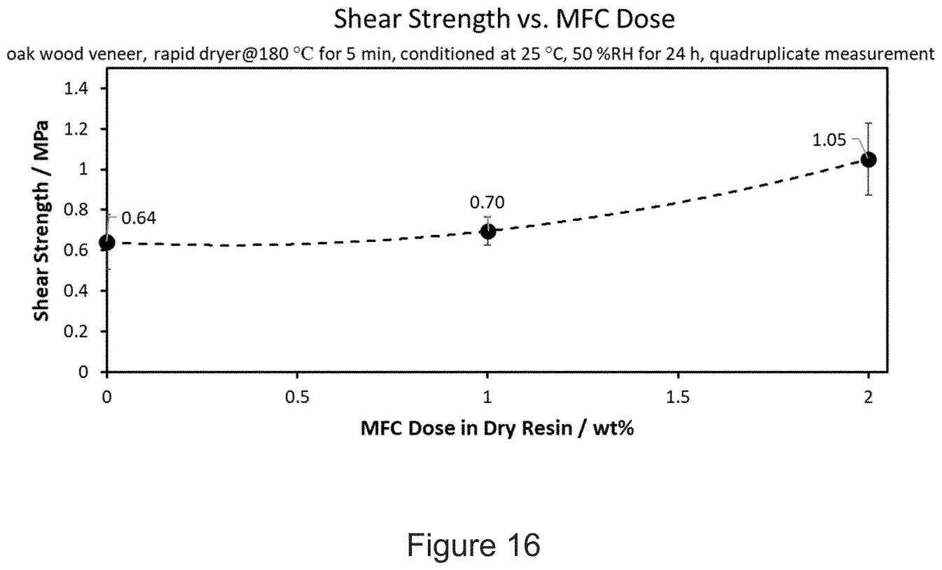

Results—Effect of MFC Content on MUF Resin: FIG. 16 is a graph showing the effect of MFC content on MUF resin. As can be seen in FIG. 16, an increase in the MFC content in MUF resin leads to an increase in shear strength.

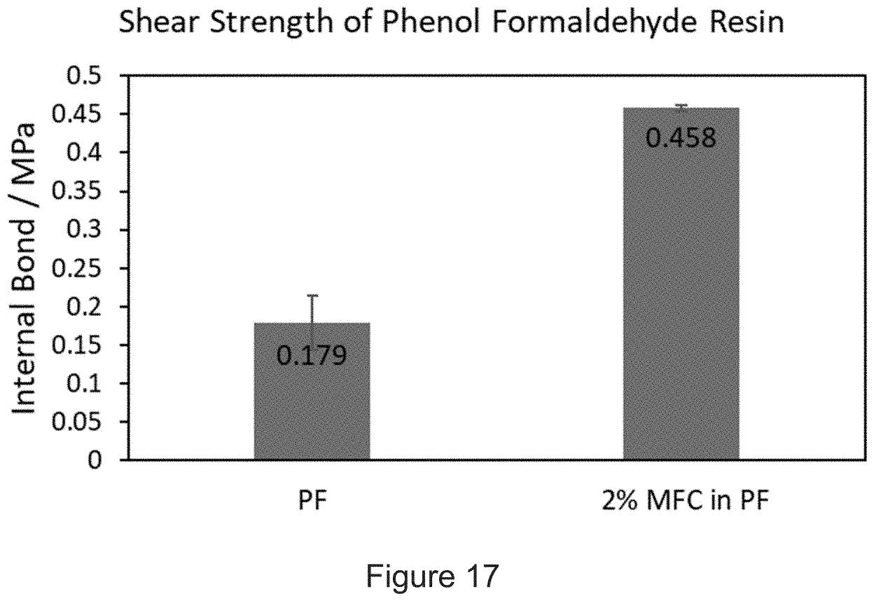

Results—Effect of MFC Content on PF Resin: FIG. 17 is a bar graph showing the effect of MFC content on PF resin. As can be seen in FIG. 17 an increase in the MFC content in PF resin leads to an increase in shear strength.

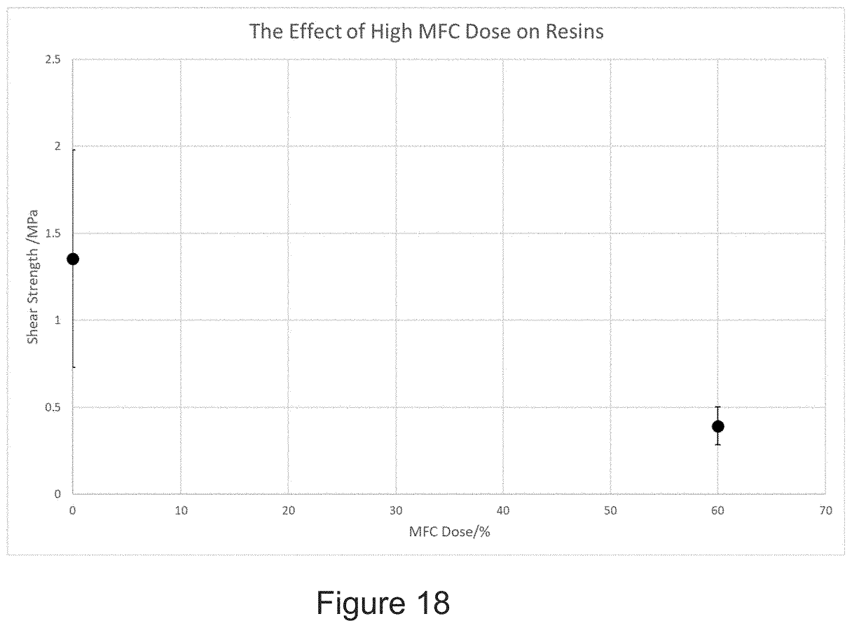

Results—Effect of High MFC Dose in UF on Resin Property: FIG. 18 is a graph showing that a decrease in shear strength is observed when 60 wt % MFC is added in UF.

### Embodiments

The present disclosure provides a method for the re-dispersion of an essentially-dried or partially-dried and, optionally, pulverized, composition comprising nanocellulose and, optionally, one or more inorganic particulate material, the method comprising the steps of: (a) providing a quantity of a thermosetting resin to a mixing tank through a first inlet, wherein the mixing tank comprises a moderate-shear mixing apparatus comprising a shear-head impeller, and wherein the mixing tank further comprises an outlet and a first pump attached to the outlet; (b) providing a quantity of essentially-dried or partially-dried and, optionally, pulverized, composition comprising nanocellulose and, optionally, one or more inorganic particulate material, to the mixing tank through the first inlet in sufficient quantity to yield a liquid slurry at a solids content of from about 0.5 wt % to about 5 wt % (in some embodiments about 0.5 wt % to about 3 wt %) fibre solids; (c) mixing the liquid slurry under moderate-shear conditions via the mixing apparatus to partially de-agglomerate the liquid slurry to form a flowable slurry; (d) pumping the flowable slurry via the pump attached to the first outlet of the mixing tank to an inlet of a first stage high-shear rotor-stator apparatus comprising an outlet and a pump attached to the outlet, wherein the inlet of the first stage high-shear rotor-stator apparatus is in communication with the outlet of the mixing tank, and the flowable slurry is subjected to high-shear mixing to form a substantially homogenous suspension; (e) pumping the substantially homogenous suspension from the outlet of the first stage high-shear rotor-stator apparatus to an inlet of a second stage high-shear apparatus selected from a rotor-rotor apparatus, a second high-shear rotor-stator apparatus, a colloid mill, an ultrafine grinding apparatus, or a refiner, wherein the rotor-rotor apparatus comprises counter-rotating rings for subjecting the substantially homogenous suspension to additional high-shear processing to produce a uniform re-dispersed suspension of nanocellulose and, optionally, one or more inorganic particulate material; and (f) collecting the re-dispersed suspension of nanocellulose and, optionally, one or more inorganic particulate material, in a suitable holding vessel for further end-use applications.

In some embodiments, the method comprises a hydrocyclone following the rotor-stator apparatus, wherein the hydrocyclone comprises an inlet, a first hydrocyclone outlet, and a second hydrocyclone outlet, wherein the hydrocyclone separates the substantially homogenous suspension into (i) a sheared fine particle stream and (ii) an under-sheared coarse particle stream; pumping the under-sheared coarse particle stream from the first hydrocyclone outlet to a second inlet of the mixing apparatus to permit recirculation and remixing of the under-sheared coarse particle stream with the flowable slurry in the mixing tank; flowing the fine particle stream from the second outlet of the hydrocyclone to an inlet of the second stage high-shear apparatus selected from a rotor-rotor apparatus, a second high-shear rotor-stator apparatus, a colloid mill, an ultrafine grinding apparatus, or a refiner, wherein the rotor-rotor apparatus comprises counter-rotating rings for subjecting the substantially homogenous suspension to additional high-shear processing.

In some embodiments, the composition of nanocellulose further comprises one or more inorganic particulate material.

In some embodiments, the essentially-dried or partially-dried composition comprising nanocellulose and, optionally, one or more inorganic particulate material is pulverized.

In some embodiments, the essentially-dried or partially-dried composition comprising nanocellulose, and optionally inorganic particulate material, is pulverized.

In some embodiments, the method is a continuous process, semi-continuous process, or batch process.

In some embodiments, the liquid composition of nanocellulose is about 0.5 wt % to about 2.5 wt % fibre solids.

In some embodiments, the liquid composition of nanocellulose is about 0.75 wt % fibre solids.

In some embodiments, the liquid composition of nanocellulose is about 1 wt % fibre solids.

In some embodiments, the liquid composition of nanocellulose is about 1.25 wt % fibre solids.

In some embodiments, the liquid composition of nanocellulose is about 1.5 wt % fibre solids.

In some embodiments, the liquid composition of nanocellulose is about 1.75 wt % fibre solids.

In some embodiments, the liquid composition of nanocellulose is about 2 wt % fibre solids.

In some embodiments, the liquid composition of nanocellulose is about 2.5 wt % fibre solids.

In some embodiments, the liquid composition of nanocellulose is about 3 wt % fibre solids.

In some embodiments, the liquid composition of nanocellulose is about 4 wt % fibre solids.

In some embodiments, the liquid composition of nanocellulose is about 5 wt % fibre solids.

In some embodiments, the nanocellulose may be prepared from a chemical pulp, a chemithermomechanical pulp, a mechanical pulp, a recycled pulp, a paper broke pulp, a papermill waste stream, waste from a papermill, or a combination thereof.

In some embodiments, the one or more inorganic particulate material comprises an alkaline earth metal carbonate or sulphate, a hydrous kandite clay, an anhydrous (calcined) kandite clay, talc, mica, perlite or diatomaceous earth, or combinations thereof.

In some embodiments, the one or more inorganic particulate material comprises calcium carbonate, magnesium carbonate, dolomite, bentonite, gypsum, kaolin, halloysite, ball clay, metakaolin, fully calcined kaolin, or a combination thereof.

In some embodiments, the one or more inorganic particulate material comprises calcium carbonate.

In some embodiments, the one or more inorganic particulate matter comprises kaolin.

In some embodiments, the one or more inorganic particulate matter comprises kaolin and calcium carbonate.

In some embodiments, the calcium carbonate is precipitated calcium carbonate, ground calcium carbonate or a combination thereof.

In some embodiments, the calcium carbonate comprises a calcite, aragonite or vaterite structure

In some embodiments, the calcium carbonate is in a scalenohedral or rhombohedral crystal form.

In some embodiments, the kaolin is hyperplaty kaolin.

In some embodiments, at least about 50 wt % of the calcium carbonate has an equivalent spherical diameter of less than about 2 μm.

In some embodiments, at least about 50 wt % of the kaolin has an equivalent spherical diameter of less than about 2 μm.

In some embodiments, the ground calcium carbonate is limestone or marble.

In some embodiments, the end-use comprises a method of making wood-based panels.

In some embodiments, the first stage high-shear rotor-stator apparatus is selected from a Trigonal® mill, a colloid mill, an ultrafine grinding apparatus, or a refiner.

In some embodiments, the second stage high-shear rotor-stator apparatus is selected from a rotor-rotor apparatus, a Trigonal® mill, a colloid mill, an ultrafine grinding apparatus, or a refiner.

The present disclosure also provides a transportable system (1) for re-dispersing an essentially-dried or partially-dried and, optionally, pulverized composition comprising nanocellulose and, optionally, one or more inorganic particulate material in a thermosetting resin to form a liquid composition, comprising: a mixing tank (20) comprising a mixing apparatus (21) comprising a shear-head impeller (22), wherein the mixing tank (20) comprises a first mixing tank inlet (24) for reception of a liquid slurry of nanocellulose and, optionally, one or more inorganic particulate material and a mixing tank outlet (26) comprising a pump (27); a first stage high-shear rotor-stator apparatus (30) comprising a rotor-stator inlet (31) connected to the mixing tank outlet (26) and a rotor-stator outlet (32); a second stage high-shear apparatus (50) selected from a rotor-rotor apparatus, a Trigonal® mill, a colloid mill, an ultra-fine grinding apparatus, or a refiner, wherein the second stage high-shear apparatus (50) comprises a second stage high-shear inlet (52) connected to the first stage high-shear rotor-stator outlet and an outlet (53); and a storage tank (60) comprising a storage tank inlet (61) connected to the rotor-rotor outlet (53).

In some embodiments, the system comprises a hydrocyclone (40) comprising a hydrocyclone inlet (41), a first hydrocyclone outlet (42), and a second hydrocyclone outlet (43) wherein the hydrocyclone inlet (41) is connected to the rotor-stator outlet (32) of the rotor-stator apparatus, wherein the hydrocyclone separates the slurry of nanocellulose and, optionally, one or more inorganic particulate material into a sheared fine particle stream and an under-sheared coarse particle stream, wherein the first hydrocyclone outlet (42) is connected to a second inlet (25) of the mixing tank (20) for returning the under-sheared coarse particle stream to the mixing tank (20), wherein the fine particle stream is flowed via the second hydrocyclone outlet (43) to the second stage high-shear inlet (52).

In some embodiments, the essentially-dried or partially-dried and, optionally, pulverized composition comprising nanocellulose further comprises one or more inorganic particulate material.

In some embodiments, the essentially-dried or partially-dried and, optionally, pulverized composition comprising nanocellulose further comprises one or more inorganic particulate material is pulverized.

In some embodiments, the liquid composition of nanocellulose is about 0.5 wt % to about 5 wt % fibre solids.

In some embodiments, the liquid composition of nanocellulose is about 0.5 wt % to about 3 wt % fibre solids.

In some embodiments, the liquid composition is about 0.75 wt % fibre solids.

In some embodiments, the liquid composition is about 1 wt % fibre solids.

In some embodiments, the liquid composition is about 1.25 wt % fibre solids.

In some embodiments, the liquid composition is about 1.5 wt % fibre solids.

In some embodiments, the liquid composition is about 1.75 wt % fibre solids.

In some embodiments, the liquid composition is about 2 wt % fibre solids.

In some embodiments, the liquid composition is about 2.5 wt % fibre solids.

In some embodiments, the liquid composition is about 3 wt % fibre solids.

In some embodiments, the liquid composition is about 4 wt % fibre solids.

In some embodiments, the liquid composition is about 5 wt % fibre solids.

In some embodiments, the nanocellulose may be prepared from a chemical pulp, a chemithermomechanical pulp, a mechanical pulp, a recycled pulp, a paper broke pulp, a papermill waste stream, waste from a papermill, or a combination thereof.

In some embodiments, the one or more inorganic particulate material comprises an alkaline earth metal carbonate or sulphate, a hydrous kandite clay, an anhydrous (calcined) kandite clay, talc, mica, perlite or diatomaceous earth, or combinations thereof.

In some embodiments, the one or more inorganic particulate material may comprise calcium carbonate, magnesium carbonate, dolomite, gypsum, kaolin, halloysite, ball clay, metakaolin, fully calcined kaolin, or a combinations thereof.

In some embodiments, the one or more inorganic particulate material may comprise calcium carbonate.

In some embodiments, the one or more inorganic particulate matter may comprise kaolin.

In some embodiments, the one or more inorganic particulate matter may comprise kaolin and calcium carbonate.

In some embodiments, the calcium carbonate is precipitated calcium carbonate, ground calcium carbonate or a combination thereof.

In some embodiments, the calcium carbonate comprises a calcite, aragonite or vaterite structure.

In some embodiments, the calcium carbonate is in a scalenohedral or rhombohedral crystal form.

In some embodiments, the kaolin is hyperplaty kaolin.

In some embodiments, at least about 50 wt % of the calcium carbonate has an equivalent spherical diameter of less than about 2 μm.

In some embodiments, at least about 50 wt % of the kaolin has an equivalent spherical diameter of less than about 2 μm.

In some embodiments, the ground calcium carbonate is limestone or marble.

In some embodiments, the first stage high-shear rotor-stator apparatus is selected from a Trigonal® mill, a colloid mill, an ultrafine grinding apparatus, or a refiner.

In some embodiments, the second stage high-shear rotor-stator apparatus is selected from a rotor-rotor apparatus, a Trigonal® mill, a colloid mill, an ultrafine grinding apparatus, or a refiner.

The present disclosure further provides a method for the re-dispersion of an essentially-dried or partially-dried and, optionally, pulverized, composition comprising nanocellulose and, optionally, one or more inorganic particulate material, the method comprising the steps of: (a) flowing a thermosetting resin comprising nanocellulose and, optionally, one or more inorganic particulate material obtained from essentially-dried or partially-dried nanocellulose and, optionally, one or more inorganic particulate material, to a moderate-shear mixing apparatus comprising a shear-head impeller to form a liquid slurry comprising nanocellulose and, optionally, one or more inorganic particulate material; (b) flowing the liquid slurry to a first stage high-shear rotor-stator apparatus, wherein the liquid slurry is subjected to high-shear mixing to form a substantially homogenous suspension; (c) flowing the substantially homogeneous suspension to a second stage high-shear apparatus selected from a rotor-rotor apparatus, a second stage high-shear rotor-stator apparatus, a colloid mill, an ultrafine grinding apparatus, or a refiner, wherein the rotor-rotor apparatus comprises counter-rotating rings for subjecting the substantially homogenous suspension to high-shear processing to produce a uniform re-dispersed suspension of nanocellulose and, optionally, one or more inorganic particulate material; and (d) collecting the re-dispersed suspension of nanocellulose and, optionally one or more inorganic particulate material, in a suitable holding vessel for further end-use applications.

In some embodiments, the substantially homogeneous suspension is flowed to a hydrocyclone, wherein the substantially homogenous suspension is separated into an undersheared coarse particle stream and a sheared fine particle stream, wherein the undersheared coarse particle stream is recirculated to the moderate shear mixing apparatus and the sheared fine particle stream is flowed to the second high-shear rotor-stator apparatus, a colloid mill, an ultrafine grinding apparatus, or a refiner.

In some embodiments, the composition of nanocellulose further comprises one or more inorganic particulate material.

In some embodiments, the essentially-dried or partially-dried and, optionally, pulverized, composition comprising nanocellulose and, optionally, one or more inorganic particulate material is pulverized.

In some embodiments, the essentially-dried or partially-dried composition comprising nanocellulose, and optionally inorganic particulate material, is pulverized.

In some embodiments, the method is a continuous process, semi-continuous process, or batch process.

In some embodiments, the liquid composition of nano cellulose is about 0.5 wt % to about 2.5 wt % fibre solids.

In some embodiments, the liquid composition is about 0.75 wt % fibre solids.

In some embodiments, the liquid composition is about 1 wt % fibre solids.

In some embodiments, the liquid composition is about 1.25 wt % fibre solids.

In some embodiments, the liquid composition is about 1.5 wt % fibre solids.

In some embodiments, the liquid composition is about 1.75 wt % fibre solids.

In some embodiments, the liquid composition is about 2 wt % fibre solids.

In some embodiments, the liquid composition is about 2.5 wt % fibre solids.

In some embodiments, the liquid composition is about 3 wt % fibre solids.

In some embodiments, the liquid composition is about 4 wt % fibre solids.

In some embodiments, the liquid composition is about 5 wt % fibre solids.

In some embodiments, the nanocellulose may be prepared from a chemical pulp, a chemithermomechanical pulp, a mechanical pulp, a recycled pulp, a paper broke pulp, a papermill waste stream, waste from a papermill, or a combination thereof.

In some embodiments, the one or more inorganic particulate material comprises an alkaline earth metal carbonate or sulphate, a hydrous kandite clay, an anhydrous (calcined) kandite clay, talc, mica, perlite or diatomaceous earth, or combinations thereof.

In some embodiments, the one or more inorganic particulate material comprises calcium carbonate, magnesium carbonate, dolomite, gypsum, kaolin, halloysite, ball clay, metakaolin, fully calcined kaolin, or a combinations thereof.

In some embodiments, the one or more inorganic particulate material comprises calcium carbonate.

In some embodiments, the one or more inorganic particulate matter comprises kaolin.

In some embodiments, the one or more inorganic particulate matter may comprise kaolin and calcium carbonate.

In some embodiments, the calcium carbonate is precipitated calcium carbonate, ground calcium carbonate or a combination thereof.

In some embodiments, the calcium carbonate comprises a calcite, aragonite or vaterite structure.

In some embodiments, the calcium carbonate is in a scalenohedral or rhombohedral crystal form.

In some embodiments, the kaolin is hyperplaty kaolin.

In some embodiments, at least about 50 wt % of the calcium carbonate has an equivalent spherical diameter of less than about 2 μm.

In some embodiments, at least about 50 wt % of the kaolin has an equivalent spherical diameter of less than about 2 μm.

In some embodiments, the ground calcium carbonate is limestone or marble.

In some embodiments, the end-use comprises a method of making wood-based panels.

In some embodiments, the first stage high-shear rotor-stator apparatus is selected from a Trigonal® mill, a colloid mill, an ultrafine grinding apparatus, or a refiner.

In some embodiments, the second stage high-shear rotor-stator apparatus is selected from a rotor-rotor apparatus, a Trigonal® mill, a colloid mill, an ultrafine grinding apparatus, or a refiner.

The present disclosure also provides a method for re-dispersing a partially-dried, filtration cake composition comprising nanocellulose and, optionally, one or more inorganic particulate material, and, optionally one or more additive in a thermosetting resin, the method comprising the steps of: (a) providing a quantity of a thermosetting resin to a first mixing tank; (b) providing a partially-dried, filtration cake composition comprising nanocellulose and, optionally, one or more inorganic particulate material and, optionally one or more additional additive; (c) optionally, providing one or more additive to the first mixing tank, wherein, the quantity of partially-dried, filtration cake composition comprising nanocellulose and, optionally, one or more inorganic particulate material and, optionally one or more additive, has a total solids content of about 8 wt. % to about 60 wt. %, and wherein the thermosetting resin and partially-dried filtration cake has a fibre content of from about 0.5 wt % to about 20 wt % fibre solids, preferably about 0.5 wt. % to about 4 wt. % fibre solids, more preferably about 0.5 wt. % to about 3 wt. % fibre solids, and more preferably about 1 wt. % to about 2 wt. % fibre solids based on the total solids content of the nanocellulose and optionally one or more inorganic particulate material, and, optionally, one or more additive; (d applying high-shear mixing with a first moderate-to-high-shear mixing apparatus comprising a shear-head impeller to the thermosetting resin and nanocellulose and, optionally, one or more inorganic particulate material, and, optionally one or more additive, to form a flowable slurry; (e) applying further high-shear mixing with a high-shear rotor-stator or rotor-rotor mixing apparatus to the flowable slurry to form a substantially homogeneous suspension of the thermosetting resin and nanocellulose and, optionally one or more particulate material and, optionally, one or more additional additive; and (f) recovering the substantially homogeneous suspension of thermosetting resin and nanocellulose and, optionally one or more particulate material and, optionally, one or more additional additive, in a storage tank, or utilizing the substantially homogeneous suspension in an end-use application or, optionally, recirculating the substantially homogeneous suspension to the first mixing tank to permit further continuous processing of the substantially homogeneous suspension.

In some embodiments, the method comprises providing the partially-dried, filtration cake composition comprising nanocellulose and, optionally, one or more inorganic particulate material, and, optionally one or more additional additive, to the first mixing tank (20) by a feed hopper.

In some embodiments, the method comprises one or more optional filter apparatus for removal of agglomerates in the flowable slurry.

In some embodiments, the flowable slurry is further processed in a second mixing tank having a second moderate-to-high-shear mixing apparatus comprising a shear-head impeller to impart high-shear mixing of the thermosetting resin and nanocellulose and, optionally, one or more particulate material, and, optionally one or more additive, to form a flowable slurry, wherein the first mixing tank and second mixing tank are connected by an overflow tube for passively conducting flowable slurry from the first mixing tank to the second mixing tank when an overflow level of mixing tank is reached.

In some embodiments, the first moderate-to-high-shear mixing apparatus comprising a shear-head impeller (22b) is selected from a dispergator, disperser, overhead stirrer for high-speed, high-shear mixing or Cowles type mixer or other generally vertically oriented shear-head impeller apparatus.

In some embodiments, the first and/or second moderate-to-high-shear mixing apparatus comprising a shear-head impeller (22b) is a dispergator, disperser, overhead stirrer for high-speed, high-shear mixing or Cowles type mixer or other generally vertically oriented shear-head impeller apparatus.

In some embodiments, the first moderate-to-high-shear mixing apparatus comprising a shear-head impeller is a dispergator.

In some embodiments, the first and/or second high-shear mixing apparatus comprising a shear-head impeller is a dispergator.

In some embodiments, the first moderate-to-high-shear mixing apparatus comprising a shear-head impeller is a Cowles-type mixer.

In some embodiments, the first moderate-to-high-shear mixing apparatus comprising a shear-head impeller is a generally vertically oriented shear-head impeller apparatus.

In some embodiments, the first and/or second moderate-to-high-shear mixing apparatus comprising a shear-head impeller is a Cowles-type mixer.

In some embodiments, the first and/or second moderate-to-high-shear mixing apparatus comprising a shear-head impeller is a generally vertically oriented shear-head impeller apparatus.

In some embodiments, the high-shear rotor-stator mixing apparatus is a Trigonal® SM180, BVG Shear Master (i.e., an inline disperser rotor-stator machine with multiple rotor-stator configurations, such as homogenization, delamination, deflating, cutting, emulsifying, pumping, and high shear dispersing) (available from BVG Bauer-Verfahrenstechnik-GmbH, Gewerbering 12, 86926, Greifenberg, Germany) or Cavitron mixing apparatus.

In some embodiments, the high-shear rotor-stator mixing apparatus is a colloid mill.

In some embodiments, the rotor-rotor mixing apparatus comprises counter rotating rings.

In some embodiments, the rotor-rotor mixing apparatus is an Atrex dispergator

In some embodiments, the one or more additive is a biocide.

In some embodiments, the biocide is 2,2-dibromo-3-nitrilopropionamide (DBNPA).

In some embodiments, the DBNPA is dosed at about 250 ppm.

In some embodiments, the biocide is 2-methyl-2h-isothiazolin-3-one/2-methyl-2h-isothiazol-3-one (3:1 ratio) (CMIT/MIT).

In some embodiments, the CMIT/MIT is dosed at about 200 ppm.

In some embodiments, the one or more additive is a flocculant.

In some embodiments, the flocculant is a cationic flocculant.

In some embodiments, the cationic flocculant is a polyacrylamide solution.

In some embodiments, the filtration cake is a belt press cake.

In some embodiments, the filtration cake is a plate and frame press cake.

In some embodiments, the filtration cake is a tube press cake.

In some embodiments, the one or more inorganic particulate materials are selected from an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite, bentonite or diatomaceous earth, or magnesium hydroxide, or aluminum trihydrate, or combinations thereof.

In some embodiments, the one or more inorganic particulate material is selected from one or more of kaolin, calcined kaolin, wollastonite, bauxite, talc, bentonite or mica.

In some embodiments, the one or more inorganic particulate material is calcium carbonate, preferably ground calcium carbonate, precipitated calcium carbonate and mixtures thereof.

In some embodiments, the one or more inorganic particulate material is kaolin clay.

In some embodiments, the one or more inorganic particulate material is hyper-platy kaolin.

In some embodiments, the nanocellulose is produced from hardwood pulp, softwood pulp, wheat straw pulp, bamboo, bagasse, virgin fiber, chemical pulp, chemithermomechanical pulp, mechanical pulp, thermomechanical pulp, kraft pulp, bleached long fibre kraft pulp, eucalyptus pulp, spruce pulp, pine pulp, beech pulp, hemp pulp, acacia cotton pulp, recycled pulp, papermill broke, paper steam rich in mineral fillers, or a combination thereof.

In some embodiments, the hardwood pulp is selected from the group consisting of eucalyptus, aspen, birch, and mixed hardwood pulps

In some embodiments, the softwood pulp is selected from the group consisting of spruce, pine, fir, larch, hemlock, and mixed softwood pulp.

The system also provides a transportable make down system for re-dispersing partially-dried, filtration cake compositions comprising nanocellulose, and, optionally, one or more inorganic particulate material, and optionally one or more additive, comprising: a first mixing tank (20) having tank inlet (24); second inlet (25) for provision of thermosetting resin to the first mixing tank (20); first moderate-to-high-shear mixing apparatus (22a) comprising a shear-head impeller (22b) for moderate-to-high-shear mixing of the thermosetting resin and nanocellulose and, optionally, one or more particulate material, and, optionally, one or more additive, to form a flowable slurry; outlet (26) attached to inlet (31) of a high-speed, high-shear, rotor-stator and/or rotor-rotor mixing apparatus (30) for applying further high-shear to the flowable slurry; further comprising outlet (32); wherein after application of high-shear to the flowable slurry by the rotor-stator and/or rotor-rotor mixing apparatus (30) forms a substantially homogeneous suspension comprising nanocellulose and, optionally one or more inorganic particulate material, and, optionally, one or more additive; and the substantially homogeneous suspension is retrieved through outlet (32) optionally connected to storage tank (60) or utilized directly in an end-use application or recirculated to an optional third inlet (29) of mixing tank (20) to form a recirculation loop to permit further continuous processing of the substantially homogeneous suspension.

In some embodiments, the system comprises providing the partially-dried, filtration cake composition comprising nanocellulose and, optionally, one or more inorganic particulate material, and, optionally one or more additional additive, to the first mixing tank (20) by a feed hopper.

In some embodiments, the system comprises one or more optional filter (28a/28b), which is operated interchangeably to permit cleaning and removing agglomerates in the flowable slurry, interposed between outlet (26) and inlet (31).

In some embodiments, the flowable slurry from mixing tank (20) may be further processed in a second mixing tank (70) having second moderate-to-high-shear mixing apparatus (72a) comprising a shear-head impeller (72b) for high shear mixing of the thermosetting resin and nanocellulose and, optionally, one or more particulate material, and, optionally, one or more additive; further comprising outlet (73) connected to inlet (31) of second high-speed, high-shear rotor-stator and/or rotor-rotor mixing apparatus (30); further comprising an overflow tube for passively conducting flowable slurry from first mixing tank (20) to second mixing tank (70) when the overflow level of mixing tank 1 is reached.

In some embodiments, the system comprises an operating system for controlling the feed rate of partially-dried nanocellulose and, optionally one or more inorganic particulate material, and, optionally, one or more additive, and the thermosetting resin to control the solids content in first mixing tank (20).

In some embodiments, the first high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments, the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments, the first moderate-to-high-shear mixing apparatus (22a) comprising a shear-head impeller (22b) is a dispergator.

In some embodiments, the first moderate-to-high-shear mixing apparatus (22a) comprising a shear-head impeller (22b) is a disperser.

In some embodiments, the first moderate-to-high-shear mixing apparatus (22a) comprising a shear-head impeller (22b) is an overhead stirrer for high-speed, high-shear mixing.

In some embodiments, the first moderate-to-high-shear mixing apparatus (22a) comprising a shear-head impeller (22b) is Cowles type mixer.

In some embodiments, the first and/or second moderate-to-high-shear mixing apparatus (22a) comprising a shear-head impeller (22b) is a dispergator.

In some embodiments, the first and/or second high-shear mixing apparatus (22a) comprising a shear-head impeller (22b) is a disperser.

In some embodiments, the first and/or second high-shear mixing apparatus (22a) comprising a shear-head impeller (22b) is an overhead stirrer for high-speed, high-shear mixing.

In some embodiments, the first and/or second high-shear mixing apparatus (22a) comprising a shear-head impeller (22b) is a Cowles-type mixer.

In some embodiments, the filtration cake is a belt press cake.

In some embodiments, the filtration cake is a plate and frame press cake.

In some embodiments, the one or more inorganic particulate materials are selected from an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, hyper-platy kaolin, talc, mica, perlite, bentonite or diatomaceous earth, or magnesium hydroxide, or aluminum trihydrate, or combinations thereof.

In some embodiments, the one or more inorganic particulate material is selected from one or more of kaolin, calcined kaolin, wollastonite, bauxite, talc, bentonite or mica.

In some embodiments, the one or more inorganic particulate material is calcium carbonate, preferably ground calcium carbonate, precipitated calcium carbonate and mixtures thereof.

In some embodiments, the one or more inorganic particulate material is kaolin clay.

In some embodiments, the one or more inorganic particulate material is hyper-platy kaolin.

In some embodiments, the first mixing tank (20) has a volume of at least 1 m².

In some embodiments, the nanocellulose is produced from hardwood pulp, softwood pulp, wheat straw pulp, bamboo, bagasse, virgin fiber, chemical pulp, chemithermomechanical pulp, mechanical pulp, thermomechanical pulp, kraft pulp, bleached long fibre kraft pulp, eucalyptus pulp, spruce pulp, pine pulp, beech pulp, hemp pulp, acacia cotton pulp, recycled pulp, papermill broke, paper steam rich in mineral fillers, or a combination thereof.

In some embodiments, the hardwood pulp is selected from the group consisting of eucalyptus, aspen, birch, and mixed hardwood pulps.

In some embodiments, the softwood pulp is selected from the group consisting of spruce, pine, fir, larch, hemlock, and mixed softwood pulp.

In some embodiments, the quantity of partially-dried, filtration cake composition comprising nanocellulose and, optionally, one or more inorganic particulate material and, optionally one or more additive, has a total solids content of about 8 wt. % to about 60 wt. %, and wherein the thermosetting resin and partially-dried filtration cake has a fibre content of from about 0.5 wt % to about 20 wt % fibre solids, preferably about 0.5 wt. % to about 4 wt. % fibre solids, more preferably about 0.5 wt. % to about 3 wt. % fibre solids, and more preferably about 1 wt. % to about 2 wt. % fibre solids based on the total solids content of the nanocellulose and optionally one or more inorganic particulate material, and, optionally, one or more additive.

The present disclosure also provides a transportable make down system for re-dispersing partially-dried, filtration cake compositions comprising nanocellulose, and, optionally, one or more inorganic particulate material, and optionally one or more additive, comprising: a first mixing tank (20) having tank inlet (24); second inlet (25) for provision of thermosetting resin to the first mixing tank (20); first moderate-to-high-shear mixing apparatus (22a) comprising a shear-head impeller (22b) for moderate-to-high-shear mixing of the thermosetting resin and nanocellulose and, optionally, one or more particulate material, and, optionally, one or more additive, to form a flowable slurry; outlet (26) attached to inlet (31) of a high-speed, first high-shear, rotor-stator and/or rotor-rotor mixing apparatus (30) for applying further high-shear to the flowable slurry; further comprising outlet (32); a second high-shear rotor-stator and/or rotor-rotor mixing apparatus (50) comprising inlet (52) connected to the first high-shear rotor-stator and/or rotor-rotor outlet (32) and comprising outlet (53); wherein after application of high-shear to the flowable slurry by the first rotor-stator and/or rotor-rotor mixing apparatus (30) and the second high-shear rotor-stator or rotor-rotor mixing apparatus (50) forms a substantially homogeneous suspension comprising nanocellulose and, optionally one or more inorganic particulate material, and, optionally, one or more additive; and the substantially homogeneous suspension is retrieved through outlet (53) optionally connected to storage tank (60) or utilized directly in an end-use application or recirculated to an optional third inlet (29) of mixing tank (20) to form a recirculation loop to permit further continuous processing of the substantially homogeneous suspension.

In some embodiments, the first high-shear apparatus is a rotor-stator mixing apparatus and the second high-shear mixing apparatus is a rotor-stator mixing apparatus.

In some embodiments, the first high-shear apparatus is a rotor-stator mixing apparatus and the second high-shear mixing apparatus is a rotor-rotor mixing apparatus.

In some embodiments, the first high-shear apparatus is a rotor-rotor mixing apparatus and the second high shear mixing apparatus is a rotor-rotor mixing apparatus.

In some embodiments, the first high-shear apparatus is a rotor-rotor mixing apparatus and the second high-shear mixing apparatus is a rotor-stator mixing apparatus.

In some embodiments, the flowable slurry is further processed in a second mixing tank having a second moderate-to-high-shear mixing apparatus comprising a shear-head impeller to impart high-shear mixing of the thermosetting resin and nanocellulose, and, optionally one or more inorganic particulate material, and, optionally one or more additive.

The present disclosure further provides a method for re-dispersing a partially-dried, filtration cake composition comprising nanocellulose and, optionally, one or more inorganic particulate material, and, optionally one or more additive in a thermosetting resin; the method comprising the steps of: (a) providing a quantity of a thermosetting resin to a first mixing tank; (b) providing a partially-dried, filtration cake composition comprising nanocellulose and, optionally, one or more inorganic particulate material; and, optionally one or more additional additive; (c) optionally, providing one or more additive to the first mixing tank; wherein, the quantity of partially-dried, filtration cake composition comprising nanocellulose and, optionally, one or more inorganic particulate material and, optionally one or more additive, has a total solids content of about 8 wt. % to about 60 wt. %, and wherein the thermosetting resin and partially-dried filtration cake has a fibre content of from about 0.5 wt % to about 20 wt % fibre solids, preferably about 0.5 wt. % to about 4 wt. % fibre solids, more preferably about 0.5 wt. % to about 3 wt. % fibre solids, and more preferably about 1 wt. % to about 2 wt. % fibre solids based on the total solids content of the nanocellulose and optionally one or more inorganic particulate material, and, optionally, one or more additive; (d) applying high-shear mixing with a first moderate-to-high-shear mixing apparatus comprising a shear-head impeller to the thermosetting resin and nanocellulose and, optionally, one or more inorganic particulate material, and, optionally one or more additive, to form a flowable slurry; (e) applying further high-shear mixing with a first high-shear rotor-stator or rotor-rotor mixing apparatus and with a second high-shear rotor-stator or rotor-rotor mixing apparatus to the flowable slurry to form a substantially homogeneous suspension of the thermosetting resin and nanocellulose and, optionally one or more particulate material and, optionally, one or more additional additive; and (f) recovering the substantially homogeneous suspension of thermosetting resin and nanocellulose and, optionally one or more particulate material and, optionally, one or more additional additive, in a storage tank, or utilizing the substantially homogeneous suspension in an end-use application or, optionally, recirculating the substantially homogeneous suspension to the first mixing tank to permit further continuous processing of the substantially homogeneous suspension.

In some embodiments, the first high-shear apparatus is a rotor-stator mixing apparatus and the second high-shear mixing apparatus is a rotor-stator mixing apparatus.

In some embodiments, the first high-shear apparatus is a rotor-stator mixing apparatus and the second high-shear mixing apparatus is a rotor-rotor mixing apparatus.

In some embodiments, the first high-shear apparatus is a rotor-rotor mixing apparatus and the second high shear mixing apparatus is a rotor-rotor mixing apparatus.

In some embodiments, the first high-shear apparatus is a rotor-rotor mixing apparatus and the second high-shear mixing apparatus is a rotor-stator mixing apparatus.

In some embodiments, the flowable slurry is further processed in a second mixing tank having a second moderate-to-high-shear mixing apparatus comprising a shear-head impeller to impart high-shear mixing of the thermosetting resin and nanocellulose, and, optionally one or more inorganic particulate material, and, optionally one or more additive.

The present disclosure also provides a method for the re-dispersion of a dried or partially-dried and, optionally, pulverized, composition comprising nanocellulose and, optionally, one or more inorganic particulate material into a thermosetting resin, the method comprising the steps of: (a) providing a thermosetting resin to a mixing tank, wherein the mixing tank comprises a moderate-shear mixing apparatus comprising a shear-head impeller; (b) providing a dried or partially-dried and, optionally, pulverized, composition comprising nanocellulose and, optionally, one or more inorganic particulate material, to the mixing tank in sufficient quantity to yield a liquid composition at a solids content of from about 0.5 wt % to about 5 wt % (in some embodiments about 0.5 wt % to about 3 wt %) fibre solids; (c) mixing the liquid composition by a moderate-shear to high-shear mixing apparatus to partially de-agglomerate the liquid composition to produce a uniform re-dispersed composition of nanocellulose and, optionally, one or more inorganic particulate material in the thermosetting resin; and (d) collecting the re-dispersed composition of nanocellulose and, optionally, one or more inorganic particulate material, in a suitable holding vessel for further end-use applications.

In some embodiments, the thermosetting resin comprises formaldehyde-based resin.

In some embodiments, the formaldehyde-based resin is selected from the group consisting of urea formaldehyde, melamine urea formaldehyde, phenol formaldehyde, and combinations thereof.

In some embodiments, the thermosetting resin comprises isocyanate-based resin.

In some embodiments, the isocyanate-based resin comprises polymeric methylene di-isocyanate.

The present disclosure also provides a method for the re-dispersion of a dried or partially-dried and, optionally, pulverized, composition comprising nanocellulose and, optionally, one or more inorganic particulate material, into a thermosetting resin, the method comprising the steps of: (a) providing a thermosetting resin; (b) providing a dried or partially dried and, optionally, pulverized, composition comprising nanocellulose, and, optionally, one or more inorganic particulate material; (c) mixing the thermosetting resin and the a dried or partially dried and, optionally, pulverized, composition, and, optionally, one or more inorganic particulate material, to yield a liquid composition at a solids content of from about 0.5 wt % to about 5 wt % (in some embodiments about 0.5 wt % to about 3 wt %) fibre solids under moderate- to high-shear mixing conditions with a shear-head impeller and/or a rotor-stator and/or a rotor-rotor mixing apparatus to form a re-dispersed composition comprising the thermosetting resin and the nanocelluose, and optionally one or more inorganic particulate material; and (d) collecting the re-dispersed composition for further end-use applications.

In some embodiments, the thermosetting resin comprises formaldehyde-based resin.

In some embodiments, the formaldehyde-based resin is selected from the group consisting of urea formaldehyde, melamine urea formaldehyde, phenol formaldehyde, and combinations thereof.

In some embodiments, the thermosetting resin comprises isocyanate-based resin.

In some embodiments, the isocyanate-based resin comprises polymeric methylene di-isocyanate.

In some embodiments, the re-dispersed composition is a homogenous composition.

In some embodiments, the nanocellulose comprises microfibrillated cellulose.

What is claimed is:

1. An adhesive resin composition for the manufacture of wood-based panels, the adhesive resin composition comprising:
thermosetting resin; and
nanocellulose.

2. The adhesive resin composition according to claim 1, wherein the thermosetting resin comprises formaldehyde-based resin.

3. The adhesive resin composition according to claim 2, wherein the formaldehyde-based resin is selected from the group consisting of urea formaldehyde, melamine urea formaldehyde, phenol formaldehyde, and combinations thereof.

4. The adhesive resin composition according to any one of claims 1-3, wherein the thermosetting resin comprises isocyanate-based resin.

5. The adhesive resin composition according to claim 4, wherein the isocyanate-based resin comprises polymeric methylene di-isocyanate.

6. The adhesive resin composition according to any one of claims 1-5, wherein the nanocellulose comprises microfibrillated cellulose.

7. The adhesive resin composition according to claim 6, wherein the microfibrillated cellulose has a mean particle size d₅₀ value of about 1 μm to about 500 μm.

8. The adhesive resin composition according to claim 6 or 7, wherein the microfibrillated cellulose has a fibre steepness of about 20 to about 50.

9. The adhesive resin composition according to any one of claims 6-8, wherein the microfibrillated cellulose has a fibre length (Lc(w) ISO) of less than 0.7 mm as measured by a fiber image analyzer.

10. The adhesive resin composition of claim 6, wherein the microfibrillated cellulose has:
a mean particle size d₅₀ value of about 1 μm to about 500 μm;
a fibre steepness of about 20 to about 50; and
a fibre length (Lc(w) ISO) of less than 0.7 mm as measured by a fiber image analyser.

11. The adhesive resin composition according to any one of claims 1-10, wherein the nanocellulose is present in an amount of at least about 0.01 wt % of the total weight of the adhesive resin composition.

12. The adhesive resin composition according to claim 11, wherein the nanocellulose is present in an amount of at least about 0.5 wt % of the total weight of the adhesive resin composition.

13. The adhesive resin composition according to any one of claims 1-12, wherein the nanocellulose is present in an amount of about 0.01 wt % to about 50 wt % of the total weight of the adhesive resin composition.

14. The adhesive resin composition according to claim 13, wherein the nanocellulose is present in an amount of about 0.2 wt % to about 50 wt % of the total weight of the adhesive resin composition.

15. The adhesive resin composition according to any one of claims 1-14, wherein the nanocellulose is present in an amount of at least about 40 wt % of the total solid content of the adhesive resin composition.

16. The adhesive resin composition according to claim 15, wherein the nanocellulose is present in an amount of at most about 50 wt % of the total solid content of the adhesive resin composition.

17. The adhesive resin composition according to any one of claims 1-16, wherein the adhesive resin composition has a shear viscosity of >100 Pa·s at a shear rate of 0.1 s⁻¹.

18. The adhesive resin composition according to any one of claims 1-17, wherein the adhesive resin composition has a shear viscosity of <1 Pa·s at a shear rate of >1000 s⁻¹.

19. The adhesive resin composition according to any one of claims 1-18, further comprising a solvent.

20. The adhesive resin composition according to claim 19, wherein the solvent is selected from the group consisting of water, alcohol, toluene, and combinations thereof.

21. The adhesive resin composition according to claim 20, wherein the alcohol comprises at least one of ethanol, glycerol, and polyvinyl alcohol.

22. The adhesive resin composition according to any one of claims 1-21, further comprising inorganic particulate material.

23. The adhesive resin composition according to claim 22, wherein the inorganic particulate material comprises calcium carbonate, clay, aluminum trihydrate, and combinations thereof.

24. The adhesive resin composition according to any one of claims 1-23, further comprising at least one additive.

25. The adhesive resin composition according to claim 24, wherein the at least one additive comprises a hardener, an emulsion, a fire retardant, and any combination of two or more thereof.

26. The adhesive resin composition according to claim 25, wherein the hardener comprises at least one of ammonium chloride and metal chloride.

27. The adhesive resin composition according to claim 26, wherein the metal chloride comprises at least one of aluminum chloride, zinc chloride, and magnesium chloride.

28. The adhesive resin composition according to any one of claims 25-27, wherein the emulsion comprises at least one of polyvinyl acetate emulsion and paraffin emulsion.

29. The adhesive resin composition according to any one of claims 25-28, wherein the fire retardant comprises at least one of zinc oxide, aluminum hydroxide, and ammonium polyphosphate.

30. A wood-based panel comprising the adhesive resin composition according to any one of claims 1-29.

31. The wood-based panel according to claim 30, wherein the wood-based panel is selected from the group consisting of plywood, chipboard, low-density fiberboard, medium-density fiberboard, and high-density fiberboard.

32. A method of using the adhesive resin composition according to any one of claims 1-29, the method comprising:
applying the adhesive resin composition to either the input or the output of a dryer of a wood-based panel assembly process.

33. The method according to claim 32, wherein applying the adhesive resin composition comprises spraying the adhesive resin composition to either the input or the output of the dryer.

34. The method according to claim 32, wherein applying the adhesive resin composition comprises curtain coating the adhesive resin composition to either the input or the output of the dryer.

35. A method of preparing the adhesive resin composition according to any one of claims 1-29, the method comprising:
providing the nanocellulose in the form of a high-solid product; and
mixing the high-solid product with the thermosetting resin.

36. The method according to claim 35, wherein providing the nanocellulose in the form of the high-solid product comprises:
producing a slurry comprising nanocellulose present in an amount of up to about 10 wt % of the total weight of the slurry; and
mechanically dewatering the slurry to produce the high-solid product having nanocellulose present in an amount of at least about 10 wt % of the total weight of the high-solid product.

37. The method according to claim 36, wherein the nanocellulose is present in an amount of about 1 wt % to about 2 wt % of the total weight of the slurry.

38. The method according to claim 36 or 37, wherein mechanically dewatering the slurry comprises use of a centrifuge.

39. The method according to any one of claims 36-38, wherein mechanically dewatering the slurry comprises use of a belt press.

40. The method according to any one of claims 36-39, wherein nanocellulose is present in an amount of at least about 15 wt % of the total weight of the high-solid product.

41. The method according to any one of claims 35-40, further comprising mixing the high-solid product with the thermosetting resin to produce the adhesive resin composition to have nanocellulose present in an amount of at least about 40 wt % of the total solid content of the adhesive resin composition.

42. The method according to claim 41, wherein the nanocellulose is present in an amount of at most about 50 wt % of the total solid content of the adhesive resin composition.

43. The method according to any one of claims 35-42, wherein mixing the high-solid product with the thermosetting resin comprises use of a Cowles mixer, a rotor/stator mixer, rotor-rotor mixer, or a homogenizer.
